(19) United States
(12) Patent Application Publication
(10) Pub. No.: US 2013/0035244 A1
(43) Pub. Date: Feb. 7, 2013

(54) Method for Characterising a Molecule

(71) Applicant: Laurent Philippe Albou, Strasbourg (FR)

(72) Inventor: Laurent Philippe Albou, Strasbourg (FR)

(73) Assignee: BIONEXT S.A., Boulogne Billancourt (FR)

(21) Appl. No.: 13/386,833

(22) PCT Filed: Jul. 26, 2010
(86) PCT No.: PCT/EP2010/060821

§ 371 Date: Sep. 5, 2012

(30) Foreign Application Priority Data
Jul. 24, 2009 (FR) 09/03674

(51) Int. Cl. C40B 30/02

(52) U.S. Cl. 506/8

(57) ABSTRACT

The invention relates to a method for characterising three-dimensional objects, including steps comprising: i) generating a three-dimensional reconstruction of a three-dimensional object; ii) generating a mesh of the object, said mesh being made up of points connected two-by-two by a ridge; iii) characterising the points and/or faces of the mesh of the object according to the statuses of remarkable properties at said points; iv) splitting the object into contiguous three-dimensional regions based on the mesh and the characterisation of the points thereof; v) creating a database of regions that represent objects of an environment; and/or vi) screening a region on a database in order to find objects that contain similar and/or complementary regions; and/or vii) inferring functions of the objects according to similarities in the regions thereof; and/or viii) inferring interactions between objects by complementarity of the regions thereof; and/or ix) specifying the frequency of a region in an environment.

The present invention relates to methods for characterising, comparing and screening three-dimensional objects in particular in order to automatically identify their remarkable properties, to compare these objects to other known elements in order to infer functions, and to evaluate or deepen the possible physical interactions between these objects.

The comparison of three-dimensional objects belongs among other fields to pattern matching and have numerous applications, especially in physics (interaction between objects, computation of surface contacts and corresponding energetic potentials), in biology (screening of regions and of molecules, specificity of regions), in chemistry (prediction of interactions between synthesizable compounds), in surgery (fine detection of regions to operate, despite inter-patient variability), in biometrics (fingerprints recognition), in robotics (determination of objects that can be handled by a mechanic arm), in aerospace (localization of targets and docking), or more generally in every industrial fields where the systematic and fast recognition of objects or complex sub-objects is necessary.

The invention is in particular intended for pattern matching of molecules and approaches called in silico (that is, by purely numerical approaches), for instance to determine in a systematic way which molecules have a given functional region, or to determine in a systematic way the molecular interactions (that is, the partners of a target) and the structures of corresponding molecular assemblies, whatever their size or the type of molecules involved.

In silico screening approaches of small patterns (such as catalytic sites) are for instance known, in vitro and in vivo screening approaches (two hybrid (Y2H), TAP-TAG) of macromolecules, or also the “docking” (in silico approach of predicting the shape of the assembly between a ligand and a receptor to form a stable complex, but where the execution time takes between a few hours and several days for a single assembly, which makes it difficult to be applied to screening problems).

In vitro/in vivo high-throughput screening approaches remain slow, expensive and difficult to implement, and do not provide sufficiently accurate results, thus limiting their use and their effectiveness in areas such as those of the pharmaceutical industry, cosmetic, chemistry or food industry.

In fact, in vitro/in vivo approaches have too low sensitivities and accuracies to identify with high certainty the molecular interactions, as it is demonstrated in the literature. Other in vitro/in vivo approaches allow to identify and characterise, with near certainty, the molecular interactions (in particular with crystallography, with nuclear magnetic resonance, calorimetry) but require several weeks to several months (sometimes years) to validate a single interaction.

In vitro/in vivo, the identification of the location of binding sites requires for instance to perform numerous mutagenesis experiments, which are long and expensive. These binding sites however are fundamentals for understanding the molecular mechanisms behind cell functions and pathologies. They are, for pharmaceutical industry as for cosmetic industry, an essential key to help in the creation of active and specific compounds.

Moreover, existing in silico screening approaches only answer to three problems: (i) to search in a database for an existing compound able to bind a biological target; (ii) to create a compound able to bind a biological target; (iii) to search for molecules having a small structural pattern. These approaches which essentially allow selecting a compound able to bind a target, do not allow screening macromolecules (such as protein, DNA, RNA, lipids) which are the biological targets of small compounds, neither do they precise which are the other biological targets of these compounds.

It is becoming essential to be able to functionally characterise the biological macromolecules to better understand the function of a cell or of a pathology, of metabolic and regulation pathways, and to better identify the mode of action of these compounds. For instance, we wish to know the different targets and binding sites of a compound for a given cellular type, or, to determine if the compound may interfere with biological interfaces and as a consequence disrupts the smooth functioning of the cell. A better characterisation of macromolecules, of their regions and of their binding sites would in particular provide a way to evaluate and modulate the efficacy and the possible causes of toxicity of a compound in a cellular context defined by a set of macromolecules.

The different steps described in the following descriptions will help to deepen the knowledge of an object by detailing its remarkable properties (later called “structural fingerprints”) and to evaluate its interactions with other objects in a well defined environment (i.e. in biology, a cellular environment; in robotics, an assembly line; in biometrics, a collection of fingerprints; in artificial intelligence, a three-dimensional reconstruction of the environment). The method also provides for the description of the object and of its environment, in order to specify the frequency of the subparts that compose the object, and in particular to detect the subparts that make the object unique in the studied environment.

The invention is therefore intended to provide a method for characterising three-dimensional elements allowing comparing with accuracy, performing high-throughput screening, regrouping and/or differentiating objects of an environment according to their three-dimensional structures.

Another goal of the invention is to determine in silico, the remarkable properties of some parts of the three-dimensional objects, in particular geometric and/or physico-chemical and/or evolutionary remarkable properties; that is a set of properties important for the field and for the studied application.

The invention is also intended to provide, for a given three-dimensional object having desired properties in its field and/or area of application, a method to detect and characterise one or more objects having either complementary or similar properties of the desired properties, and to infer functions to the screened object, either by similarity or by complementarity with other objects of the environment.

Another objective of the invention is to provide a method allowing the accurate, fast, traceable and reproducible screening of three-dimensional objects, whatever their size, their type or their properties.

Finally, an objective of the invention is to provide cartography (i.e., a mapping) of a given three-dimensional object, by analysing and gathering all information concerning this object in a simple and descriptive three-dimensional visualization.

The objectives cited above are achieved thanks to a method for characterizing a molecule, comprising the steps of:
Generating a three-dimensional representation of the molecule;
Compute remarkable properties at each point of the three-dimensional representation of the molecule;
Generating at least one region of said molecule from its three-dimensional representation and remarkable properties at each point, and
Screening said region and/or a complementary to the region in a database comprising a set of prerecorded molecular regions to obtain at least one region similar or complementary to the screened region.

Other features, goals and advantages will become more apparent upon reading the detailed description that follows, and attached drawings given as non-limiting examples and in which:

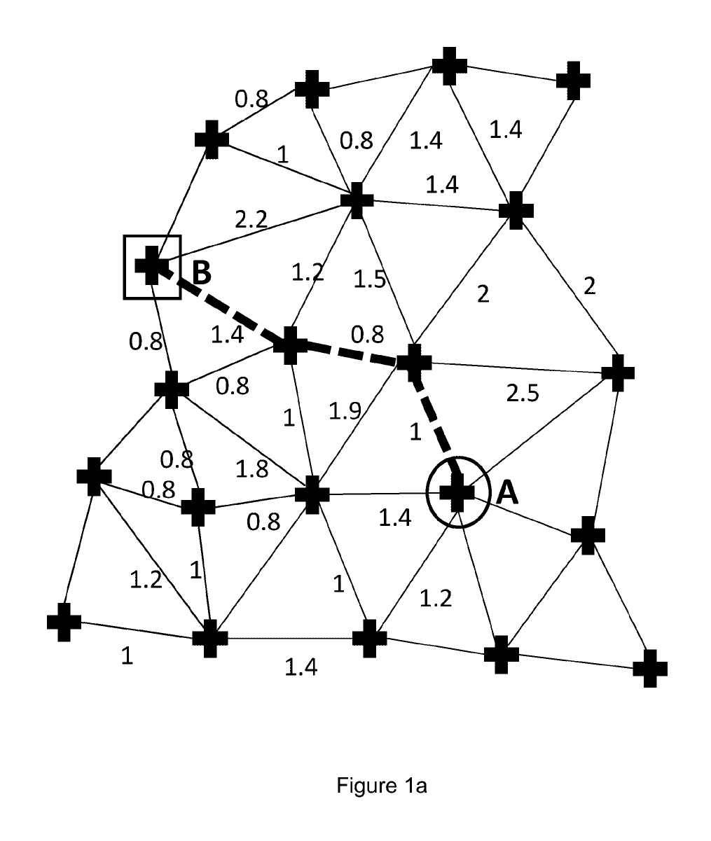

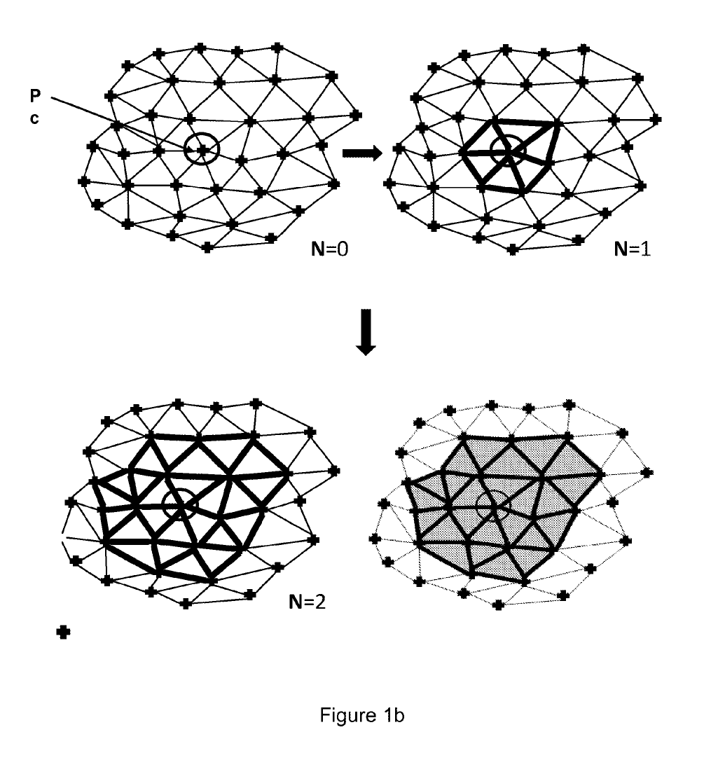

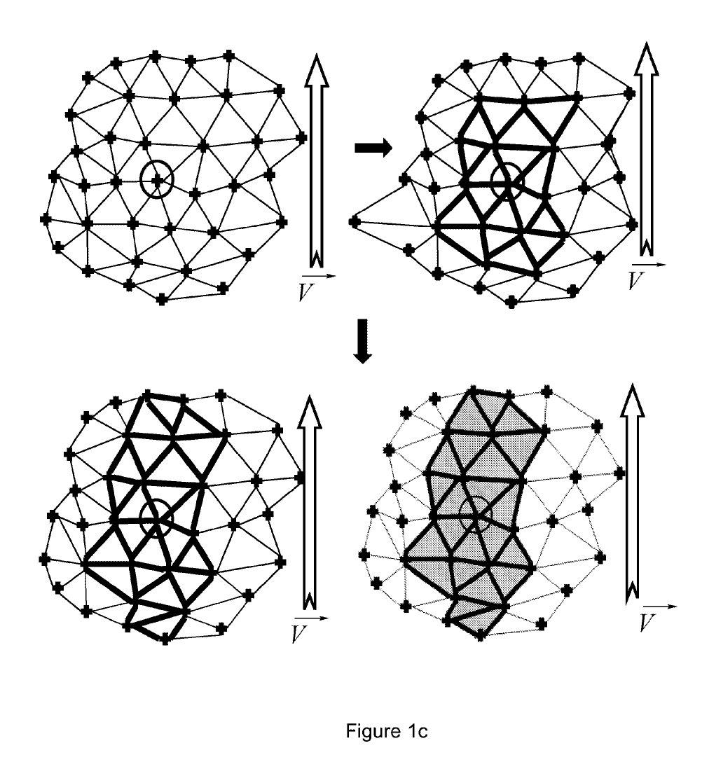

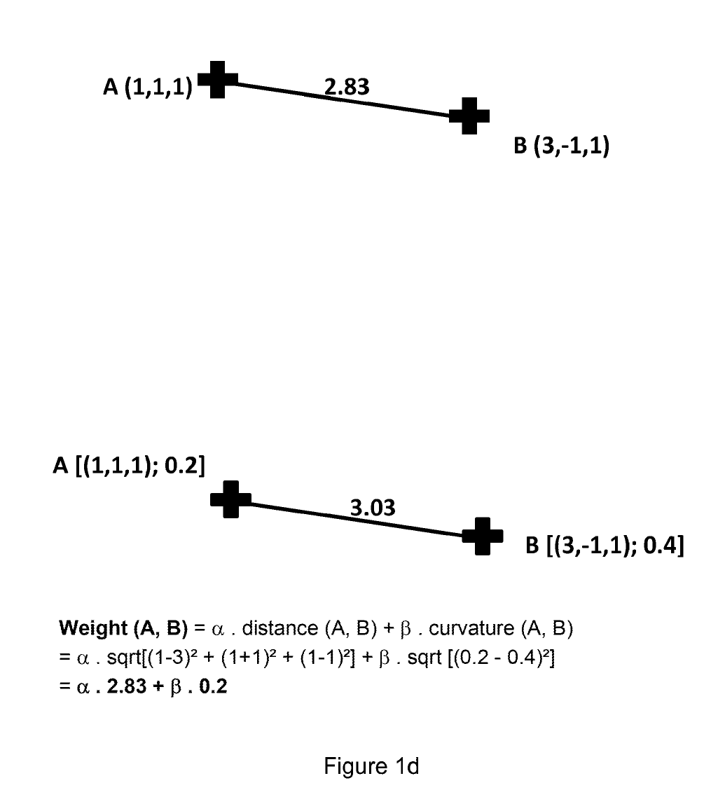

FIG. 1a illustrates the approximation of a geodesic distance between two points by travelling along the shortest path of weighted edges in accordance with an embodiment of the invention;

FIG. 1b illustrates the generation of a region from the mesh or graph of any object in accordance with an embodiment of the invention;

FIG. 1c illustrates the generation of a region under a directional vector constraint from a mesh or graph of any object in accordance with an embodiment of the invention;

FIG. 1d illustrates the computation of a distance between two points according to their characterising properties;

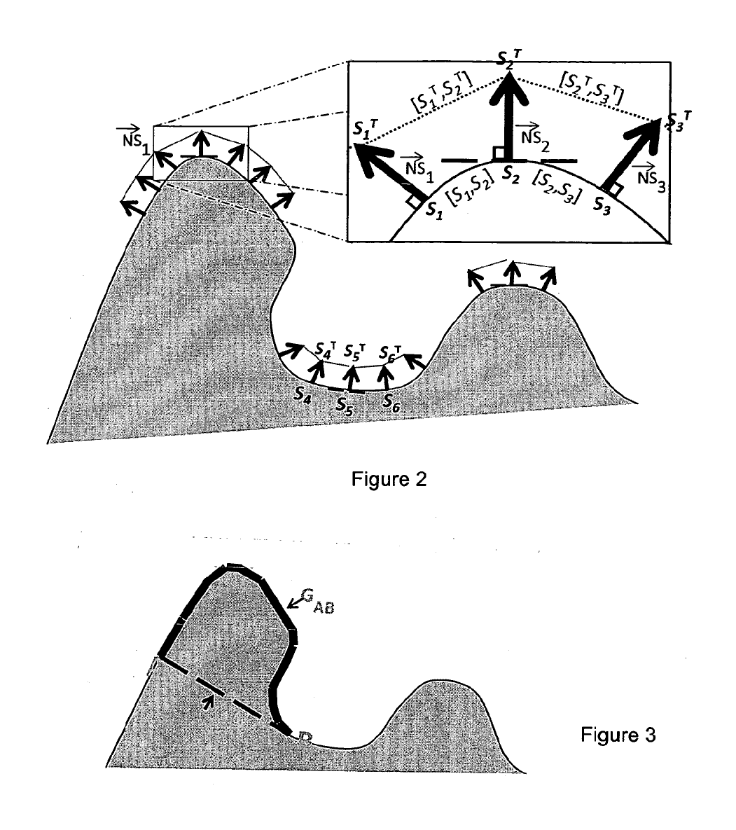

FIG. 2 illustrates the computation of the local curvature on any surface points in accordance with an embodiment of the invention;

FIG. 3 illustrates the difference between a geodesic distance and a Euclidian distance in the sense of the invention;

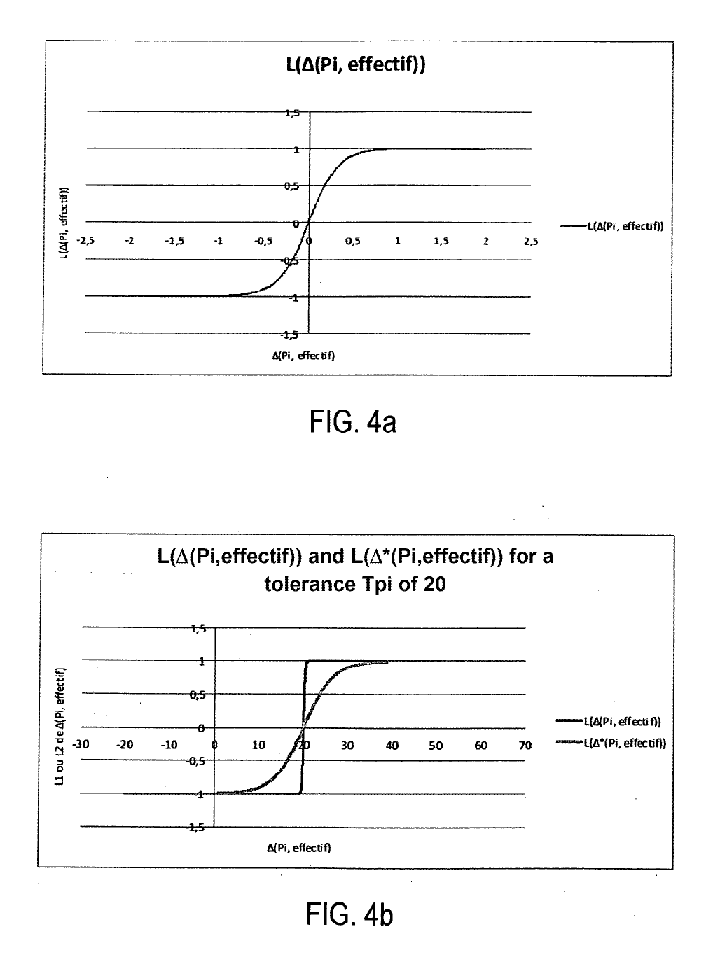

FIG. 4a illustrates the behaviour of a logistic function L, used in the computation of an energy score, following the deviation Δ of values of a property given two points;

FIG. 4b illustrates the behaviour of a logistic function L for a given tolerance, for a deviation of property Δ and a normalised deviation of property Δ* between two points;

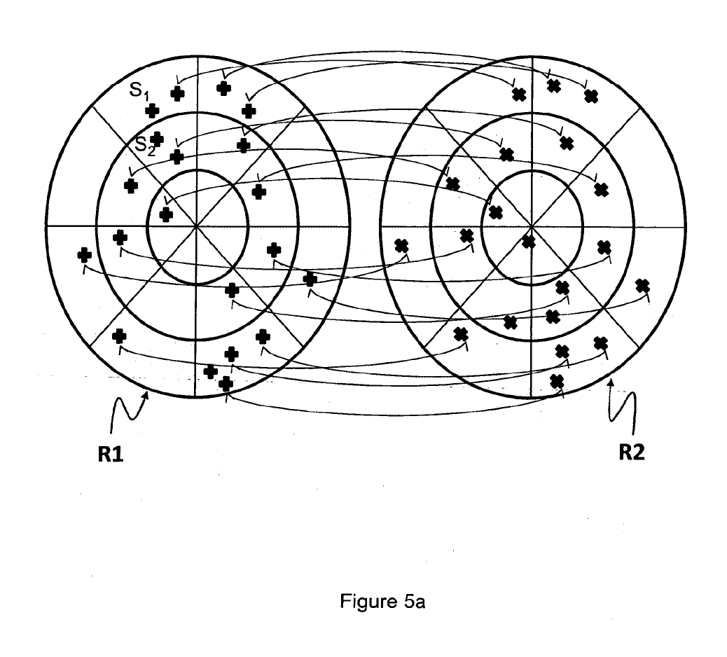

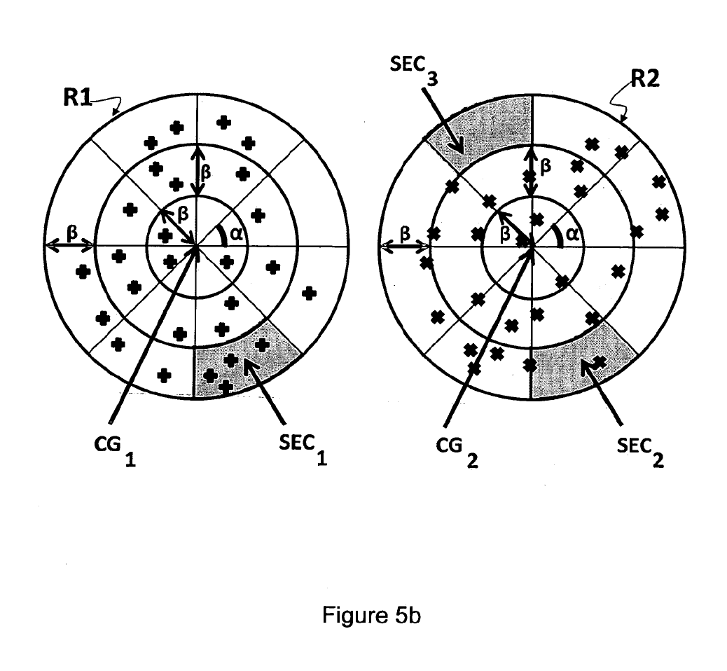

FIG. 5a illustrates an example of a matching scheme between the points of two regions;

FIG. 5b illustrates a first embodiment of the alignment of two regions to be compared;

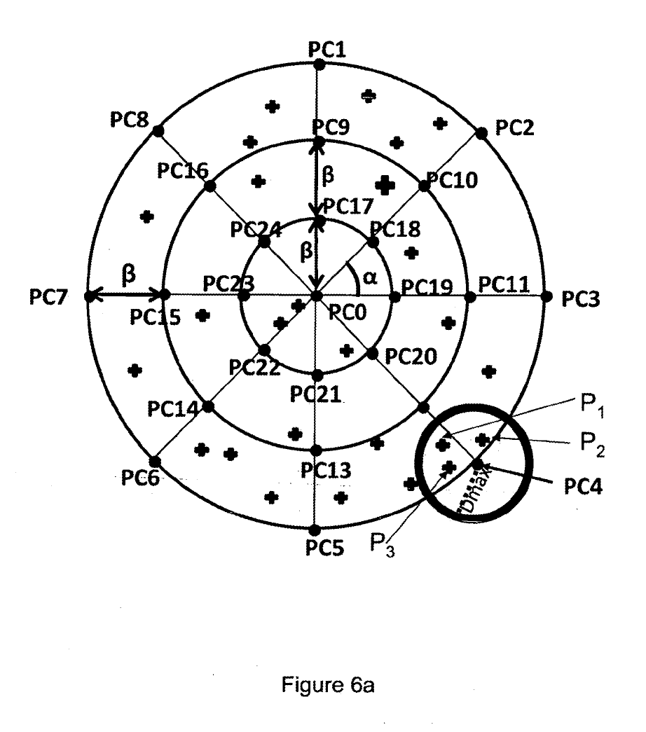

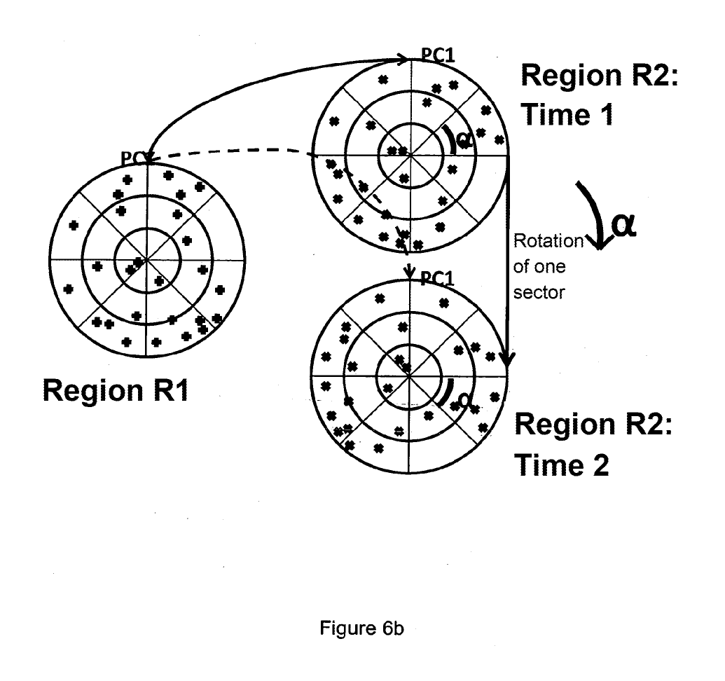

FIGS. 6a and 6b illustrate a second embodiment of the alignment of two regions to be compared;

FIG. 7 illustrates the alignment of a region L with several other regions in order to locate the specific points of L, which can in particular serve as anchor points for the development of more specific molecules;

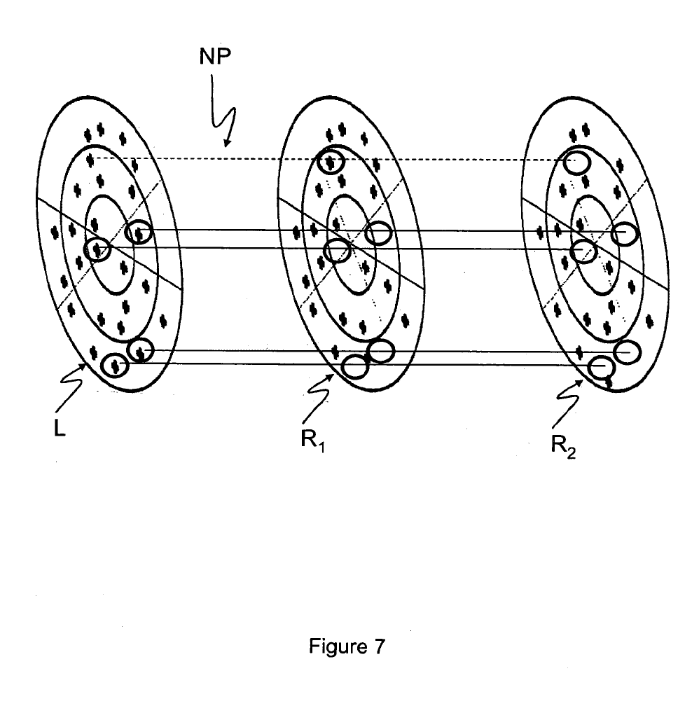

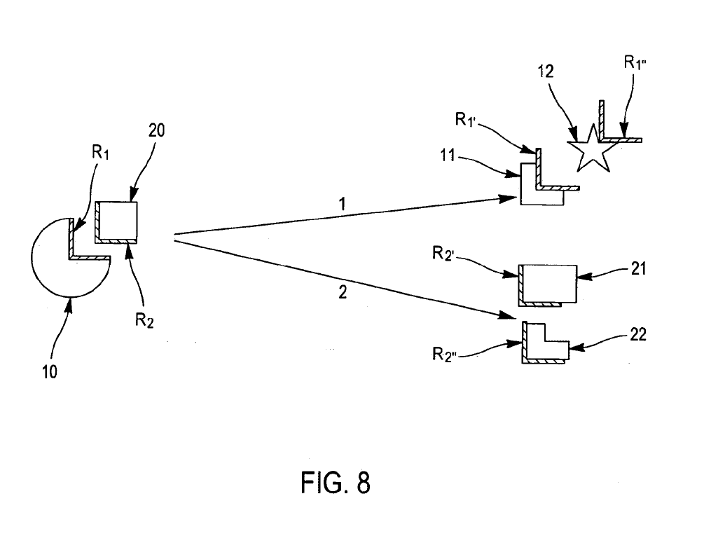

FIG. 8 illustrates in general the method according to invention, allowing retrieving collections of objects having either similar regions, or complementary regions.

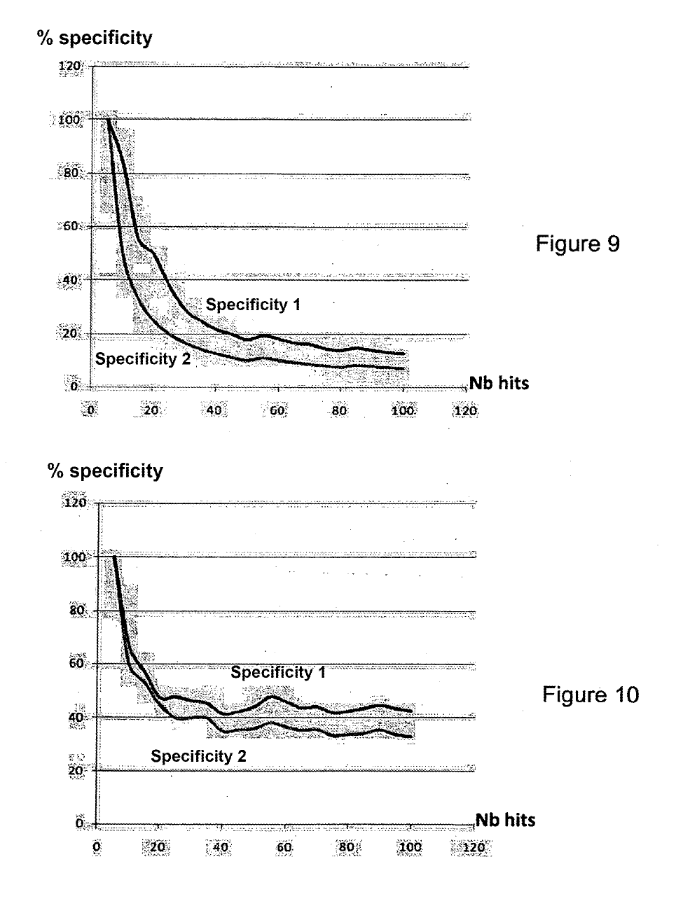

FIGS. 9 and 10 are two figures indicating the accuracy of the screening of FAD (Flavin Adenin Dinucleotide) and of mannose, respectively in function of the number of hits considered.

A three-dimensional object is defined by spatial localisation of a set of points in an arbitrary coordinate system, where each point can be characterised by a size, a distribution probability for its location, and a set of distinct properties that give a detailed description of the object at this point.

The three-dimensional object can be hollow (only defined by the points of its envelop), or full (this is the case for molecules, where each point defining the object corresponds to an atom).

The envelop (or surface) of the three-dimensional object defines the set of points of the object directly in contact with the external environment, or close enough in order to participate to contacts with the external environment under certain conditions (in particular in the case of deformable objects).

A three-dimensional object is said to be deformable if its structure is malleable, that is if all or part of its points can change of spatial location.

Those changes, which alter the coordinates of all or part of the points of the objects, may have important consequences such as the definition of a new envelop for the three-dimensional object.

For instance, a molecule is considered to be a full and deformable object, whereas an industrial tube is considered as a hollow and undeformable object.

The atoms constituting a molecule have different sizes that depend in particular of their local and global environments. The modelling of molecular surfaces is therefore quite complex, in the sense that it is necessary to take into account the intermolecular atomic interactions, but also the deformations of those surfaces induced by the interactions with some partners and by some more or less pronounced variations of the environment.

### Modelling of the Three-Dimensional Object

We will describe the characterising method (or characterisation method, or process) according to the invention for any three-dimensional object.

According to this invention, we first model this object by reconstructing its surface and optionally its internal volume.

To do so, numerous algorithms exist and allow reconstructing with more or less fidelity the surface and the internal volume of the object.

We can distinguish in particular the exact reconstruction, used more for visualisation than for computer analysis due to its high complexity, and the simplified reconstruction discretising the surface and/or the volume of the object for computer analysis. Generally, a simplified reconstruction is sufficient to characterise the properties of an object with results equivalent to those produced by an exact reconstruction.

Among simplified reconstruction, the tessellation of Voronoï is of particular interest (the Voronoï tessellation allows determining the area of influence of each point) and can be used to construct the Delaunay complex in which the whole object is divided so that each edge somehow links the closest points in a given direction. The alpha complex is derived from the Delaunay complex by conserving the edges for which the size is inferior to a threshold.

In particular, the alpha shape obtained from the Delaunay complex (also called dual shape when alpha=0) provides an envelop of the three-dimensional object, and therefore allows modelling its surface. The Delaunay complex, the alpha complex and the alpha shape (H. Edelsbrunner) have the advantage of being simplified reconstructions that keep intact the location of the points of the object.

It is also possible to reconstruct the surface of a three-dimensional object using approaches such as marching cube, marching tetraedra or spherical harmonics.

During the systematic analysis of objects, we thus favoured either a simplified reconstruction or an exact reconstruction without interpolation and with a resolution specific to the problem given in order to simplify its representation. In particular, it is possible to use low-resolution representations where the object is described by a low number of facets, in order to perform a first filtering before heavier and more detailed comparisons.

Furthermore, the inside of the object corresponds to the points of the object that are not sufficiently close to the external environment.

For instance, in the case of molecules, the atoms belonging to the inside of the object are those which are not accessible to the external environment (through a computation of the atom accessibility), or that are not sufficiently close to the external envelop (in agreement with the notion of depth). This computation of accessibility or depth developed for the molecular analysis remains applicable for any full three-dimensional object.

In the case where the internal volume of the object is also required, it is possible to use in particular the Delaunay complex or the alpha complex, due to their ability to divide a full object into tetraedras, which is geometrical structure that can be conveniently used to determine the internal points of the object, therefore providing a construction method for internal regions (those that do not contain surface points) and intermediate (i.e., intermediary) regions (those containing both surface and internal points).

From the modelling of the three-dimensional object by one of these various surface reconstruction (or volume) methodologies, we generate a mesh of the object, that is a triangulation (or derivate of triangulation) of the points of the object and/or of the surface points in order to create and represent its three-dimensional surface or volume.

Advantageously, the mesh is then transposed into graphs of different types.

This transposition of the object mesh into a graph is optional but allows directly taking advantage of the robust and fast algorithms of the Graph Theory for the description, the analysis and the comparison of surfaces, regions of surfaces, intermediate regions and internal regions of the object.

In fact, the Graph Theory provides specifically optimised solutions. Concerning graph algorithms, some, such as the shortest path of Dijkstra, are of particular interest, as well as the determination of connected components, and for connected and triangulated graphs, of graph matching algorithms (also called “graph matching”) and of cliques detection.

For instance, the mesh can be transposed into a graph where each point of the mesh corresponds to a node in the graph and the triangulation of the mesh defines the edges of the graph.

It is also possible to define numerous graphs in which a node of the graph correspond to several points of the mesh, and where the definition of an edge relies on one or several criteria, such as having at least a predefined number of edges in the mesh between the two sets of points discretising the two nodes of the graph, in order to link these two nodes by an edge in the graph.

Preferably, the mesh is transposed into a connected and triangulated graph in order to benefit from several algorithms and heuristics of the Graph Theory, in particular those for the graph matching.

In one embodiment, the points of the three-dimensional object are gathered into several sets of points before the modelling of its surface and/or volume. Thus, the object mesh is generated from these sets of points, and its transposition into a graph gives a triangulation of these sets.

In the case of molecular surfaces, four graphs can be easily defined: the graphs of surface points, the graphs of surface atoms, the graphs of surface residues and the graphs of functional groups.

For a graph of surface points, each point of the surface mesh corresponds to a node in the graph and each edge of the mesh triangulation corresponds to an edge in the graph. This graph can be defined for the surfaces of any three-dimensional object.

For a graph of surface atoms, each surface atom (accessible to the external environment, that is having a positive accessibility (or ASA that stands for Accessible Surface Area) corresponds to a node in the graph and each interaction between surface atoms corresponds to an edge in the graph.

Alternatively, only a few of these interactions are taken into account, by performing a filtering on various geometrical and physico-chemical criteria.

We will notice that in the case of dual shape (also called alpha shape when alpha equals zero), the graphs of surface points and the graphs of surface atoms are strictly the same, given that a surface point corresponds exactly to a surface atom.

For the graphs of surface residues, each accessible residue (ASA>0) or each surface residue corresponds to a node in the graph and a predetermined number of interactions between the atoms of these residues (or the distance between their residues barycentre) are used to define an edge in the graph.

Finally, for the graphs of functional groups, every neighbouring atoms belonging to a same functional group (hydroxyl, carboxyl, ketone, etc) are gathered into a single node in the graph, and an edge links the functional groups that are in contact (atomic radius intersections of neighbouring groups) or sufficiently close (arbitrary distance criterion which can be added orientation and accessibility criteria).

More generally, from the mesh of a three-dimensional object, it is therefore possible to create numerous graphs characterising different properties and phenomenon specific to the object, to its surface, to its volume or to its intermediate zones.

For instance, for any object, it is possible to define a graph of surface curvatures in which (1) every surface points of the object having similar curvature values and being contiguous are gathered into a node in the graph, and where (2) an edge between two nodes is defined either by arbitrary criteria such as the distance of the difference between their average curvature values, or by the direct contact in the mesh of these group of points.

For any object having a spatial distribution of charges (such as an electric wire, a dipole, an integrated circuit, or a molecule), it is also possible to define a surface graph characterising this distribution of charges by gathering into a node of the graph, all the points in the mesh having similar charges and that are contiguous, and where an edge is defined either by arbitrary criteria or by the direct contact in the mesh of the sub-regions each having the points of the associated nodes.

Furthermore, it is possible to make a graph combining at the same time the curvature and the charge distribution, in which case the regions of a complex or the important zones of the object must exhibit at the same time a specific shape (curvature) and charge (for instance, a cationic or anionic plug, or a conductive or insulating anchor, etc.).

In fact, if it is possible to define graphs characterising a specific property of the three-dimensional object from its mesh, it is also possible to define graphs characterising a set of remarkable properties of the three-dimensional object (also called structural fingerprints) by gathering the points that have a sufficiently small distance between the numerical values of their properties.

When the object is full and its representation provides either a triangulation or a tetraedrisation of its internal points, it is also possible to define graphs of the internal regions of the object.

We differentiate the graphs and corresponding surface regions having only surface points, the graphs and internal regions having only internal points (which are not part of the surface), and the graphs of intermediate regions having both surface points and internal points.

Nevertheless, in this description, all the steps of the method according to the invention which are implemented on the basis of surface graph can be directly transposed for internal graphs as well as intermediate graphs.

### Generation of Regions and Structural Fingerprints

According to the invention, the characterising method has a step during which the studied object is divided into regions, in order to create new fields of application, to increase in an automated and systemic way our knowledge of the object, and to accelerate the step of comparison with other three-dimensional objects.

To do so, we generate one or more regions of the object, then we compare them to other regions belonging either to the same object, or to other three-dimensional objects, in order to determine if some of these regions are similar or complementary, and also in order to evaluate the representativeness (the frequency) of these regions given a set of objects. More generally, we will compare a region to a collection of regions representative of a field of application and of the question asked. We will also be able for instance to infer one or more functions to an object by similarity and/or complementarity of its regions with regions of other objects.

Advantageously, depending of the type of the given three-dimensional object (microscopic or macroscopic) and its deformability, we generate various shapes (or conformations) of this object using common approaches to obtain several secondary objects (derived) to be analysed by the method of the invention.

Optionally, we generate the stable conformations of regions by considering them as independent entities, in order to reduce the computation.

In the case of molecules, the molecular dynamic and the molecular mechanic allow describing their movements with both accuracy and fineness, and as a consequence, new sets of spatial coordinates for each point of the object, regardless of their location on the surface or internal.

In the case of molecular dynamic, it is also possible to analyse the possible change of conformation during a given time (typically microseconds).

Other approaches exist, in particular the normal modes that can be applied to any three-dimensional object, and during which a spring tension is applied to each edge of the mesh in order to generate its normal modes. The different conformations are obtained rapidly but are less accurate than those obtained by molecular dynamic or molecular mechanic. They nevertheless provide valuable insights into the main tendencies and into the most stable conformations of the three-dimensional object, of its surface and of its internal points.

Therefore, when we want to compare two deformable objects such as molecules, we advantageously generate the most stable conformations of these three-dimensional objects, and we apply the method according to the invention to each of these object configurations, rather than to only one. We then obtain more regions to compare, and generally more remarkable properties interesting for the area of application. Typically, and as it will be described in the following, we determine, for each of the object configuration, the remarkable properties at the level of each mesh point (or graph node), before (or sometime after) the division of each stable conformation of the three-dimensional object into regions, we then compare them to other collections of regions in order to determine a set of similar or complementary regions.

We will notice that when the probability distribution of point locations of an object exists (which is the case with the b-factor of molecules), we can use this information to generate new conformations or to guide the generation of stable conformations according to one of the methods described above (molecular dynamic, molecular mechanic, normal modes).

This optional step of generation of all or part of conformations increases the sensitivity of the approach, but can also reduce the specificity of the screening if too many conformations are considered. The invention nevertheless provides a way to compensate this loss of specificity during the quality evaluation of the alignment of regions, as we will see later in the description.

The method is then applied directly to the three-dimensional object or to the secondary objects derived from the generation of its different stable conformations.

We then generate a set of regions using one or more criteria defined from the representation of the three-dimensional object, either its mesh or its graph.

Several methods to define the regions of a three-dimensional object exist. Nevertheless, these methods do not ensure the notion of contiguity of the region, neither do they allow generating in a systematic and fast way, an exhaustive list of regions from an object with or without shape constraints: that is, contiguous regions of various sizes and shapes. The notion of contiguity is important because it ensures that we work on a unique undividable bloc, and not on a set of sub-blocs scattered in space: a contiguous region is the smallest undividable bloc, functional or not, of an object. The notion of contiguity is also necessary to generate the “complementaries” of a region (i.e regions which are complementary to an initial region and thus can bind this initial region).

A first existing method consists to gather all the points of the object that are inside a sphere of a given radius. Nevertheless, the definition of such surface regions does not ensure the notion of contiguity.

In particular, when we wish to describe an object by its regions, it is preferable to work on contiguous regions in order to unite or divide them, and thus building new sets of contiguous regions. Also, when working on a sufficiently big pattern, it is possible to divide it into contiguous subregions and to screen them separately, in order to detail the specific subregions of that object region and to better decrypt the functions of that object.

In the following examples, the approach to divide is implemented through the use of a graph derived from the mesh of the object. This is however not limiting in the sense where these methods can also be implemented directly from the mesh. The difference being that the Graph Theory algorithms would have to be adapted to work on mesh data structures.

It is also possible to implement an approach to divide the surfaces into contiguous regions either with a distance criterion, or following a criterion on the number of points belonging to the region, or following the remarkable properties of the object points, or by combining these criteria. In the case of the generation of regions based on remarkable properties, the obtained region is called a “structural fingerprint”: it characterises a remarkable region of the object obtained with no predefined criteria on the shape or size (as would be the case with a distance criteria). The use of a mesh and its associated graph allow to generate regions by travelling from a node of the graph, which ensure the contiguity of the region.

In the following, several criteria of segmentation of a three-dimensional object into three-dimensional regions will be described. This list of criteria is nevertheless not limiting and is given only for illustration purposes.

Furthermore, according to the method of the invention, the regions and structural fingerprints can be obtained from one or a combination of segmentation criteria, in order to obtain a vast number of regions and structural fingerprints.

Spatial Distance Criteria

For each surface point (or subgroup of points), we can approximate and calculate the geodesic distance between this point and any other on a surface.

The geodesic distance between two points of the object is approximated as the length of the shortest path—or of one of the shortest path if several exist—between the two points in the graph: this distance is therefore dependent of the object representation.

In this invention, the geodesic distances are generally used to gather the points of the object that are close enough (following the distance criteria, and/or the number of points) which is used create one or several contiguous regions.

For instance, in the case of a graph of surface points, each edge has for weight the Euclidian distance between its two linked points. An approximation of the geodesic distance between two points S1 and S2 is for instance the sum of Euclidian distances of the edges forming the shortest path between these two points.

On FIG. 1a is illustrated an example of approximation of the geodesic distance between two points A and B of a graph, including a set of points with edges each associated with a weight. On this figure, the weight between two adjacent points is written above the edge linking them: as we can observe, the geodesic distance between the points A and B is equal to 1+0.8+1.4=3.2 (following the dotted path in the graph).

Taking advantage of the robust Dijkstra algorithm for the determination of the shortest path and for the computational approximation of the geodesic distances, it is possible to create a novel and faster algorithm by using new end criteria, in order to reduce the computation to the only geodesic distances necessary to divide the object in regions.

To do so, the object mesh is transposed into a connected and triangulated graph G(S, A) with S nodes and A edges.

We then define a set (not empty) of surface points from which a region is to be created, and we choose one or more point(s) Pc in this region. Each point of this set is assigned an infinite distance, whereas to each of the Pc point(s) are assigned a zero distance.

The FIG. 1b illustrate the generation of a region from a graph. On this figure, the point Pc is the centre of the region to be created, the bold edges represent the selected edges to generate the region, and N is the number of edges that can be traveled starting from the centre Pc.

The travelling of neighbouring points allows determining the shortest path (and therefore the geodesic distances) between the points Pc of the starting set and every other points of the object. We will notice in this aspect that the graphs describing meshes are connected and triangulated and that since the weights of their edges are always positive (in the sense they represent a distance), there always is a shortest path between two points S1 and S2 of the graph.

We then use an end criterion to this algorithm by computing only the required distances. For instance, on the FIG. 1b, the grey region correspond to the region generated with an end criteria N=2 where N is the maximal number of edges that can be traveled in order to gather points inside the region.

This end criterion can be in particular a distance criterion, or a criterion on the number of points constituting the region in generation.

According to the distance criterion, we determine at each iteration of the algorithm what is the nearest point from the selected Pc point, among the list of remaining points to be treated (that is, the points for which a distance corresponding to their shortest path to the point(s) Pc is still to be assigned). When the distance between a given point and the point Pc is greater than a predetermined threshold, the algorithm stop and return the list of points that have treated. The points treated correspond to the set of points contiguous to the point(s) Pc and are at geodesic distance smaller or equal to the designated threshold. Every other point that has not been treated is necessarily at a geodesic distance of the point(s) Pc greater than the distance threshold.

With the number criterion, the iterations of the algorithm stop when we have selected at most the designated number of points.

Alternatively, we generate ring-shaped regions by not selecting (or by removing from the obtained region) the set of points for which the distance between them and the chosen point(s) Pc are inferior to the minimal distance threshold.

If we use a volume representation of the object such as the Delaunay complex or the alpha complex (which also model the internal points and the edges that link them), the method is generalizable and allows the generation of internal and intermediate regions from the computation of geodesic distance between any two points of the object.

Distance Criterion Dependent of Remarkable Properties

Following another embodiment, the segmentation of the object into contiguous regions is implemented following the states of remarkable properties, that is geometric, physico-chemical or evolutionary, (etc.) properties having an interest in the field of or for the application in which the object is studied, in order to automatically generate the regions that correspond to one or more of these properties. These regions characterising well-defined states of the objects are built with no a priori of shape and size and are consequently called structural fingerprints. Of course, one at least of the properties used for the generation of the structural fingerprint can be a spatial location property: we naturally obtain a region following the distance criterion, which can also characterise other remarkable properties of the object.

Typically, those properties can be: (1) spatial location (point coordinates of the object); (2) local surface curvature; (3) the orientation of the local normal to the surface or normal to a point of this surface; (4) the local flexibility index (obtained for instance by approaches such as molecular dynamic or molecular mechanic, as well as normal modes); (5) the local malleability index (obtained for instance from the flexibility data and/or from the spatial location of cavities, voids and low-density zones of the objet); (6) the presence of functional group (hydroxyl, carboxyl, etc); (7) the electrostatic potential or the local charge; (8) the local conductivity index, dependent for instance of the used materials in each point of the object; (9) the local density (also dependent from the material used); (10) the local resistance (being derived from either pre-established measures or determined by an approach similar to the one used for malleability); (11) in the case of molecules, the score of conservation determined from the multiple alignment of sequences or from the structures of homologous molecules. This score of conservation informs on the observed variability for a given residue (or for a set of atoms) during Evolution (and in a few cases for a specific clade). Once the multiple alignment is obtained, it can be computed for instance with the Shannon Entropy, derived from the Information Theory; (12) the score of coevolution of the region, determined by the multiple alignments of sequences or homologous structures, by observing if the evolutionary changes of one residue (or a group of atoms) seem to be correlated to the evolutionary changes of other residues (or sets of atoms). It informs on the possible functional links between different regions of the molecule, in particular in the case of allosteric phenomena.

This embodiment can in particular be combined to the previous embodiment, in order to generate the regions and/or structural fingerprints having both the geometric, physico-chemical and evolutionary remarkable properties and respecting the distance criterion.

To do so, the studied properties must be digitizable, and optionally normalizable.

Advantageously, to implement this embodiment, the mesh of the three-dimensional object is transposed into a graph in order to have access to the Graph Theory tools.

It is then possible to compute, for a given property P having for instance value inside [0, 1], a distance specific to this property between the two nodes N₁ and N₂ of the graph corresponding to the points S1 and S2 of the mesh of the given three-dimensional object (FIG. 1d).

For instance, one can compute the distance (Euclidian, Manhattan, etc., and for one or more properties) between two nodes N₁ and N₂ directly linked by an edge by computing the distance between the values P(N₁) and P(N₂).

In the same way, one can compute the geodesic distance between two given nodes N₁ and N₂ not directly linked by computing the sum of their sub-distances derived for the shortest path between the nodes N₁ and N₂.

For a property P, the geodesic distance D_{P}(N₁,N₂) between the two nodes N1 and N2 is then given by:

D_{P}(N₁,N₂)=\sqrt{[P(N₁)−P(N₂)]²}

More generally, given n properties P₁, P₂, . . . , Pₙ having values on the interval [0, 1], the geodesic distance

$${D}_{{\sum }_{i}^{n} {P}_{i}} ( {N}_{1 ,} {N}_{2} )$$

between the states of these properties for the nodes N₁ and N₂ is generalized by:

$${D}_{{\sum }_{i}^{n} {P}_{i}} ( {N}_{1 ,} {N}_{2} ) = \frac{1}{n} {\sum }_{i}^{n} \sqrt{{[ {P}_{i} ( {N}_{1} ) - {P}_{i} ( {N}_{2} ) ]}^{2}}$$

The parameter 1/n is optional but allows normalizing the distance by the number of properties. By assigning a weight w(N₁,N₂) to the edge linking the nodes N₁ and N₂, the Euclidian distance

$${D}_{{\sum }_{i}^{n} {P}_{i}} ( {N}_{1 ,} {N}_{2} )$$

computed from the different states between the nodes N₁ and N₂ for the properties P₁, P₂, . . . , Pₙ, it becomes possible to generate regions from the set of properties, with no a priori of shape nor size. These structural fingerprints characterise regions that are generally important and specific to the object, to a sub-family or to a family of objects. This novel description of three-dimensional objects increases the knowledge that can be systematically extracted with no human intervention from the structure of object and from properties such as curvature, charge distribution, or colorimetric indexes also assigned automatically. This automatic characterisation of the structural fingerprints of object (remarkable regions) has applications in particular in Artificial Intelligence (AI) in order for the robots to better describe and interact with their environment, as well as to establish classifications (links, ranks) between objects from their structural fingerprints. In biology, this characterisation allows to better describe and compare the molecules, in particular to classify (i.e., rank) them and better understand their various functions. In image analysis, by using a property such as the colour or the grey tone, it can be used to select the regions of the image having a similar colour or grey tone. In particular, the approach then allows to determine the contour of objects and to select those that are part of an image by accepting a configurable error factor allowing for the growth of a region describing an object.

Alternatively, the weight w(N₁,N₂) assigned to the edge linking two nodes N₁ and N₂ can be defined as the Manhattan distance

$${D}_{{\sum }_{i}^{n} {P}_{i}} ( {N}_{1 ,} {N}_{2} ) = {\sum }_{i = 1}^{N} \vert {P}_{i} ( {N}_{1} ) - {P}_{i} ( {N}_{2} ) \vert ,$$

the p^{th} distance of Minkowski

$${D}_{{\sum }_{i}^{n} {P}_{i}} ( {N}_{1 ,} {N}_{2} ) = p \sqrt{{\sum }_{i = 1}^{N} {\vert {P}_{i} ( {N}_{1} ) - {P}_{i} ( {N}_{2} ) \vert}^{p}} ,$$

or the Chebyshev distance

$${D}_{{\sum }_{i}^{n} {P}_{i}} ( {N}_{1 ,} {N}_{2} ) = lim {}_{p \to ∞} \sqrt[p]{{\sum }_{i = 1}^{N} {\vert P ( {N}_{1} ) - P ( {N}_{2} ) \vert}^{p}} .$$

To favour (respectively to unfavour) a property Pi with respect to one (or several) other property(ies) Pⱼ, it is possible to weight the importance of each of the properties Pᵢ, Pⱼ. We then obtain the following equations, where aᵢ is a weighting factor of the Pᵢ property:

$${D}_{{\sum }_{i}^{n} {P}_{i}} ( {S}_{1 ,} {S}_{2} ) = ∓ \frac{1}{card ( P )} {\sum }_{i}^{n} {a}_{i} \sqrt{{( {P}_{i} ( {S}_{1} ) - {P}_{i} ( {S}_{2} ) )}^{2}}$$

$${D}_{{\sum }_{i}^{n} {P}_{i}} ( {S}_{1 ,} {S}_{2} ) = {\sum }_{i = 1}^{N} {a}_{i} \vert {P}_{i} ( {S}_{1} ) - {P}_{i} ( {S}_{2} ) \vert$$

$${D}_{{\sum }_{i}^{n} {P}_{i}} ( {S}_{1 ,} {S}_{2} ) = \sqrt[p]{{\sum }_{i = 1}^{N} {a}_{i} {\vert {P}_{i} ( {S}_{1} ) - {P}_{i} ( {S}_{2} ) \vert}^{p}}$$

$${D}_{{\sum }_{i}^{n} {P}_{i}} ( {S}_{1 ,} {S}_{2} ) = lim {}_{p \to ∞} \sqrt[p]{{\sum }_{i = 1}^{N} {a}_{i} {\vert {P}_{i} ( {S}_{1} ) - {P}_{i} ( {S}_{2} ) \vert}^{p}}$$

Furthermore, to detect the structural fingerprints of a three-dimensional object, it is possible to determine a minimal number of points constituting the fingerprints in order for it to be of sufficient size following the criteria of the desired application.

In the case where the property Pᵢ is the location (coordinates), this criterion correspond to the spatial distance criterion previously described, in which the geodesic distance between two states of property is equal to the spatial distance over the surface of the object and between the two associated points.

The generation of structural fingerprints (that is of regions generated with no a priori of shape or size) on the basis of the state of remarkable properties in each of the object is therefore done following an algorithm similar to the one used to generate the regions on the basis of the spatial distance criterion. Nevertheless, in the case of a structural fingerprint characterising one or more given remarkable properties, we also consider the state of this property (isolation of a zone, its conductivity, the depth of a cleft, its flatness, etc). Therefore, rather than assigning a zero value to the nodes forming the centre of the region as in the case of distance criterion, we assign to them a value equal to the distance between their real state and the desired state for this remarkable property (that is for the curvature property, the desired state is for instance a cleft with a numerical value close to 0, and the real state of a point is its own computed curvature value). This difference allows to take into account from the beginning of the fingerprint generation, the error given by the state at the centre, and to limit the growth of the fingerprint due to this original error. More generally, during the initialisation step to determine the structural fingerprint, we assign to every points of the mesh object (or to its associated graph), the distance between their real states and the desired states.

For instance, in the case we wish to find the set of cleft regions of the surface of an object, that is, the sets of contiguous points which have a curvature value Ps close to 0—examples of this computation of local curvature of a region will be given later in this description—, we first determine the curvature value of each point of the object surface, and we choose a point from the object to generate a region corresponding to a cleft following the curvature values assigned to each point. For curvature value P(Cᵢ)=0.2 in Cᵢ, we then assign an error value ∥P(Cᵢ)−P_{S}∥ to Cᵢ equal to 0.2, then we grow the region until a given error threshold (generally low) on the states of the desired properties. For instance, to detect the clefts of a three-dimensional object, one can search a state of curvature close to 0, and use an error threshold of about 0.1 allowing for the flexible growth of the region.

By iterating on every surface point, it is then possible to identify all the cleft regions of the surface of the object.

When several properties are considered, we assign to every points of the object mesh (or to its associated graph) the sum of the distances between each of their states and the desired states. As seen previously, this sum of distances can nevertheless be normalized by the number of properties in order to use an extension value independent of the number of properties. Otherwise, if N properties were to be chosen, then the extension parameter of structural fingerprints should be approximately k*N where k would be the extension value if only one property was used.

The obtained regions therefore characterise specific aspects of the studied three-dimensional objects.

In the case of molecular surfaces, it is then possible to characterise the object by dividing it into cleft and conserved regions (which are first-class targets for active compounds), or into cleft regions having a given electrostatic potential (which is important in particular in Drug Design), etc.

In the case of industrial use, it is possible to systematically search the regions of a three-dimensional object being both insulating and resistant.

In the case of surgery use, the approach following the invention allows to define the damaged regions of a tissue or an organ, as well as their limits, by using in particular remarkable properties such as colorimetric data (highlighting a lesion), curvature properties or again the resistance of a tissue. This method, as previously illustrated, can also be used to generate the regions defining existing objects of an image, from the structural fingerprints generated from the distance between pixels and on the colorimetric state of points.

In other fields such as robotics, properties such as curvature, flexibility, density, resistance, conductivity or isolation of object are important and can be taken into account for instance to determine the best region, following the selected criteria, to be used for the docking of a robotic arm.

All of these regions, defined either by distance criterion or following remarkable properties, can be automatically generated both efficiently and rapidly.

Furthermore, the generation of such regions allows gathering and classifying the complex three-dimensional objects from which they are created, following the presence of these regions or structural fingerprints, characterising specific properties and abilities of the three-dimensional object.

In particular, the generation of those regions can be used to simplify the representation of three-dimensional objects or of bigger regions.

For instance, following an embodiment, we define a graph in which each node is a region obtained from one or more remarkable property(ies), and where each edge is a link between two of these regions, defined either by an existing contact in the initial mesh between these regions, or by an arbitrary distance criterion between the states of properties of these regions. That way, we simplify the comparison of three-dimensional objects by comparing the graphs of their regions.

In the same way, a region can be described by sub-regions obtained from a set of properties, in particular physico-chemical and/or geometric properties, in order to simplify the representation and the subsequent comparison with other regions and three-dimensional objects.

Describing a region R in subregions can also be used to determine the specific sub-regions of R, that is, the subregions that can be find uniquely on the considered object in a given environmental context: examples of environments are a cellular environment, an assembly line with different objects and tools, a photograph or a three-dimensional scene containing several objects. The modelling of an environment is then achieved by gathering in a database the collection of regions and structural fingerprints that can be generated from the objects belonging to that environment.

Propagation Criteria (Shape Constraints)

Following another embodiment, contiguous regions are created also by using propagation criteria (shape criteria) on the region.

To do so, we define a vector \vec{V} oriented in the plan of the graph, then we weight the growth following the direction and/or orientation of each edge of the graph with respect to the vector \vec{V}. Thus, the weight of an edge (defined following the distance criterion and/or following remarkable properties) linking two points S₁ and S₂ of the graph will be equal to the distance separating them plus a factor taking into account the angle (\vec{S₁S₂},\vec{V}) between the edge and the vector \vec{V}: the lower the angle (or the orientation) between the edge \vec{S₁S₂} and the vector \vec{V} is, the lower the weight of this edge will be, and inversely:

Following the direction of \vec{V}:

w_{d}(\vec{S₁S₂})=w(\vec{S₁S₂})+K_{d}|sin(\vec{V},\vec{S₁S₂})|

Following the orientation of \vec{V}:

$${w}_{o} ( \vec{{S}_{1} {S}_{2}} ) = w ( \vec{{S}_{1} {S}_{2}} ) + {K}_{o} sin ( \frac{( \vec{V} , \vec{{S}_{1} {S}_{2}} )}{2} )$$

Where w(\vec{S₁S₂}) is the weight of \vec{S₁S₂}; and

(\vec{V},\vec{S₁S₂}) is the angle in radian between vectors \vec{V} and \vec{S₁S₂}; and

Kd and Ko are constants.

We then obtain regions elongated in the direction or the sense of the constraint vector \vec{V}.

The FIG. 1c illustrates in particular the generation of a region from the graph of an object with a constraint vector \vec{V}, and as centre of the region, the point Pc. Again, the selected edges for the generation are in bold, and the obtained region is in grey.

In the same way, it is possible to generate regions of arbitrary shape by defining several vectors \vec{V}₁, \vec{V}₂, . . . , \vec{V}ₙ and by applying the propagation criterion with each one of them:

Following the direction of \vec{V}₁, \vec{V}₂, . . . , \vec{V}ₙ:

w_{d}(\vec{S₁S₂})=w(\vec{S₁S₂})+K_{d1}|sin(\vec{V}₁,\vec{S₁S₂})|+K_{d2}|sin(\vec{V}₂,\vec{S₁S₂})|+ . . . +K_{dn}|sin(\vec{V}ₙ,\vec{S₁S₂})|

Following the orientation of \vec{V}₁, \vec{V}₂, . . . , \vec{V}ₙ:

$${w}_{o} ( \vec{{S}_{1} {S}_{2}} ) = w ( \vec{{S}_{1} {S}_{2}} ) + {K}_{o 1} \frac{\vert sin ( \vec{{V}_{1}} , \vec{{S}_{1} {S}_{2}} ) \vert}{2} + {K}_{o 2} \frac{\vert sin ( \vec{{V}_{2}} , \vec{{S}_{1} {S}_{2}} ) \vert}{2} + … + {K}_{on} \frac{\vert sin ( \vec{{V}_{n}} , \vec{{S}_{1} {S}_{2}} ) \vert}{2}$$

Where w(\vec{S₁S₂}) is the weight of the edge \vec{S₁S₂}; and

K_{d1}, . . . , K_{dn} et Kₒ₁, . . . , Kₒₙ are constants

Alternatively, it is possible to disadvantage the growth of the region following the direction (respectively the orientation) of one or more vectors by increasing the weight of the edge when the angle between the edge \vec{S₁S₂} and the vector \vec{V} is low.

Furthermore, the growth of the penalty can be adapted by applying different operators such as the square root or the exponential to K(\vec{V},\vec{S₁S₂}).

Other ways to determine the weight of edges following the orientation or direction of at least one vector are possible.

For instance, in the case of growth controlled by an orientation constraint vector, the following equation can also be used:

wₒ(\vec{S₁S₂})=w(\vec{S₁S₂})+K_{π}└π−|(π−(\vec{V},(\vec{S₁S₂})∥π∥|┘

Where ∥π∥ is modulo π; and

K_{π} is a constant. In this embodiment, the penality K_{π}└π−|(π−(\vec{V},(\vec{S₁S₂})∥π∥|┘ is increasing on the interval [0, π[ and with values on [0,π], whereas on the interval ]π,2π[, the penality K_{π}[π−|(π−(\vec{V},(\vec{S₁S₂}))∥π∥|] is decreasing and with values on [π,0]. For an angle of 0, a penality of 0 must then be assigned, and for an angle of π, a penality of π must be assigned.

Following another embodiment, we take into account the global orientation of the region in the three-dimensional space (if the vector is three-dimensional), or of its simplified orientation in the tangent plan at Pc from which the region is extended, by projecting the vectors \vec{V} and \vec{S₁S₂} in the target plan.

Orientation Criterion of the Contour

Following yet another embodiment, particularly adapted for the regions of small objects and that can be combined to the previously described embodiments, we define regions by limiting the contour to a given orientation, in order to select only the interesting region of the object rather than the whole object (due to its small size).

In fact, if the object is sufficiently small and a generated region is sufficiently big, the obtained region is not only contiguous, but also cyclic and encompasses the whole object, in the sense that a point at one extremity of the region is connected to the point at the opposite extremity. In an extreme case, the region is exactly the envelop of the object.

Following another embodiment of this segmentation criterion, we generate a region Rᵢ following any of the previous algorithm, typically following the distance criterion.

In a second step, we define a surface normal \vec{NR₁} of the region by computing the average of the surface normals of the facet (or of the surface normals of the points, each surface normal of a point is obtained by averaging the surface normal of the facets adjacent to this point) of the

$$\vec{{NR}_{i}} = \overline{\vec{{NS}_{i}}} = \frac{1}{card ( {NS}_{i} )} {\sum }_{{s}_{i} ⋐ {R}_{i}} \vec{{NS}_{i}}$$

Where Sᵢ is a point of the region;

{right arrow over ( N̅S̅ᵢ̅ is the surface normal of a facet having the point Sᵢ, or the surface normals of the point Sᵢ;

This averaged surface normal can be weighted by the geodesic distance (or the Euclidian) of the surface normals of a point of the region, the area of the facet having the surface normal, the combination of both the distance and the area of the facet having the surface normal, etc.

We then generate the contour CRᵢ of the Rᵢ region. To do so, we choose a point Cᵢ of the region Rᵢ, typically its barycentre.

In a third step, we determine the point CPᵢ of the region for which the geodesic distance between this point and the point Cᵢ is the greatest and then, among the set of points of the region Rᵢ which are adjacent to the point CPᵢ, we determine the point P_{adj,i}, which is separated from the point Cᵢ by the greatest geodesic distance.

The points CPᵢ and P_{adj,i} are therefore, by definition, two points of the contour CRᵢ.

We then iterate the method starting from the point that has just been determined, in order to gather the points P_{adj,i}, P_{adj,i+1}, . . . , P_{adj,n} located on the contour of the region Rᵢ, and this until the adjacent point P_{adj,n} different from the point CPᵢ.

We thus determine, step by step, the whole set of points which belong to the contour CRᵢ of the region Rᵢ.

Once the contour of the region has been determined, we define an angle threshold, then we remove the set of points P_{adj,k} among the points CPᵢ, P_{adj,i}, P_{adj,i+1}, . . . , P_{adj,n} of the contour CRᵢ, for which the angle (\vec{NP_{adjk}_{ᵢ}},\vec{NRᵢ}) is greater than the threshold.

Where \vec{NP_{adjk}} is the surface normal of the point P_{adj,k}; and

\vec{NRᵢ} is the surface normal of the region Rᵢ.

We then obtain a subregion R_{i,1} of the region Rᵢ, having all the points of the original region Rᵢ, excepting points P_{adj,k} of the contour CRᵢ which did not respected the orientation criteria, that is, those points which had an angle between their surface normal and the surface normal of the region greater than an angle threshold.

We then iterate the method on the region R_{i,1}, in order to remove from the contour of the region R_{i,1}, all the points which do not meet either this criteria.

Step by step, we then obtain a region R_{i,j} from the initial region Rᵢ, for which the contour meet the requirements of the orientation criteria.

Following another embodiment, the contour of these regions constrained by a given orientation is obtained by determining the set of points of maximal depth, and by generating in an iterative way, the list of points of the contour CRᵢ of the region from the deepest points. The depth is defined as the smallest number of edges between a point of the region to the nearest central point Pc, from which the region has been generated.

For instance, the deepest points (distance from the central point(s)) can be determined following the Dijkstra algorithm by assigning to each point its distance to a predefined origin point, following the number of edges traveled during the neighbouring search.

The stop condition for the search of contour points is then that every points of the contour must be linked by at least one edge, in order to guaranty that the resulting region is contiguous and therefore connected.

Orientation Criterion of the Region Points

It is also possible, during the growth of the region, to take only the points whose surface normal has an angle with the surface normal \vec{NRᵢ} of the region, inferior to an angle threshold. Nevertheless, this approach can generate regions with internal holes, in particular when the region Rᵢ have a three-dimensional accident of shape (pleated). These internal holes must therefore be detected, and the points that have been wrongly removed must be re-added.

Nevertheless, in the case of objects binding in cavities, for instance of small compounds binding molecular cavities, the selection of a region encompassing all the compound, or more precisely the selection of the envelop of the compound, can be better than its segmentation, in which case, it can be better to select one or the other approach, following the application and the information sought.

In this case, starting from a set of surface points of a three-dimensional object, and as a consequence from a set of nodes in the associated surface graph, it is possible to define N regions following one or more segmentation criteria in order to obtain full regions, ring-shaped regions, with a normal growth or under the constraints of one or more vectors, etc.

Nevertheless, the automatic generation of regions and structural fingerprints following these different criteria produces redundant regions, that is, regions sharing an important number of points.

Advantageously, the present invention provides a way to eliminate all or part of the redundant regions in order to reduce the number of regions to test, and therefore accelerate the use of the obtained regions following the invention, in particular for the generation of databases of regions, for the screening of three-dimensional objects, for the search of regions having specific remarkable properties, etc.

Following an advantageous embodiment, we define a subset M of the N generated regions which includes the non-redundant regions of N (that is, a set of regions R₁, . . . R_{N} where for any two regions (Rᵢ, Rⱼ), the percentage of common points is inferior to a threshold).

To do so, during a first step, a unique label is assigned to each point of the N set, for instance during the generation of the mesh following the known techniques such as marching cube (a computer graphics algorithm allowing to generate a polygonal object from a three-dimensional scalar field by approximation of an isosurface) or on the basis of the spatial location of point when it is unique (for instance by transposing the rounded coordinates of a point into a string).

A hash map (that is, a data structure allowing associating an element to a key) is then defined for each region Rᵢ, in which the elements are constituted by the points of the region Rᵢ, whereas the associated keys are defined on the basis of their respective and unique label.

After that, to determine if two regions Rᵢ and Rⱼ of N are redundant, the respective hash map of the two regions are compared in order to determine the percentage of common points. If this percentage is higher than a predefined threshold, for instance 85%, the regions Rᵢ and Rⱼ are considered redundant and one of them is removed.

Again, it is possible to implement the previously described approaches to define contiguous regions which also includes (or exclusively includes) the internal points of the three-dimensional object (if the object is full) by using for instance the mesh obtained from the Delaunay complex described by Fletcher et al in the U.S. Pat. No. 7,023,432. The definition of these internal regions allows comparing three-dimensional objects by their surface regions as well as their internal regions or their intermediate (i.e., intermediary) regions (which includes both internal and surface points).

### The Remarkable Properties

After a set of regions and/or structural fingerprints has been generated from the mesh or from the graph representing the three-dimensional object, we characterise the regions of the object following the state of some geometric and/or physicochemical properties that are of interest for the application and/or the domain of study.

Alternatively, this step is implemented directly on the object, before the generation of regions and/or structural fingerprints.

In what follows, geometric, physicochemical and evolutionary properties will be described. This description is nevertheless only given as an example and is non-limiting.

The Local Curvature

A first geometric property is the local curvature defined on each surface point of the object. This surface property is an important information both for the visualisation of the region (and of the three-dimensional object) but also for the automatic computer interpretation of surfaces. It allows describing for any surface point, the local tendency of the region, and indicating if the studied point belongs to a concave (cleft shape), flat or convex (knob shape) subregion.

Different approaches exist to define such a curvature. These common approaches are generally based on the use of a solid angle or on the local point density (being correlated to the local shape of the surface region) that can induce a bias when cavities exist (zone without points) under the surface. The approach to compute the curvature that we propose works on any three-dimensional object for which an envelope can be defined, whether the object is hollow or full.

In a two-dimensional space, for a set of points S₁, S₂, . . . Sₙ, both linked two by two by segments [S₁,S₂], [S₂,S₃], . . . [Sₙ₋₁,Sₙ], the surface tangent at each point as well as the surface normal of this tangent and passing through this point can be determined using conventional method. The normalized surface normal (of unitary norm) \vec{NS₁}, \vec{NS₂}, . . . , \vec{NSₙ} are then assigned to each point S₁, S₂, . . . Sₙ.

In a three-dimensional space, several methods allow to determine the surface normal on each point by using the facets adjacent or close to these points. In particular, the surface normal of a facet can be computed using the vectorial product of two vectors defined by two of its adjacent edges; this vectorial product being by definition perpendicular (i.e., normal) to the facet. These methods are applicable to any surface, and allow computing the local curvature on any point of a region or of the three-dimensional object. They are therefore not limited to regions obtained using this invention, neither are they limited by this invention.

Following another embodiment, we compute by conventional arrangements the surface normal on a point S₁ for which a local curvature has to be computed, by averaging all the surface normals of every facets (or points) adjacent or contiguous to S₁. Each surface normal thus averaged can then be weighted, in particular by the distance from S₁ to the centre of facets (or points) contiguous and/or by the area of contiguous facets.

Then if S₁^{T} is the transpose of point S₁ by its surface normal \vec{NS₁}, S₂^{T} is the transpose of S₂ by its surface normal \vec{NS₂}, and more generally Sᵢ^{T} is the transpose of Sᵢ by its normal \vec{NSᵢ}, the local curvature at point Sᵢ is then defined in two dimensions as the mean C(Sᵢ) of the ratio

$$\frac{⌊ {S}_{i - 1}^{T} {S}_{i}^{T} ⌋}{[ {S}_{i - 1} {S}_{i} ]} and \frac{[ {S}_{i}^{T} {S}_{i + 1}^{T} ]}{[ {S}_{i} {S}_{i + 1} ]} .$$

On the FIG. 2, we can see that

$$\frac{1}{2} ( \frac{[ {S}_{1}^{T} {S}_{2}^{T} ]}{[ {S}_{1} {S}_{2} ]} + \frac{[ {S}_{2}^{T} {S}_{3}^{T} ]}{[ {S}_{2} {S}_{3} ]} ) > 1$$

and as a consequence the point S₂ is a knob, whereas

$$\frac{1}{2} ( \frac{[ {S}_{4}^{T} {S}_{5}^{T} ]}{[ {S}_{4} {S}_{5} ]} + \frac{[ {S}_{5}^{T} {S}_{6}^{T} ]}{[ {S}_{5} {S}_{6} ]} ) < 1$$

and as a consequence, the point S₅ is in a cleft.

In general, starting from a surface point Sᵢ, it is possible to create a contiguous zone Zᵢ around this point by gathering the points Sⱼ closest to the points Si. To do so, we define a distance threshold for which the distance to the point Si is inferior or equal to this distance threshold. The definition of the distance threshold depends in particular of the required accuracy for the local curvature: the smaller the distance threshold is, the more the curvature will reflect local tendencies; the bigger the distance threshold is, the more the curvature will reflect global tendencies of the surface.

The local curvature C(Sᵢ) for a point Sᵢ is then equal to the mean of every ratio

$$\frac{d ( {S}_{i}^{T} {S}_{j}^{T} )}{d ( {S}_{i} {S}_{j} )} ,$$

where d(SᵢSⱼ) is preferably the geodesic distance between points Sᵢ and Sⱼ:

$$C ( {S}_{i} ) = \frac{1}{Card ( {S}_{1} , {S}_{2} , … , {S}_{n} )} {\sum }_{{S}_{j ⋐ {S}_{1} , {S}_{2} , … , {S}_{n}}} \frac{d ( {S}_{i}^{T} {S}_{j}^{T} )}{d ( {S}_{1} {S}_{j} )}$$

Alternatively, d(SᵢSⱼ) is the Euclidian distance between the points Sᵢ and Sⱼ.

When the ratio C(Sᵢ) is strictly superior to 1 (respectively, strictly inferior or strictly equal to 1), the point is on a knob (respectively on a cleft, on a flat).

Alternatively, in order to have a normalized curvature continuous on the interval [0, 1], the curvature C(Sᵢ) can also be computed using the following equation:

$$C ( {S}_{i} ) = \frac{1}{card ( {S}_{1} , {S}_{2} , … , {S}_{n} )} {\sum }_{{S}_{j} ⋐ {S}_{1} , {S}_{2} , … , {S}_{n}} \{ \begin{matrix}0.5 + \frac{( \vec{{NS}_{i}} , \vec{{NS}_{j}} )}{{K}_{c} π} si \frac{d ( {S}_{i}^{T} {S}_{j}^{T} )}{d ( {S}_{i} {S}_{j} )} > 0 \\ 0.5 - \frac{( \vec{{NS}_{i}} , \vec{{NS}_{j}} )}{{K}_{c} π} si \frac{d ( {S}_{i}^{T} {S}_{j}^{T} )}{d ( {S}_{i} {S}_{j} )} < 0\end{matrix}$$

Where (\vec{NSᵢ},\vec{NSⱼ}) is the angle in radian between the surface normal vectors \vec{NSᵢ} and \vec{NSⱼ}; and

K_{c} is a weighting factor allowing modulating the contrast between a flat curvature, a knob and a cleft.

When the angle deviations between \vec{NSᵢ} and \vec{NSⱼ} are within 0 and π/2, an adequate value for K_{c}, empirically determined, is 0.3.

If the curvature value C(Sᵢ) is not inside the interval [0, 1], we just need to overwrite it in order for the curvature value to be 1 when its actual value is superior to 1, and in order for the curvature value to be 0 when its actual value is inferior to 0.

Analytically, for a normalized curvature and continuous on the interval [0, 1], when the value of C(Sᵢ) is close to 0, 0.5 and 1, the point Sᵢ is respectively on a cleft, a flat or on a knob.

Following the needs and in order to better depict the local or global curvature tendency, it is possible to either vary the size of the zone Zᵢ (by varying the size of the distance threshold), or to weight the curvature of points Sⱼ of Zᵢ, in particular by the inverse of their geodesic distance to the central point Sⱼ, multiply by a constant L:

$$C ( Si ) = \frac{1}{{\sum }_{Sj ∈ R} Ld ( Si , Sj )} {\sum }_{Sj ∈ R} \{ \begin{matrix}\frac{0.5 + \frac{( \vec{NSl} , \vec{NSj} )}{K π}}{Ld ( Si , Sj )} si \frac{d ( {Si}^{T} , {Sj}^{T} )}{d ( Si , Sj )} > 0 \\ \frac{0.5 - \frac{( \vec{NSl} , \vec{NSj} )}{K π}}{Ld ( Si , Sj )} si \frac{d ( {Si}^{T} , {Sj}^{T} )}{d ( Si , Sj )} < 0\end{matrix}$$

Alternatively, and as well as for the determination of surface normal, rather than doing the arithmetic mean of the weighted mean by the inverse of distances, we weight the curvature computation by the area of adjacent facets.

Following another embodiment, we obtain curvature values C_{[-1,1,]}(Sᵢ) on the interval [−1, 1], the clefts, the flats and the knobs being then defined for values respectively close to −1, 0, by using the following equation:

C_{[-1,1]}(Sᵢ)=2C(Sᵢ)−1

These different alternatives of the general approach to compute the curvature that we have just detailed can be implemented for any type of three-dimensional object or three-dimensional region, as long as a mesh of the object or the region, transposed or not into a graph, has been generated. The computation approach of the local curvature is therefore not limited by the approach described in this invention. It has the advantages of being exact and fast to compute.

The Electrostatic Potential

A second property relates to the functional groups and to the electrostatic potential of the studied region. The electrostatic potential can in particular be obtained by one of the numerous existing approaches that solve the Poisson Boltzmann equation.

By functional group we understand any set of points with a partial or complete charge, or any set of points sharing a same potential with respect to the electrostatic interactions.

Typically, for a molecule, there are common functional groups such as ketone, carboxyl, etc., whereas for industrial three-dimensional objects, they are for instance AC power plug having positive and negative poles, conductive surfaces, insulating surfaces, etc.

The next table presents the functional groups in organic chemistry. The interest in differentiating them during the comparison of molecules relies in the fact that each group has distinct interaction potentials and reactivity:

| | |
|---|---|
| Alkane | Hydrocarbon chain |
| Aromatic | Containing cycles |
| Alcohol | R—CH2—OH; |
| (primary, secondary, tertiary) | R,R′—CH—OH; |
| | R,R′,R″—C—OH |
| Aldehyde | R—C(═O)H |
| Ketone | R—C(═O)—R′ |
| Carboxyl | R—C(═O)OH |
| Phenol | Phenyl-OH |
| Amine | R—NH2; |
| (primary, secondary, tertiary) | R—N(—H)—R′; |
| | R—N—R′R″ |
| Amide | R—C(═O)NH2; |
| (primary, secondary, tertiary) | R—C(═O)N(H)—C(═O)—R′; |
| | R—C(═O)N—[C(═O)R′][C(═O)—R″] |
| Thiol | R—SH |

To determine in an effective way the interactions between objects or of regions of objects, it can be necessary to take into account both the curvature and the electrostatic potential, shape complementarity not always being sufficient.

In fact, in the case of deformable objects, the importance of electrostatic interactions between two objects (and more precisely between their interacting regions) may be greater than the importance of curvature during comparison, and in order to predict their interaction. This phenomenon is in particular due to the possible changes of conformation of the objects and regions occurring during their interaction.

The Deformability

During the comparison of full three-dimensional objects, in order to quantify the amount of void under the surface of an object and to determine the malleability of the structure, it is possible to detect the existing cavities of the object. In fact, the malleability (or deformability) of an object results from several factors including the presence of cavities (or zones of low densities) and/or the flexibility index of the zone.

Typically, in the case of molecules, the presence of cavities allows to bind ligands. It is therefore worth studying a remarkable property, in the case of such three-dimensional object.

In order to quantify the deformability of an object, we compute the amount of void under the surface (cavities) for every point of the region.

An example of embodiment of this quantifying method of the void under the surface for each point P of the region consist in retrieving the set of points P_{cav} belonging to one or more cavities and close enough to the point P. Then it is possible to give an approximation of the void volume of cavities selected by the P_{cav} points, by considering for each cavity, that the void volume close to P is equivalent to the total volume of the cavity multiply by the percentage of P_{cav} points of this selected cavity. Thus for instance, if a cavity of 800 Å³ is present under the surface and in the vicinity of point P, and that 20% of the P_{cav} points of this cavity are selected, then the approximate amount of void at point P will be 160 Å³.

The void volume can in particular be approximated by computing the sum of volumes of the empty tetrahedrons that compose it in the Delaunay complex.

The Radius of a Region

Another remarkable property of a region Rᵢ is its radius T(Rᵢ). To generate the radius T(Rᵢ) of a region Rᵢ, we determine by a conventional approach the barycentre Cgᵢ of this region Rᵢ.

The Euclidian radius T(Rᵢ) of the region Rᵢ can then be computed using the following equation:

$$T ( {R}_{i} ) = \frac{1}{card ( {CR}_{i} )} {\sum }_{{Sc}_{i} ⋐ {CR}_{i}} ‖ {Cg}_{i} , {Sc}_{i} ‖$$

Where ∥Cgᵢ,Scᵢ∥ is the Euclidian distance between the barycentre Cgᵢ and the contour point Scᵢ.

Alternatively, we compute the mean Euclidian radius of the region by summing the mean and standard deviations (std) of the distances between every points Sᵢ of the region Rᵢ and Cgᵢ:

T(Rᵢ)= ∥̅C̅g̅ᵢ̅,̅S̅ᵢ̅∥̅+std[∥Cgᵢ,Sᵢ∥]

Following yet another embodiment, it is possible to compute the geodesic radius of the region by replacing ∥Cgᵢ,Sᵢ∥ by d(C_{gi}, Sᵢ) that returns the geodesic distance between the points Cgᵢ and Sᵢ. In the case of regions generated without shape constraint and following a spatial geodesic distance criterion, the geodesic radius of the region will be closer to the threshold distance used during the generation of the region.

In the case of regions built with constraints, it is nevertheless possible to define several sizes in the direction (respectively orientation) of the constraint vectors.

Following yet another embodiment, we perform a Principal Component Analysis (PCA) to determine the main axis of the region.

### Energy Score and Filters for the Comparisons

We will now describe the steps of comparison of three-dimensional objects and regions following the invention.

Energy Score

To evaluate the quality of the alignment between two regions R₁ and R₂ using the computed remarkable properties, the invention provide a way to compute, for each alignment of these regions, an energy score.

The energy score depends in great part of the nature of the object considered. Nevertheless, in the case of the comparison of surface regions of objects, a few properties such as the curvature, the resistance (or malleability), the density, the spatial location of surface points (as well as a distribution probability indicating the possible error on their location) and the surface normals of the points and facets are common properties for every three-dimensional objects, and can therefore be used systematically during the computation of the energy score and during the comparison of regions.

Given n properties Pᵢ defined for each point and/or facet of a region R₁, the local energy score score_{local}(Sᵢ,S₂) corresponding to the alignment of a point S₁ of the region R₁ with a point S₂ of the region R₂ is given by the following formula:

$${Score}_{local} ( {S}_{1 ,} {S}_{2} ) = {\sum }_{i = 1}^{n} {α}_{i} {Score}_{{P}_{i}} ( {S}_{1 ,} {S}_{2} )$$

Where αᵢ is a weighting factor of the score Score_{P}_{ᵢ} of the property Pᵢ for the two aligned points S₁ and S₂.

Preferably, each Score_{P}_{ᵢ} returns a normalized score on a same interval of value, so that when the coefficients αᵢ are equal to 1, the properties contribute equally to the global score.

Furthermore, to agree with usual conventions on energy scores and entropic scores, the energy score Score_{P}_{ᵢ}(S₁,S₂) for a given property Pᵢ preferably returns a normalized value on the interval [−1,1], in order for the energy score of that property to be close to −1 when the states of the considered property for the points S₁ and S₂ are similar, and close to 1 when they are different.

To take into account the intrinsic variability of a functional region of an object during its comparison, an embodiment consists in introducing a tolerance threshold T_{Pi}, generally empirical and specific to the property Pᵢ.

This tolerance threshold T_{Pi} defines the acceptable difference between the respective states of the property Pᵢ between two points S₁ and S₂ of the regions R₁ and R₂, respectively.

When the difference observed between states of a property for the points S₁ and S₂ is inferior to this tolerance threshold T_{Pi}, the variation of the property Pᵢ in these points is considered as “normal”, and the energy score Score_{P}_{ᵢ}(S₁,S₂) returns—in agreement with the conventions of this embodiment—a negative value.

On the contrary, when the difference observed is greater than the tolerance threshold T_{Pi}, the energy score score_{P}_{ᵢ}(S₁,S₂) returns a positive value, indicating that the variation of the property is “unusual” between these points.

An example of calculation of Score_{P}_{ᵢ} following this embodiment consists in computing first the effective difference Δ_{Pi}_{_{effectif}} of the states of the property Pᵢ in these two points S₁ and S₂ and then the normalized effective state Δ*_{Pi}_{_{effectif*}}. To do so, we compute the difference between the difference observed Δ_{observé} of states of this property for the points S₁ and S₂ with the predefined tolerance threshold T_{Pi} for this property as defined by the following equations:

Δ_{observé}=|Pᵢ(S₁)−Pᵢ(S₂)|

Δ_{Pieffectif}=Δ_{observé}T_{P}_{ᵢ}

Δ*_{Pieffectif}=(Δ_{observé}−T_{P}_{ᵢ})/T_{P}_{ᵢ}

Where Pᵢ(S₁) is the value of property Pᵢ state at the point S₁; and Pᵢ(S₂) is the value of property Pᵢ state at the point S₂.

The energy score Score_{P}_{ᵢ}(S₁,S₂) for the points S1 and S2 is then equal, for a given normalized property Pi, to the value returned by the logistic function L:

$${Score}_{{P}_{i}} ( {S}_{1 ,} {S}_{2} ) = L ( {Δ}_{Pi , effectif} )$$

$$With \text{:}$$

$$L ( {Δ}_{Pi , effectif} ) = \frac{2}{( 1 + {e}^{- {λΔ}_{Pi , effectif}} )} - 1$$

Where λ is a constant; and Δ*_{Pi,effectif} is the difference of the respective values of states of the points S₁ and S₂ for the property Pᵢ, normalized by the tolerance T_{Pi} specific to this property (FIG. 4b).

Then, when the difference between the states Pᵢ(S₁) and Pᵢ(S₂) of the property Pᵢ is greater than the tolerance T_{Pi}, Δ_{Pi,effectif} and Δ*_{Pi,effectif} are positives and L(Δ_{Pi,effectif}) and L(Δ*_{Pi,effectif}) return a positive value at most equal to 1, thus penalizing the wrong alignment of the points S₁ and S₂ for the property Pᵢ (FIG. 4a).

Inversely, when the difference between states Pᵢ(S₁) and Pᵢ(S₂) is below the tolerance T_{Pi} (indicating a normal variation of the state of the property), Δ is negative and L(Δ) returns a negative value at most equals to −1, thus rewarding the good alignment of the points S₁ and S₂ for the property Pᵢ.

Typically, an adequate value for the constant λ of the logistic function is 6.

The advantage of using such an energy score based both on the definition of tolerances and the use of a logistic function returning values on the interval [−1, 1], reside in the possibility to integrate a plurality of wanted remarkable properties P₁, P₂, . . . , Pₙ to the equation of the local score Score_{local}(Sᵢ,Sⱼ), while preserving a coherent and performance energy score, whenever the properties P₁, P₂, . . . , Pₙ are digitizable (i.e., can be digitized) and that it is possible to assign tolerances to the accepted differences.

Furthermore, if a point Sᵢ of the region R₁ does not have an equivalent Sⱼ in the region R₂ for the property Pᵢ, the energy score Score_{P}_{ᵢ} returns a predefined value following the research criteria.

For instance, if we are searching for a region of similar size, the energy score corresponding to the non-alignment of a point Sᵢ of the region R₁ is penalizing. The value of this energy score for this non-alignment can then be defined as the value corresponding to the highest energy score (or to a fraction of the highest energy score) of the energy scores computed for the studied remarkable properties P₁, P₂, . . . , Pₙ for the compared regions. This value is then equal to the worst score of alignment (or to a fraction of the worst score of alignment) defined by the energy score for these n properties. Optionally, we weight this predefined value of this energy score by a weighting factor in order to adjust the importance of this lack of matching scheme, in particular in the case where the non-aligned points have a specific interest for the ongoing research.

On the contrary, if we search for a region smaller than the region R₁ (that is, a sub-region of the studied region), the energy score corresponding to the lack of alignment (matching) of the point Sᵢ can be defined as a zero value and will then have no incidence on the global energy score Score_{global}(R₁,R₂). This requires to check the percentage of aligned points for regions R₁ and R₂, as well as the energy score, in order to determine if the alignment is of interest (if the sub-region is sufficiently big to be of interest).

The global energy score Score_{global}(R₁,R₂) corresponding to the alignment of two regions R₁ and R₂ for the set of studied remarkable properties P₁, P₂, . . . , Pₙ is then given by the sum of local energy scores Score_{local}(Sᵢ,Sⱼ) for pair of points Sᵢ and Sⱼ (aligned or not aligned):

$${Score}_{global} ( {R}_{1 ,} {R}_{2} ) = {\sum }_{{S}_{i} ⋐ {R}_{1}} {Score}_{local} ⌊ {S}_{i} , {Eq}_{{R}_{2}} ( {S}_{i} ) ⌋$$

Where Eq_{R}_{₂} (S₁) is the point Sⱼ of R₂ that is aligned with the point Sᵢ of Rᵢ (see FIG. 5a for the matching scheme of points of two regions).

If no point match in R₂, as it is the case for points S₁ and S₂ on the FIG. 5a, we then return the predefined value for the energy score corresponding to the non-alignment of points Sᵢ and Sⱼ.

Therefore, thanks to this global energy score informing on the similarities of the two regions of three-dimensional objects following the N properties defined by the field and/or the area of application, it is especially possible to create classifications of these regions. The classifications depend on chosen properties during comparison, which means that for a same set of regions, it is possible to obtain different classifications, each corresponding to the properties used for the comparison/screening (example: the set of convex regions, the set of conductive regions, etc.).

The classification of regions into groups is established following the pair wise comparisons of regions and following their respective energy scores. For each pair of regions, the assigned energy score inform on their similarity or dissimilarity following the remarkable properties chosen for the computation of the score.

It is then possible to build classifications on the basis of the global energy score by using common clustering supervised or non-supervised algorithms (k-mean, iterative k-mean, neighbour joining, kohonen, etc).

Furthermore, to simplify the classification and systematically highlight the most interesting results, it is also possible to normalize the global score of each alignment.

To do so, we determine the highest energy score that can be obtained during the screening of a region, which is achieved by computing the alignment score of the region with itself. By definition, the alignment of the region with itself returns the maximal score that can be achieved during any screening. Let us remember that the alignment score depends on the number of points of the region to be screened, as well as the number of properties used for this comparison, therefore there can be several distinct maximal scores for the comparison of any two regions R₁ and R₂.

It is then sufficient to normalize the score of any obtained alignment during the screening of a region with the maximal score obtained by the alignment of this region with itself.

It is then possible to create a classification scale of alignments following their quality. For instance, when the normalized score of an alignment is greater than 80 (over 100), the screening successfully retrieved very similar regions, most of them sharing a same function; for a score between 50 and 80 (over 100), some of the similar regions retrieved do not share a same function (more variability is accepted); for a score between 35 and 50 (over 100), we estimate that similar regions are retrieved but they do not necessarily share the same functions; below a normalized score of 25 or 30, the retrieved regions are mostly similar but probably do not share the same functions.

To summarize, we normalize the global score of comparison in order to rapidly distinguish the interesting alignments from those that are less interesting, and in order to be able to compare the alignments extracted from two distinct screenings. It is then also possible to create confidence categories to inform on their expected amount of errors.

### Example

The comparison of a region R with itself gives a global energy score of −500 following the computation of the score that we detailed above.

The comparison of the region R with regions L₁ and L₂ respectively give a global energy score of −230 and −390. The normalized energy scores of (R, L₁) and of (R, L₂) are then respectively 0.46 (46 over 100) and 0.78 (78 over 100).

Optionally, it is possible to analyse the optimal alignment of two regions R1 and R2 in order to determine if the alignment errors of the points of R1 with those of R2 are scattered on the whole region, or if these errors are locally concentrated in one or more sub-regions.

In fact, the sum of numerous small errors scattered on the whole alignment can be equivalent, in the computation of the global score following this embodiment, to the sum of a small number of important errors concentrated in a sub-region. It can then be of interest to distinguish these two cases, and in particular, to penalize the one having a huge concentration of local errors, often giving less good results in the field of screening than the one having small errors scattered on the whole region.

The error done for each pair of points (Sᵢ, Sⱼ) of two aligned regions R₁ and R₂ (as well as for any point Sₖ of R₁ not having any match in the region R₂) is given by the local score of the couple Score_{local}(S₁,S₂). In fact, considering that the local energy score of the couple (Sᵢ, Sⱼ) returns a value informing on similarities and/or dissimilarities between these points for the set of studied remarkable properties, it also provides a measure of the error done during the alignment or the non-alignment of the point S₁ of R₁ with the point S₂ of R₂.

In this case, starting from the two optimally aligned regions R₁ and R₂ following the method of the invention, it is possible to generate sub-regions of one of the regions R₁ or R₂, on the model of generation of structural fingerprints, by using the value of the local energy score on each point of the R₁ region.

We then define a graph having a set of nodes corresponding to one or more points of the region, and we assign to each graph node the value of the local score associated to the corresponding point(s) in the region. Alternatively, we define an acceptable maximal error, and we assign to a node the distance between the maximal error and the value of the local score corresponding to this (these) point(s).

Therefore, a score informing on the local error is assigned to each point, and to each edge linking two points is assigned the distance between these scores, so that we can grow an error region by these edges.

We then choose a growth parameter allowing defining the growth limits of the region. Then, when errors exist, it is possible to generate the sub-regions that gather the concentrated and wrongly aligned points (that is, the points having an important error and gathered into a sub-region of the region).

For instance, if we compare two regions R₁ and R₂ with a single property, the maximal accepted error that can be done on the alignment of a point of R₁, with a point of R₂ (or the non-alignment of a point of R₁) is then equal to the maximal local score of these points, which is 1, whereas the maximal similarity is equal to −1.

Then for two points A and B of R₁ matching with A′ and B′ in R₂, if the errors done on the alignment of A with A′ and B with B′ are respectively 1 and 0.8, we assigned to the edges linking A and B and A′ and B′ a weight equal to 0.2.

If all the other points of the regions R₁ and R₂ are correctly aligned (that is, their local scores of alignment are negative), then the weight of any edge linking one of these points to A (respectively B) will have a value at least greater than 1 (respectively 0.8). If we want to create an error region (points with values close to 1) and we choose a growth parameter for these error regions of 0.3, only one sub-region error on R₁ having the points A and B can be generated on R₁.

On the contrary, if the growth parameter is equal to 0.1, then only one error region having the point A will be defined.

In fact, the wanted value in this example is 1: the error done on point A is therefore zero, whereas the error done on B is 0.2. If we consider a growth value of 0.1, we then generate a single error region having the point A.

We then determine the number of error sub-regions generated, for which their cardinal is greater or equal to a predefined cardinal (that is, where the number of points forming the error region is greater than a predefined threshold).

It is then possible to determine if the errors of alignments of the points of R₁ with those of R₂ are scattered on the whole region, or if the errors are locally gathered in one or more sub-regions, in particular by determining the number of error sub-regions generated for which, their cardinal is greater or equal to a predefined cardinal, and by taking into account the number of points for each error sub-region.

The definition of these error sub-regions informs on the distribution of errors done by the optimal alignment of two regions. In particular, it allows to distinguish the case where errors are small but scattered on the whole region (many small error sub-regions), from the case where errors are huge but locally gathered (one or more error sub-regions).

It is then possible to take into account those errors in the global score corresponding to the optimal alignment of two regions, by changing the rank of an alignment if it contains too much localized errors, that is, by removing the region from the screening result, or by adding a penalty to the global score, following the size (number of wrongly aligned points) and/or number of error sub-regions.

An example of penalizing score to add to the global score is then:

$${Pénalité}_{erreur} = C \cdot {\sum }_{i = 1}^{N} card ( {ER}_{i} )$$

Where ERᵢ is an error sub-region;

card (ERᵢ) is the number of points of the error sub-region XX; and

C is a constant allowing giving more or less importance to this penalty, with respect to the global score of alignment.

Finally, when we generate several stable conformations of the three-dimensional object in order to obtain several secondary three-dimensional objects derived from the initial three-dimensional object, we have seen that the screening accuracy can be lowered if too many conformations are considered. To compensate this loss of accuracy, it is then possible, following an embodiment of the energy score, to screen a region as well as its most stable conformational derivatives by reducing the tolerance parameters T_{Pi}. In fact, these tolerance parameters are introduced to take into account the intrinsic variability of a region and of the different conformations that it can take. If this variability is generated in a first step, the tolerance to variations can then be reduced and the screening will be more accurate.

These different embodiments of the energy computation score can be implemented to assess the alignment of two regions or three-dimensional objects of any kind, regardless of the method of the invention, as long as a mesh and/or a graph of the said regions or objects is available.

To effectively compare in a fast and robust way several regions with themselves, the invention provides a first step to simplify the representations of regions by implementing one or more “filters” in order to reduce the complexity of the regions and/or the number of regions to compare with the studied region.

The use of all or part of these filters is of course optional, but they can quickly eliminate the regions that can not be similar to the region of interest as well as the regions that do not have some wanted remarkable properties.

Representation Simplification of the Three-Dimensional Object

The first filter essentially resides in the simplification of the representation of the object following at least one simplification method (that will be detailed in the following description).

In particular, the dual shape, or again the spherical harmonics can be implemented to simplify the representation of the surface of the object, and as a consequence of the associated graphs and regions. In the case where the surfaces are obtained following a marching cube approach or one of its derivatives, it is also possible to play on the grid size parameter or the intersection interpolation parameter to obtain simplified representations of the object.

Alternatively, the simplification of the object is achieved on the basis of a gathering of points of the object that have similar states of properties. In particular, as explained previously, it is possible to gather the set of points having a close curvature value and/or the set of points having close functional groups.

More generally, it is possible to generate in a systematic way, the set of structural fingerprints of the object to simplify the representation, and then its comparison.

Representation Simplification of the Three-Dimensional Region

The second filter essentially resides in the simplification of the representation of the region, following at least one simplification method.

A region can be described by a graph. The graph can be used such as a simplified representation by gathering the nodes having similar states of properties (node contractions). The graph of the region is then a graph describing the remarkable properties of the region (such as the presence of clefts, insulating zones, resistant zones, flexible zones, etc.). These graphs, which are far simpler (of an order of 10), allows performing more effective comparison.

Nevertheless, if the region has a set of sub-regions generated on the basis of remarkable properties, it is possible to generate a graph in which each sub-region is a node.

An example of embodiment of the simplified graph of a region is obtained by removing the set of edges of the graph region, which have local weight greater than a predefined threshold, and by searching for connected components in this region. The connected components having a given minimal number of points (in order to guaranty a sufficient size) then constitute sub-regions of the region that gather distinct remarkable properties.

This very simplified graph is well suited for the graph matching. It is nevertheless also possible represent this very simplified region in the space by averaging the coordinates of each node to compare efficiently the regions by a geometrical approach rather than by algorithms of the Graph Theory (such as graph matching).

These comparisons of simplified regions are less accurate than the detailed comparison of objects and regions, but are sufficient to remove the dissimilar regions as well as to gather and/or classify the similar regions.

Comparison Simplifications by Region Classification

During the comparison of regions, the computation of energy score allows for instance quantifying the differences and similarities between two regions to be compared, and as a consequence, classifying them by using conventional methods (k-mean, iterative k-mean, neighbour joining, kohonen, etc).

A third filter therefore consist in the creation of region classifications to gather prior to any comparison, sufficiently similar regions (following the energy score), and to limit the comparisons to the only regions contained in one of the group of the classification (for instance, the group having the characteristics closest to the region to be screened) and following the field and the area of application concerned. To do so, we compare the region to study with averaged regions representative to each of regions class generated during the classification. We then reduce the comparison to the class of regions that is the most similar, and optionally to a few additional classes in the order of their similarity.

Removal of Too Distinct Regions

In the same way, by using simplified representations, it is possible to remove before said comparison, the regions that cannot be similar, or more precisely those that do not have a minimal number of specific and important features of the region of interest.

Typically, if some points are more important than others in a region, we will first try to compare them.

Such important points can be manually defined, prior to the screening of a region, or automatically by providing criteria specifics to the domain or to the area of application.

Thus, in Biology and during the comparison of molecular regions, it is possible to give more importance to the local score Score_{local}(Sᵢ,Sⱼ), in the equation of the global score, if we know that the point Sᵢ belongs to an important functional sub-region of the region (in particular the hot spots of interactions, the catalytic residues, the phosphorylation/glycosylation sites, etc.).

In automatic, it is also possible to define the points belonging to the most conserved residues of a molecule, as being the most important points that must be aligned with the points of another region. If no match is found on these important points, we can then avoid performing other time-consuming comparison.

Other filters based on a simple description of regions can be used to remove too dissimilar regions.

For instance, if the region of study is concave and the region to be tested in a convex, it may be useless to continue the comparison in the sense that it is not possible to align the two regions on the basis of their curvature (an important remarkable property) considering that they have structurally opposed shapes.

More generally, this is to compare all or part of the important remarkable properties of regions to limit the number of regions to be compared in more details.

A fourth filter then resides in the fast removal of regions that cannot be similar in terms of known criteria and remarkable properties important for the application and/or the field of study.

Use of Invariant Properties

As illustrated in the example of the comparison of concave and convex regions, some properties, said invariants, characterise a region independently of any orientation or alignment. This is particularly the case of the size (Euclidian or geodesic) of a region, of its composition of different states of one or more properties (for instance the proportion of insulating points, of knobs, of atomic types, etc.), or of the distribution of these properties (as the gathering or the scattering of the insulating points, of all the points having an anionic charge, etc.).

For instance, the points at the centre of a region can generally be considered as invariant using rotation operators. It is then possible to determine properties that will not change with the orientation of the region (such as the curvature or the central charge, as well as the coordinates of the centre with respect to one of the axis in the graph) and to compare them rapidly to other regions.

Although simple, these properties inform on a geometric, physicochemical and/or evolutionary reality that can help distinguishing a region from a great set of other regions.

For a surface region, we can use, for instance, the ratio of its Euclidian radius E_{AB} and of its geodesic radius G_{AB}.

The Euclidian radius E_{AB} is the minimal distance between the centre of the region to a point of its contour (or to an averaged point of the contour).

The geodesic radius G_{AB} inform on the length of the path to be traveled “on the object” or “on the region” to link the centre to a point of the contour. In the case of surfaces, it is the path over the surface that must be taken to link the two points (see FIG. 3).

The geodesic radius thus inform of the folding and accident of shapes encountered during the travel to link the centre to a point of the contour (or to an averaged point of the contour).

As a consequence, the ratio R_{E/G} or R_{G/E} between the Euclidian radius E_{AB} and the geodesic radius G_{AB} (taking into account the folding) inform on the general shape of the region, and the comparison of the ratio of two regions inform on some possible similarities between these regions. Two ratios having too different values (for instance of 1 or 2 Angstrom for the comparison of molecular regions) indicate in most of cases, different shapes. The heavier comparison of these regions is therefore of no use.

Alternatively, we use the ratio R_{E/G} of the Euclidian distance E_{AB} and of the geodesic distance G_{AB} (see FIG. 3) linking one couple of points (A, B) of a region or of an object. We can then compare the distance ratios of a couple of points of the region to be compared with the couple of points matching the aligned region, rather than the ratios of Euclidian and geodesic radius.

The use of these ratios is a very powerful filter to efficiently remove too dissimilar regions.

For instance, in the molecular screening of a region on a database having more than three million regions, use of this filter (by accepting a variation of 10% of this ratio) allows selecting only 47 000 regions matching this criterion. The comparison between results of heavy screening (on the three million regions) and of filtered screening show that almost all the similar regions retrieved in the heavy screening are also retrieved in the filtered screening.

In the same way, for more than three million regions having an aromatic composition between 0 and 58%, only 10 700 regions have more than 30% aromatic groups. In pharmaceutics, cosmetics and food industry, these aromatics play a very important role during the conception of active compounds. In these fields, the use of a filter based on the presence of a remarkable property such as a region having more than 32% of aromatic groups is therefore particularly interesting.

This observation allows removing additional regions that cannot match the region of interest.

When searching for a region of equivalent size (and not a sub-region of the region of interest), it is generally possible to only consider the regions having a similar number of points. An acceptable variation is for instance 15 to 20%.

The fifth filter then represents the use of properties that do not depend on regions alignment (invariant by rotation and translation), to compare them with each over.

Projection in a Two-Dimensional Plan

Furthermore, some regions that do not have a too accidented shape, at a coordinate (x, z) of a plan correspond a point (x, y, z) of the region. As a consequence, it is possible to do a projection of the three-dimensional region following its surface normal \vec{NRᵢ} to obtain its description in a two-dimensional plan.

Such a description of a region, where each point is described by a two-dimensional plan with a value representing one or more states of the properties Pᵢ, allows creating an image. Such an image of the region can be transformed using the Fourier transforms (or the Fast Fourier Transforms, FFT), a largely used technique to compare images, due to its invariance with respect to translational operators.

We can compare two regions by comparing their images in the plan, that is, by comparing the Fourier transforms of their images in the plan.

A sixth filter then represents the transposition in two dimensions of a three-dimensional region using a given axis in order to compare it rapidly with other regions described by their Fourier transforms.

Transposition in a Graph

Two regions R₁ and R₂ can also be transposed into graphs G₁ and G₂ where their nodes and edges properties depend on the regions we wish to retrieve (by using only the local curvature of each region, or the curvature and the charge, etc.). Instead of geometrically comparing these two regions, it is then possible to compare their respective graphs G₁ and G₂ by different approaches of the Graph Theory and Graph Matching, such as the clique detection.

Starting from the graphs G₁ and G₂, it is especially possible to perform the contraction of nodes that are similar to simplify the representation of these regions, for instance by removing all the edges having weight greater than a predefined threshold, in order to reduce the differences between the nodes.

Then we have to merge all the nodes linked by an edge in a single node for which we average the states of the properties associated to each node that are linked to it. This average can optionally be weighted with the distance from a central node to the other nodes that are directly or indirectly linked to it.

Alternatively, the contraction of graphs is implemented by creating a contracted graph in which the region is divided in a set of sub-regions having one or more remarkable properties that are assigned to each node of the contracted graph.

Those contracted graphs are then simpler to compare than the graphs from which they are extracted.

A seventh filter thus resides in the use of graphs (contracted or not) of two regions to compare the great tendencies of these regions without performing their geometrical alignment.

Use of Spherical Harmonics

A last filter finally implements the spherical harmonics as well as the Zernike three-dimensional descriptors. These tools have the particularity to be invariant by translation and rotation, and are particularly suited to the less reliable but fast comparison of regions. The biggest limits of these comparisons rely in the description of star-like objects (star-like problem). This problem is particularly important in the case of full objects having internal cavities.

An eighth filter thus resides in the use of models such as spherical harmonics and the three-dimensional Zernike descriptors to perform fast comparison of regions.

Other filters are of course usable to enhance the effectiveness and robustness of the comparison of regions.

### Alignment of Regions

In a third time, the alignment of the regions to be compared is performed, in order to find the best possible matching of each of their points and/or facets (FIG. 5a). It is then possible to compare the regions thus aligned, and to determine the similar regions or the complementary regions of the screened region.

To do so, the invention provides in particular the use of five models: a universal model, a sectorisation of points and facts of regions with control discs, a discretisation of points and facets of with control discs, a sectorisation of points and facets of regions with a sphere of control points, and a discretisation of points and facets in a sphere of control points.

These models can be implemented separately or in combination, following the desired speed and effectiveness of the comparisons.

Universal Model

In the universal model, regions R₁ and R₂ having the respective barycentre Cg₁ and Cg₂ are translated to the origin O of the system coordinate (\vec{OX}, \vec{OY}, \vec{OZ}), by applying respectively vectors \vec{Cg₁O} and \vec{Cg₂O}.

At least one of the regions is then rotated simultaneously or successively around the axes (\vec{OX}, \vec{OY}, \vec{OZ}) of the system coordinate following the respective angles αₓ, α_{y} et α_{z}, so that αₓ, α_{y} et α_{z} take a set of values between 0 and respectively at most maxₓ, max_{y}, max_{z}, where maxₓ, max_{y}, max_{z} are predefined threshold values.

For each generated alignment of two regions R₁ and R₂, that is, for each rotation of one of the regions by an angle αₓ, α_{y} and/or α_{z} around the respective axes \vec{OX}, \vec{OY}, and/or \vec{OZ}, the corresponding energy score of this alignment is computed.

The optimal alignment of regions R₁ and R₂ then correspond to the alignment in which the energy score is the lowest (in agreement with the conventions chosen in this description).

To compute the energy score corresponding to an alignment of two regions, we define matching scheme between the points and/or facets of each of the two regions (FIG. 5a). This is one of the limiting steps for which the geometrical models are proposed hereafter.

Several methods to establish the matching of points of two different regions exist.

For instance, for a given alignment of R₁ and R₂, we search for a point Sᵢ of R₁, the closest point Sⱼ in R₂. By “closest” we mean that the spatial distance between points is the closest (by optionally taking into account the probability on the location distribution, that is, the error done on this distance), the spatial distance may be a geodesic or Euclidian distance, or considering all or part of the remarkable properties which define the object and the region in this point (the distance being the distance between the two points and for the N properties defining these points). Typically, we want to determine the respective couple of points of the regions R₁ and R₂ that minimize the distance.

For instance, the top of the FIG. 1d illustrates the computation of the geodesic distance between a point A and a point B, on the basis of their spatial coordinates (respectively (1, 1, 1) and (3, 1, 1)).

In the bottom of the FIG. 1d, we can see the computation of this distance that also takes into account the value of their respective curvatures (0.2 for A and 0.4 for B) as well as a weighting factor for these two properties (α and β).

The implementation of this universal model can be optimised in order to further reduce the number of operations to be realized during the search of the optimal alignment of the regions R₁ and R₂.

For instance, to accelerate the search of the closest point Sⱼ in R₂, it is possible to define a maximal distance threshold, so that for some points of a region, there may be no matching in the other region. We then assign a predefined energy score to those points that do not match, said score can be penalizing or not, depending on whether we search for sub-regions or similar size regions.

It is also possible to adjust parameters αₓ, α_{y}, α_{z}, maxₓ, max_{y} and max_{z}, following the type of regions to be compared (surface regions, intermediate or internal) and desired quality of alignment.

Indeed, the surface and intermediate regions have surface normals \vec{NR₁} and \vec{NR₂}. These surface normals are used as reference (by aligning the regions following their surface normals \vec{NR₁} and \vec{NR₂} with one of the axis of the system coordinate, for instance \vec{OY}) in order to locate the side of the region oriented towards the external environment. We thus reduce the number of degrees of freedom required by the search of the optimal alignment of two regions.

Thus, we translate to the origin the surface or intermediate regions R₁ and R₂ of respective barycentre Cg₁ and Cg₂, and we orientate them so that their respective surface normals \vec{NR₁} and \vec{NR₂} coincide with the axis \vec{OY}. It is then possible to perform a complete rotation around the axis \vec{OY}, to find the best alignment of the two regions, then to perform small rotations (adjustments) following the axis \vec{OX} and \vec{OZ}, by assigning small values to the maximum angles maxₓ and max_{z}. This type of comparison is fast and does not lower significantly the quality of comparison.

Alternatively, rather than aligning the regions R1 and R2 following their surface normals \vec{NR₁} and \vec{NR₂} with the axis \vec{OY}, it is possible to directly perform the complete rotation of at least one of the regions around the axis \vec{OY}, then to perform small rotations around the axis \vec{OX₂} and \vec{OZ₂}, where \vec{OX₂} is any vector perpendicular to the surface normal \vec{NR₂} of R₂, and where \vec{OZ₂} is the vectorial product \vec{OX₂} [symbol] \vec{NR₂}.

Furthermore, rather than doing

$$\frac{{max}_{x}}{{α}_{x}} \times \frac{{max}_{y}}{{α}_{y}} \times \frac{{max}_{z}}{{α}_{z}}$$

comparisons, it can be interesting to first search the best alignment following the axis \vec{OY}

$$( \frac{{max}_{y}}{{α}_{y}} ) ,$$

then following the axis

$$\vec{OZ} ( \frac{{max}_{z}}{{α}_{z}} ) ,$$

(respectively

$${\vec{OZ}}_{2} ( \frac{{max}_{z}}{{α}_{z}} ) )$$

then following the axis

$$\vec{OX} ( \frac{{max}_{x}}{{α}_{x}} )$$

(respectively

$${\vec{OX}}_{2} ( \frac{{max}_{x}}{{α}_{x}} ) ) ,$$

so that only

$$\frac{{max}_{x}}{{α}_{x}} + \frac{{max}_{y}}{{α}_{y}} + \frac{{max}_{z}}{{α}_{z}}$$

comparisons are done.

Optionally, we also adjust the alignment of regions by applying, simultaneously or successively, the small translations tₓ, t_{y} and t_{z} following the respective axis \vec{OX}, \vec{OY}, and \vec{OZ}, so that tₓ, t_{y} and t_{z} have values between 0 and at most dmaxₓ, dmax_{y}, and dmax_{z}, where dmaxₓ, dmax_{y}, and dmax_{z} are predefined threshold values.

We thus determine the optimal alignment of regions, said alignment being the one with the optimal global energy score, that is, the one corresponding to the best alignment of the two regions.

Finally, it is also possible to determine the principal components of the two regions R₁ and R₂ to limit the search space around these axes defined by the Principal Component Analysis (PCA).

Sectorisation of Points

The method of points sectorisation allows simplifying the search of matches between points and facets of an intermediate or surface region R₁ with those of a region R₂, in particular when the regions are defined by a high number of points and facets.

By “sectorisation”, we mean any method allowing defining the contiguous zones which divide the entire object or region.

To do so, we circumscribed each region in a set of circles divided in sectors, so that to each point and to each facet of the region correspond at least one sector. We can then perform the comparison of the two regions R₁ and R₂ (FIG. 5b).

To do so, in a first step, we align the regions R₁ and R₂, of respective barycenters Cg₁ and Cg₂, with the origin O of the system coordinate (\vec{OX}, \vec{OY}, \vec{OZ}), by applying to the points and/or facets of the regions the respective vectors \vec{Cg₁O} and \vec{Cg₂O}. If \vec{OY₁} and \vec{OY₂} are the surface normals of the respective regions R₁ and R₂, we then perform a rotation of the regions with an angle (\vec{OY₁},\vec{OY₂}) around the vector resulting from the vectorial product \vec{OY₁}̂\vec{OY₂}, so that the axes \vec{OY₁} and \vec{OY₂} of the regions coincides.

To summarize, we align the two regions R₁ and R₂ so that their axes \vec{OY₁} and \vec{OY₂} coincide.

In a second time, we create a plurality of circles around each region R₁ and R₂, centred on the aligned barycenters Cg₁ and Cg₂ of each region, and of respective radius

$$\frac{T ( {R}_{1} )}{k β} and \frac{T ( {R}_{2} )}{k β} ,$$

where β is the step distance between each circle, k is a non zero multiplicative number of β, T(R₁) is the radius of the region R₁ and T(R₂) if the radius of the region R₂.

Typically, for molecules, β=3 Å.

Then, starting from an arbitrary diameter of each obtained circle, we draw n diameters inside each circle in order to create the main sectors of these circles.

For a desired search angle called α, the number n of main sectors is

$$\frac{α}{360} .$$

This search angle is defined by the conditions of implementation of this invention. Typically, α has a value comprised between one and ten degrees, preferably five degrees. In fact, the smallest α is, the finest and the slowest will the comparison of regions be, whereas for higher α, the comparison will be less accurate but faster.

Thus, in the case of the screening of three-dimensional objects and of their regions, we can use a search angle from five to ten degrees if we want to first privilege the speed of the method, whereas in the case of more advanced comparison of two regions of objects, a search angle of one degree allow to obtain a better result but will take more time.

In a third time, the regions R₁ and R₂ are arbitrarily aligned following one of their main diameters. For each point of a sector SEC₁ of R₁, we search for the matching points in R₂ that are in the equivalent sector SEC₂. The said equivalent sector SEC₂ being the sector of R₂ that is superimposed with the sector SEC₁ of R₁ when the regions R₁ and R₂ are aligned following one of their main diameters (FIG. 5b).

Alternatively, we extend the search of the equivalent point to the immediate neighbours of the equivalent sector SEC₂ of R₂.

This regions sectorisation considerably reduces the search of matches by reducing the number of points to be tested at each iteration.

Discretization of Regions in a Disc or a Sphere of Control

In this approach, we discretise the points where control points define a control disc (FIG. 6a).

To do so, in a way similar to the sectorisation method, we define a set of circles centred on a point of the region, typically its barycentre. Then, starting from an arbitrary diameter of each obtained circle, we draw n diameters inside each circle. The control points of a region are defined by the intersection of the generated circles around the region and of the diameters defining the sectors of said circles.

The control disc of a given region then has a set of control points for this region.

The geometrical structure of a control disc can be used to discretise a region and ease its subsequent comparison with other regions.

To do so, we define a threshold distance Dₘₐₓ, and, for each control point PCᵢ, we determine the set of points of the region belonging to a sphere centred on the given PCᵢ and having as radius the distance threshold Dₘₐₓ: that is, the set of points of the region that have distances to the control point inferior or equal to Dₘₐₓ.

Typically, on the FIG. 6a, we have represented a control disc of radius 3β, whose centre is the control point PC₀.

For instance, we discretise the points P₁, P₂ and P₃ of the region of the object belonging to the sphere of radius Dₘₐₓ centred on the control point PC₄, by averaging the properties of the points P₁, P₂ and P₃, and by assigning them to the control point PC₄.

The bigger the radius Dₘₐₓ is, the more points of the region will be selected and averaged in each control point, which lead further to approximate the shape of the region.

When a sphere of radius Dₘₐₓ does not contain any point of the region, the associated control point does not have any match in the region and is removed from any computation during the subsequent step of comparison.

Advantageously, the radius Dₘₐₓ is of magnitude of the step distance β between each circle, thus guarantying certain accuracy in the discretization of the region.

This discretised form of the region can be advantageously used in the screening of regions by not comparing the points of the region anymore, but rather the control points of the control disc of the region (see FIG. 6b). This embodiment allows comparing the two regions R₁ and R₂ by using their control discs and without computing at each alignment (rotation, translation), the matching scheme of the points of R₁ with the points of R₂.

Following an alternative of the invention, additional control points are added on the most distanced parts from the centre of their control discs. In fact, the density of control points in the periphery of the disc is lower.

For instance, we define the peripheral sectors of control discs as being the space between two control discs and two diameters, that may be successive or not: in other terms, the sectors forming the contour of the control disc. An additional control point then can be defined at the diagonals intersection of such a peripheral sector.

According to an embodiment of the invention, a region can also be sectorized and/or discretised in a sphere of control points following methods close to the sectorisation and/or the discretisation of a region in a control disc. A sphere of control points correspond to N control discs that have been successively rotated by a step angle of 360/N around an axis of the system coordinate. The sphere of control points is well suited to the comparison of any type of region (surface, intermediate, internal).

The comparison of two regions R₁ and R₂ by the comparison of their spheres of control points is similar to the implementation of the comparison by control discs. The comparison by control spheres allows comparing two regions without searching for the matches at each alignment (rotation, translation) between the points and/or facets of these two regions, thus considerably increasing the search of the optimal alignment of the two regions.

To do so, we assign to each control point PC of a control sphere, the average of the set of remarkable properties of the region points that belong to a sphere centred on PC and with a radius equal to a maximal predefined distance Dₘₐₓ.

To obtain the optimal alignment of two control discs (respectively two spheres of control points), we turn one of the control discs (respectively one of the sphere of control points) of a step angle equal to α, and we compare at each rotation the respective control points of each of the two control discs using the energy score (FIG. 6b).

In fact, when the control discs (respectively the spheres of control points) are superimposed and aligned following one of their diameters, each control points of a first region is precisely aligned with a control point of the second region. It is then just required to perform the pair wise comparisons of the control points belonging respectively to the regions R₁ and R₂ with the energy score.

Advantageously, the sectorisation and the discretisation in a control sphere allows to compare two regions R1 and R2 by searching for the optimal alignment following the three axes \vec{OX}, \vec{OY} and \vec{OZ}, whereas the sectorisation and discretisation in a control disc only authorizes the rotation around a single axis, here the axis \vec{OY} (which correspond to the axis aligned with the surface normals of the regions in the case of surface or intermediate regions).

Furthermore, the implementation of a control sphere allows sectorizing and/or discretising all the regions (surface, intermediate or internal), whereas the use of control discs is limited to the comparison of surface and intermediate regions.

This approach is particularly effective for the comparison of internal regions where no information regarding the area exposed to the environment is available, and where it is therefore necessary to perform the rotations around the three axes \vec{OX}, \vec{OY} and \vec{OZ} of the system coordinate.

It is important to note that the matching between the points of the region and the control points of that regions are only computed once, during the discretisation of the points of the region in the control points. Then during the alignments, only the control points are compared two by two. The creation of control spheres for each region follows the same rules, and as a consequence, the matching of a control point of a region R₁ with the one of the other region R₂ is known ab initio for each new alignment.

To be more general, the approach to sectorize and discretise is nevertheless not limited to the implementation of discs and spheres, which are only illustrative examples. It is in fact possible to implement these methods using any geometrical structure having a centre of symmetry, in particular polygons (hexagons, octagons, etc) as well as their three-dimensional equivalents.

Recursive Screening

Optionally, it is possible to perform an iterative (or recursive) region screening to increase the search sensitivity of similar or complementary regions. This method consists in performing a first screening of the region of interest (or of its complementary), then to select only the best results by keeping for instance only the similar regions with a global normalized score greater than 0.8 or 0.6. Then, we screen each of these best results (similar regions with a score >0.6 or 0.8) in order to retrieve new similar regions. Although this method can be repeated n times, it is generally sufficient to repeat it only once or twice. All the results (similar or complementary regions) extracted from these recursive screening are then gathered and sorted following their normalized global energy score.

### Databases, Screening and Cartographies

We will now describe the step of screening according to the invention.

The possibility to compare a given region to a second region offers the possibility to compare this region to a plurality of other regions, to determine a set of similar or complementary regions following the application, and with predefined criteria such as the remarkable properties.

For instance, in the case of surface molecular regions screening, it is especially possible to create a database of regions having a plurality of known regions, typically more than three million regions for the known protein structures. If we generate regions of various shapes and sizes, the database can contain more than 90 million of these regions.

Therefore, although the reconstruction of the mesh of an object, of its surface, and the generation of remarkable properties, and of regions characterising the object are performed by fast and performing approaches, these steps are nevertheless the most limiting steps of three-dimensional objects screening by their regions.

The invention provides for generating these information in advance and for storing them, for instance on one or several databases, so that the access and reconstruction of a given region can be achieved instantly.

For instance, in the surgery field, the three-dimensional object can be an organ or a tissue of a patient to operate. We can then generate the set of regions of the tissue or organ of the patient, to (i) better visualize and sectorize the lesions and/or the regions to operate (in particular by using the structural fingerprints based on properties such as the curvature, or the colorimetric if the lesions/regions to operate are revealed by a stain/reagent; (ii) to determine for instance the power of a laser for surgery to be used considering resistance and malleability data of the region (of a tissue); (iii) more generally, to locate the region to be operated with respect to the remaining tissue or organ, in particular to evaluate the risks and/or collateral effects of such a surgery.

In robotics, in the case where the three-dimensional object is a robotic arm, the method of the invention allows in particular recognizing the object required to accomplish a task in the environment that includes a plurality of three-dimensional objects, determining the region of the object where it must be grasped or on the contrary, the regions to be avoided (electric choc, too fragile zone, etc.), or yet recognizing the functional regions of the object in order to use them on other objects.

To achieve these different tasks, the set of three-dimensional objects in the vicinity of the robot can be automatically modelled, as well as their regions. Then these regions can be stored in a database of the robot, including information on the available objects in the environment, as well as the means to grasp them (suited to the abilities of the robot), of the object and/or of its regions.

Each of these tasks can be achieved through the screening of the regions of objects following the invention. In particular, knowing for instance the shape of the robotic hand, and by determining its complementary, it is possible to directly determined the set of regions (and therefore objects) that can be grasped.

Finally, in the field of artificial intelligence, the method of the invention can be implemented to create a virtual environment corresponding to all or part of the real world, which allows to an artificial intelligence to automatically identify the recognizable specificities of each object (their structural fingerprints) as well as the possible interactions between the objects of the environment.

In fact, for an artificial intelligence to be functional, it is necessary 1) to model its environment (for instance by using two cameras to reconstruct by stereoscopy a three-dimensional view of the environment and of its objects); and 2) to automatically assign functions to the objects and their regions (in particular by predicting the interactions between objects, on those that can, and those that cannot, and those can must not interact). The segmentation of three-dimensional objects into regions allows increasing the knowledge on the object itself and on its interactions with other objects of the physical world. This approach can thus benefit the artificial intelligence to better model its environment and better characterise it automatically, by simplifying its interactions with the physical world. The detection of objects and their three-dimensional modelling by artificial intelligence can be achieved thanks to stereoscopic cameras allowing detecting and detailing the volumes of objects. Starting from the observation of the object, the artificial intelligence thus have access to a mesh and can itself generate the regions and structural fingerprints to analyse the possible interactions of this new object with an already known environment.

In artificial intelligence logic and machine learning, when the artificial intelligence use an object with one of these regions, the induced response (electric choc, visual or sound stimuli, etc.) can in return automatically feed and annotate the database of regions, so that this induced answer will be assigned to the region as a function/a behaviour for this type of region. By homology, every region sharing characteristics close to the tested region will induce, for the artificial intelligence, a same answer.

Generation of Databases

An example of generation of a database corresponding to a set of given three-dimensional objects is described hereafter.

In a first step, we identify each three-dimensional object by a unique label. To characterise it, we then integrate the set of relevant information concerning the object into a database. Typically, those information can be size, curvature, colorimetry, if the lesions/regions to be operated are highlighted by a stain/reagent, or also by data on the resistance and malleability.

We then generate the mesh of each three-dimensional object according to the invention, and we compute a set of remarkable properties of the points of the mesh or graph of that object.

Spatial location, curvature, resistance or malleability of a three-dimensional object can be computed for any type of object.

Other properties such as the charge or the electrostatic potential can only be computed for some three-dimensional objects (such as AC power plugs, molecules, integrated circuits, etc.).

In the case of industrial objects, we can in particular compute resistance of the object for each of its points. For a robotic arm, it is also possible to compute the colorimetric states of several objects, to define the biggest regions corresponding to a colour code, said code may have been annotated to detail for instance its use or to draw the attention on some particularities.

Starting from the mesh (or the graph), we systematically generate a set of regions following several parameters (in particular following the distance criterion and/or on the basis of one or more sets of remarkable properties in order to obtain also the structural fingerprints of the object).

Each region and/or structural fingerprint generated on each three-dimensional object is then inserted into a database by detailing for each point and/or facet of each region, the properties that have been computed. Especially, the database includes information on the object extracted from the region and the neighbouring regions.

This database provides a list of regions corresponding to a virtual environment specific to the domain and to the considered area of application.

For instance, in robotics, this list can be the set of regions of objects present in a room and reachable by a mechanic arm.

In biology, the database may include the set of molecular regions that exists in a given cell, a given organ, a given tissue or a given organism.

In surgery, the database may include the set of regions of a tissue or organ to be operated, etc.

The specificity of each region defined by the set of remarkable properties of its points, of its surface or further of its possible internal cavities, allows evaluating the chance of interactions with regions of other objects. It is then possible to determine regions specific to an object in order to increase the knowledge on that object and for instance to better target it in a complex environment.

Following an embodiment, indices on those regions are created following their belonging to an object and/or to the states of their respective properties. These indices then allow a quick access to regions corresponding to the states of the studied remarkable properties. In particular, the use of filters may improve and accelerate this search (for instance by using the filter based on the invariant properties, the comparison of the frequent tendencies of regions, etc.).

Following the needs and the desired number of regions, it is also possible to create several databases having distinct functions.

Typically, it is possible to create a database:
by type of generated region. For instance, a database containing the regions formed without shape constraints, a database containing the regions formed with shape constraints, etc.;
by size of region (geodesic radius, Euclidian radius, etc.);
by shape of region (constraint vectors);
following the global charge of regions;
by centred level and/or in ring zones (peripheral) of the region:
   the centred level for the surface and intermediate regions is
   the coordinates of the central points (or sufficiently near the centre) following the axis defined by their normal surface (always oriented towards the external environment for this type of regions).
by functions (following one or more remarkable properties); etc.

Typically, this database is created after the clustering of the set of regions of an environment, and each sub-database (table) is a class of regions. Furthermore, it is also possible to define an averaged region representative of a set of regions belonging to a sub-database.

This concept allows describing each three-dimensional object following a given screening.

Thus, in the field of molecular screening, it is possible to create a database containing only the regions corresponding to known binding sites (approximately 300 000 regions) rather than creating a database of all the definable regions (from 3 000 000 to 90 000 000 regions following the desired variety of sizes and shapes).

Cartography of the Object or of the Region

Furthermore, for any three-dimensional object, the invention allows creation of a detailed cartography (i.e., mapping) of the object by using the knowledge generated during the screening of these regions. In particular, this cartography may inform on the specific regions (determined as the number of regions similar to the region of interest retrieved during its screening) and non-specific regions (when too much regions similar to the region of interest are retrieved during the screening) of the object compared to a given environment or compared to itself.

In particular, the frequencies observed during the screening of each region of the object can be mapped onto the three-dimensional object by using a simple and understandable colour code. The different interacting sites with other objects, as well as the labels referring to those objects are also stored and displayed by the cartography.

It is also possible to map (to cartography) on the three-dimensional object any remarkable property that have been computed for that object, or for its functional regions, either on the basis of external data contained for instance in a database, or on the basis of structural fingerprints characterising the special regions of the object, either on the basis of screenings.

In the case of screening, a region is said to be functional if it is possible to detect complementary regions of that region, this complementary of two regions then indicates possible interactions between the mapped object and another object segmented and stored into a database following the invention. The functions of a region may also be inferred from the similarity to another region for which a function is known.

Furthermore, in the case of molecules, it is possible to create, for each molecule studied following the approach of the invention, a molecular map (cartography) that details the different binding sites of the molecules and, when possible, their overlapping.

Following an embodiment, this cartography allows to identify the regions specific to each type of binding site (homodimer, heterodimer, protein-peptide, protein-DNA (DeoxyriboNudeic Add), protein-RNA (RiboNudeic Add), protein-ligand, protein-lipid, protein-water, etc.), the set of information relevant for the determination of the specific and non-specific regions of a molecule (with respect to a list of regions corresponding for instance to the molecular regions of a cell, an organ, a tissue, etc.), regions that are known to be binding sites of some specific biological interfaces, or yet the set of properties of molecule to identify in particular change of conformations, hydration or charge in different interacting context (for instance when the structure of the molecule is in a free form, that is, without partners, or when the structure of the molecule is a bound form, that is, with a partner).

In the field of industrial objects screening, it is possible to create a first database of tools reachable by a robotic arm, and a second database of the objects on which the robotic arm must work, by taking into account the abilities of the robot to grasp and manipulate the objects: the regions that can be grasped (and that are indicated on the cartography) depend of the shape of the robotic hand.

In the field of surgery, it is possible to create the cartography of an organ to be operated: by using the description of the regions of the organ, the region to be operated can be targeted and coloured to highlight it.

Alternatively, the region is annotated to provide information on the resistance (and/or on the resistance of its adjacent sub-regions), on the different fragile regions of an organ risking the life of a patient, etc.

Another example of cartography is to consider a tool (screwdriver, spanner, etc.) and to define the functional regions of those objects. For instance, in the simple case of a screwdriver, we can define a region that correspond to the handle and allows grasping the tool, and a region corresponding to the metal rod and the cross that allows inserting the tool in the complementary slot of the screw.

Other examples are still possible (the concept of cartography is vastly related to the concept of blueprint of an object): the “car” object has a region corresponding to the “door” and a sub-region “lock”, complementary to a region “key”.

The choice of information used in the cartography depends on the object selected for that cartography, and on the field of study, on its application, on the desired level of details, etc., or also on the regions and structural fingerprints obtained following the segmentation and the use of the distinct filters applied.

For a same three-dimensional object, we can therefore create a set of distinct map and choose those that are the most suited to a desired application.

Use of the Databases in the Comparison of Regions

The comparison of three-dimensional objects regions rather than the comparison of whole objects open the gates to new applications and new classifications of objects. In particular, it becomes possible to gather the object following the regions having a requested set of remarkable properties.

For instance, we can gather inside a specific database, the set of molecules having a region with a specific shape, having a specific charge and being not malleable; or also all the objects of a factory having a region that can be grasped and a resistance greater than a threshold, a specific shape and being insulating.

A good division of databases relative to the problems to be solved may increase the speed of the screening by a factor of 10 to 100.

According to the invention, it is especially possible to create several databases (or several tables in a given database) each containing the set of regions that may be generated from a collection of objects, but with different criteria.

For instance, for a given collection of three-dimensional objects in the industrial field:
a first database (or table) contains all three-dimensional objects regions of generated from a spatial geodesic distance criterion and without shape constraints;
a second database (or table) contains all the regions generated from a spatial geodesic distance criterion with shape constraints defined by the direction of two vectors V₁ and V₂,
a third database (or table) contains all the structural fingerprints generated from the remarkable properties: curvature and charge; and
a fourth database (or table) contains the structural fingerprints generated from the remarkable properties: resistance and conductivity.

When we search for a functional region similar to a known functional region of a given three-dimensional object in a collection of regions, we generate for instance the set of regions of that object following all the previously described methods. Then, starting from the obtained regions, we select the region automatically generated (and using one or more given criteria) that best overlaps with the functional region that we want to screen, that is, the region that have the highest number of points shared with the functional region to be screened. This selected region allows informing especially on the general shape of the functional region, and more particularly on the generation criteria that can be preferred to increase the search of similar regions.

For instance, if the selected region was obtained following a distance criterion of 10 centimeters, with the constraint vector (−2, 1, 0), we will preferably screen the functional region on the database(s) containing the regions obtained following all or part of these criteria (size 10 centimeters, constraint vector (−2, 1, 0)) rather than on all possible regions, or on all the databases containing all the regions of all objects and generated following any of the previously described approaches.

We will notice that the screening of regions does not necessarily require to be implemented on a single processor (CPU). In particular, given n processors linked by a network on a grid, and N regions to be compared, it is possible to create a file with these N regions, optionally with priority indices. Then and until the file of regions is empty, the regions to be compared will be equally distributed among all the n CPU of the grid.

In this alternative, we submit advantageously a sufficient number of regions to be compared in each transaction, so that the communication time is not too great with respect to the time required for the comparison of regions.

Furthermore, the reconstruction of regions from each node of the grid is preferably achieved by using one or two databases that centralise the data and let them accessible to each node.

Determination of Complementary Regions

The characterising approach according to the invention allows comparing the three-dimensional objects with themselves, and in particular to compare the regions of three-dimensional objects with themselves in order to determine the complementary regions.

A region R₁ is said to be complementary to a region R₂ when, in the matching scheme, for the points Sᵢ of R₁ and Sⱼ of R₂, we observe that:

P(Sᵢ)=|P(Sⱼ)−1|

If P is a property normalized on [0, 1] with a neutral value of 0.5 and

P(Sᵢ)=−P(Sⱼ)

If P is a property normalized on [−1, 1] with a neutral value of 0.

In the simple case of the description of a region by the curvature normalized on [0, 1], that is, where P is the local curvature, if a point Sᵢ of R₁ has a value of curvature equal to 0.8 (knob), the corresponding point S₂ in the complementary region R₂ has a value of curvature close to 0.2 (cleft).

In the case where the property P is a charge, a point Sᵢ of the region R₁ having a cationic charge will have as complementary point S₂ on the region R₂, a point with an anionic charge. Similarly, if the property is the conductivity, a point Sᵢ of the region R₁ that is insulating will have as complementary in the region R₂, a conductive point.

This definition can of course be extended to n properties Pᵢ if they are digitizable (i.e., if they can be digitized) and we know their neutral value in order to inverse them.

This means that starting from any region R₁ defined by a set of points Sᵢ, it is possible to define a complementary region R₂ defined by a set of points Sᵢ that are the exact complementary of Sᵢ with respect to the properties Pᵢ: there is a bijection between the Sᵢ and Sⱼ and the equations allows going both way.

It is also possible to generate several complementary regions starting from one region. To do so, we generate the complementary region in every point (which is unique by definition) of that region, then, starting from that complementary region, we randomly introduce some variability in the properties of these points in order to generate one or more regions similar to this unique region, which will be more or less complementary to the initial region depending on the introduced variability.

It is also possible to introduce variability on the location property of points. For instance, for any point S having a spatial location in (S·x, S·y, S·z), we can define a new spatial location S′ with these coordinates:

S′=(S·X+random_position( ); S·y+random_position( ); S·z+random_position( ))

Where random_position( ) returns a random value, for instance between −1 and 1.

In this aspect, we generate a plurality of complementary regions by introducing at each point small variations of their properties (generally smaller than 10% of the maximal value of the property).

Alternatively, we generate several conformations starting from the unique complementary, generated by normal modes, by molecular dynamic or mechanic, or we generate several conformations of the initial regions then we generate the set of their unique complementary regions.

All comparison methods that we have presented in relation with the screening of three-dimensional objects can therefore be applied to the comparison and the generation of complementary regions.

In fact, starting from a region R₁, rather than searching all the regions that are similar, it is possible to determine a region R₂, complementary of R₁, and to search all the regions similar to the region R₂, those will de facto be complementary of the region R₁.

If it is possible to create regions that are the exact complementary of other regions, it is also possible to create a region R₂ that entirely covers a region R₁. This type of complementary region correspond in fact to the surface that could be obtained if the region R₁ was an isolated object and might be computed as the surface of R₁. The properties of this surface covering R₁ is then inversed as indicated previously.

FIG. 8 is an example illustrating the objects that may be obtained following the method of the invention.

On this figure are represented an object 10 as well as an object 20 interacting with the object 10.

If the object 10 is a molecule, it may be for example a therapeutic target having a functional region R₁, whereas the compound 20, which have been identified according to the method of the invention, or by the existing knowledge, contains a region R₂, complementary to the region R₁.

On one hand, we then can search the databases (arrow 1) for the regions similar to the region R₁, to determine the set of objects 11, 12 having the similar regions R_{1′}, R_{1″} (in particular to determine the new therapeutic targets if R₁ is a binding site of the compound), and on the other hand (arrow 2 on the figure) the objects 21, 22 having the regions R_{2′}, R_{2″} similar to the region R₂, and therefore complementary to the region R₁. The objects 21 and 22 can therefore interact with the object 10 at the R₁ region.

We will now present a specific application of the characterising method following the invention.

In what follows, we describe more specifically the screening of molecules and macromolecules.

We also provide a method allowing the determination of binding sites and molecular partners of a target, as well as to determine the specific regions of molecular targets, to evaluate and modulate the potential toxicity or efficacy of a compound; and to generate a molecular cartography.

The in silico comparison of molecules and macromolecules is particularly important to different fields of fundamental research (for instance in biology, chemistry, etc.), and industrial research (in the pharmaceutical, cosmetic, toxicology and food industry, etc.). It allows establishing classifications of molecules, which is, combined to homology inferences, allows predicting and partially describing the role and the behaviour of these molecules. In particular, it is essential to identify the binding sites of a target molecule, and to detail the different partners that bind to it.

The function and the reactivity of a molecule in an environmental context (whether it is a cell, a tissue, an organism or a solution, in free air) depend both on the three-dimensional global structure of the molecule, but also on one or several local and active three-dimensional regions of said molecule. These local regions are used in particular as functional anchor points for other molecules. The global structure is nevertheless also important due to the sterical constraints it can create, that can thus limit the set of interactions between local regions.

To date, the geometrical, physicochemical and evolutionary comparison (in silico) of molecules and biological macromolecules (protein, DNA, stands for DeoxyriboNucleic Acid, RNA stands for RiboNucleic Add, lipids, etc.) is achieved in most cases by the comparison of sequences, structures and global properties of molecules. Some approaches recently described nevertheless attempt to take into account the presence of some key patterns (such as catalytic triads), but they do not preserve the notion of contiguity (important to compare the undividable and functional blocs, and to generate complementary regions), and do not allow to compare the regions of various sizes and shapes.

The present invention is also intended for the development of technical procedures derived from the detailed description of molecules and macromolecules in regions and structural fingerprints, as well as their screenings. The additional knowledge acquired by the systematic description of molecules and macromolecules in regions and structural fingerprints allows in particular answering to the following non limiting applications for any given environmental context: 1) the search for molecules having a specific or close functional region (accepting variations of remarkable properties of the region); 2) the search for molecular partners (whatever the type of molecule, the only pre-requisite being to have a structure); 3) the search for molecular targets of endogen or exogen compounds (notion of “druggability”); 5) the search for compound scaffolds able to bind a given molecular region; 7) the search for specificity of a molecular region (frequency of these regions in a given context/environment) and of anchor points specific to a molecule or a molecular target; 8) the creation of interaction profiles for a given molecular region or for a set of given molecular regions (interaction chip); 9) the generation of molecular interaction graphs from a molecular screening and from interaction profiles; 10) the evaluation, the classification and the modulation of a toxic potential of a molecule by the analysis of the perturbation of biological interfaces induced by the molecule; 11) the evaluation and the classification of a toxic potential of a molecule using the interaction profile of the molecule (toxicity chip); 12) the evaluation and the modulation of side-effects of a compound from the comparative analysis of the compound targets and of known biological interfaces; 13) the evaluation and the modulation of the compound efficacy from the number of targets, optionally weighted by the expression data of genes (allowing the weight of the frequency of a region by the frequency of the target carrying the region); 14) the creation of a molecular cartography allowing to gather and summarize the different knowledge produced by the characterisation method from a single and unique molecular structure; 15) the lead rescue of toxic or ineffective compounds following the interaction and specificity profiles of the compound and of its targets.

Molecular Types

A first step according to the method of the invention consists in systematically distinguish from molecular data files, the different types of molecules available.

We distinguish in particular the macromolecules (protein, DNA, RNA, lipids) from the molecules (sugars, nucleotides, water, ions, and other ligands).

Each type of molecule has in fact specific roles and reactivities. For instance, the current knowledge allows determining that DNA is implied among other things to the conservation and replication of the genetic information whereas the RNA, less stable and more reactive, plays a more transitory role that allows it either to act directly in the organism, or to serve as a copy of a portion of the DNA to be translated in proteins.

The proteins are versatile and often mix architectural roles (the necessity to have molecules of a certain size and shape to build macrostructures such as the super-complex TFIIH, but also to increase the specificity of molecular interactions by introducing sterical constraints), to catalytic roles (catalytic enzymes) and the regulations and/or signalisations (interaction with other partners).

It is then common to speak of macromolecules when we considered proteins, DNA or RNA, due to their generally important size. On the contrary, the molecules, that are generally smaller, more often play a role of solvent (for the molecular diffusion), and of regulation of macromolecules, able to induce the regulation of more complex systems such as the metabolic and signalling pathways.

The PDB database (Protein Data Bank) stores numerous molecular structures as flat files (i.e. text files). It is possible to retrieve these files and to analyse them in order to determine all the existing molecules and their molecular types. This determination of the molecular type is achieved through writing conventions summarized in the IUPAC nomenclature (stands for International Union of Pure and Applied Chemistry) and described in the PDB.

The proteins or polypeptides can in particular be separated according to their size: we use the term of protein when the polypeptide is constituted by at least sixty to eighty amino acids, of peptides when it is constituted by twenty to sixty amino acids, and of small peptides otherwise. This distinction allows taking into account the structural and physicochemical reality: the proteins of a certain size are generally more stable and the significant changes of conformation occur generally more rarely than for peptides and small peptides.

By convention, any molecule that has not been identified as a protein (respectively peptide or small peptide), a DNA, an RNA, a lipid, an ion or a water molecule following these conventions, is usually called “ligand” or “compound”. We can differentiate the endogen compounds/ligands (coming from the expression of the organism) from the exogen compounds/ligands (coming from an environment external to the organism).

Other more detailed molecular classifications are possible, in particular to precise the presence of aromatic cycles and other functional groups listed by the organic and inorganic chemistry.

Each structure file obtained in the previous step of the approach is then converted in a hierarchical data structure (following the concept of oriented object programming), so that we can have separate access to any of the present molecular types, then, for each molecular type, to each chain of that molecular type, and for each chain of that molecular type, to each residue and atom composing it.

In the following, the term “residue” refers indifferently to the amino acid residues of proteins (respectively peptide, small peptide) or to the nucleic acids of DNA, RNA.

In the same way, due to the generic aspect of the method with respect to the type of molecule, the term “molecule” can indifferently refer to molecules and macromolecules. The term macromolecules will however remain specific and will concern only proteins, DNA, RNA, lipids and other macromolecules.

Systematic Identification and Characterisation of the Structurally Known Molecular Interactions

Once the different molecules in presence are identified and stored in hierarchical data structure, it is necessary to establish in a systematic way from the molecular structures, the interactions highlighted during biological experiments. In fact, it is frequent that the file of a structure, for instance extracted from the PDB, contains several interacting molecules and macromolecules.

To do so, we analyse the interatomic intermolecular distances, that is, the distances between the atoms belonging to a molecule and those belonging to another molecule. We then can check if two atoms are in contact by comparing the distance separating them to their Van der Waals or Coulomb radius. It is possible to add or to multiply by a constant K, the sum of these radii, in order to take into account both the inaccuracies on the atom locations, but also the small atomic vibrations in these points (also correlated to the b-factors of atoms).

In particular, when we evaluate if two atoms A and B belonging to two different molecules are in contact, we can distinguish two cases: either at least one of the two atoms are non polar, then we will systematically use the Van der Waals radius to model the physical volume of these atoms; or the two atoms are polar, then we preferably consider the Coulomb radius to model their physical volumes to evaluate their interactions.

Following another embodiment to determine if two residues (or groups of atoms) interact, it is possible to determine the surface atoms of each of these two residues and to identify their respective barycenters. We then can measure if the surface atoms of residues, optionally discretised by their respective barycenters, are indeed in contact, by using an empirical threshold (generally close to 4.5 Å).

It is also possible to determine the interacting atoms and residues by computing separately the accessibility to the environment of two groups of atoms A and B (unbound form), and to compare these accessibilities to the accessibility computed on the fusion of these two groups of atoms (bound form). If the accessibility of an atom of group A or group B changes between its computation in unbound form and bound form, it is at the interface of the groups A and B, that is, this atom is an interacting atom.

Alternatively, an approach based on the Voronoï tessellation allows defining the interacting atoms and residues without prior definition of the surface and without imposing arbitrary distance and accessibility criteria. This approach can also limit and filter the interacting scheme of two molecules (scheme that summarizes that an atom Aᵢ of the first molecule interacts with an atom Bᵢ of the second molecule, and so on).

The intermolecular interactions thus detected are then classified in different categories following the molecules involved. We will differentiate in particular the homodimers (assembly of two identical molecules) from the heterodimers (assembly of two different molecules) that have some distinct interacting properties.

For a better systematic characterisation of interactions, we can advantageously differentiate the assemblies X-protein, X-peptide, X-DNA, X-RNA, X-lipid, X-ion, X-solvant, X-ligand (where X correspond to one of the type of molecules enumerated above), as the properties of some assembly types significantly differ from other types of assembly.

The structural data extracted from the crystallographic data nevertheless contain artefacts of interaction, known under the term “crystal packing”.

These interactions induced by the crystal packing do not reflect true biological interactions, it is necessary to systematically differentiate them. Numerous methods achieved this result by using mostly size, composition and complementarity (geometrical and physico-chemical) criteria of the interface.

For instance, there are a few number of crystal packing interfaces that have a buried area greater than 1000 Å², or that have a high hydrophobic and aromatic composition, or that are highly complementary: the interacting regions forming these crystalline interfaces are less complementary than the interacting regions forming biological interfaces.

In the following, we will differentiate the term “binding sites” from the term “interface” (or “biological interface”). The binding site corresponds to the set of atoms and residues of a molecule participating to an interaction, whereas the interface corresponds to the set of binding sites that interact with themselves.

Representation of Molecules

The molecular representation usually implemented is the Connolly representation, obtained from the surface computation of a three-dimensional object by the usual marching cube and marching tetraedra approaches. This representation provides molecule envelop, by approximating the surface that could be traveled by a probe, having the shape of a molecular water in the way of a ball moving on the object. The derived surfaces of the Connolly representation allows to take into account in particular the complementarity of biological interfaces binding sites.

Nevertheless it is possible to model different surface types by varying not only the size of the probe, but also by varying its phycochemical properties, including its charge.

In fact, the smaller the size of the probe is, the bigger the accuracy of the surface representation will be.

When the surface modelling of a target molecule (i.e. of a molecule of interest) depends also on the polarity of the probe, we then take into account the Coulomb radius if the probe is polar and in contact with an atom of the molecule which is also polar, or the Van Der Waals radius if the probe or the atom of the molecule is non polar.

It is also possible to change the resolution (also called the size) of the grid that allows computing the molecular representation (that is for instance to model the facets of its surface), as well as using or not the interpolations to define the points of this surface.

The availability of different representations of a same molecule at various resolutions allows to simplify its modelling, and consequently, to accelerate the subsequent comparisons.

These representations are nevertheless complex and other representations such as the Voronoï tessellation, the Delaunay complex, the dual shape and the alpha shape allows simplifying considerably the modelling of molecular structures and their subsequent analysis. As previously observed, the Voronoï tessellation and the Delaunay complex provide a description of the object inside and not only of its surface as in the case for instance of alpha shape and of Connolly surface. This structured representation of the internal parts of the object is important both for the definition and description of regions, but also for the comparison of internal and intermediate regions (having both internal points, but also surface points). For each point of the molecular structure representation, it is possible to assign one or more atoms of the molecule, and one or more residues of the molecule.

All molecular representations provide a mesh, which is a structure that locates the points and provides edges linking these points. Those edges can reflect the possible interatomic interactions of the molecule, as if it is for instance the case with the alpha complex and the alpha shapes. This mesh can also be transposed into various graphs taking into account different remarkable properties of the molecule, such as its curvature, its charges, its rigid and malleable zones, etc. In return and as previously observed, these graphs allow simplifying the representation of the molecule, and generating the regions and structural fingerprints. These regions and structural fingerprints allow both to systematically deepen the knowledge on that molecule, but also to screen the molecules on the basis of their regions. These comparisons on the basis of regions rather than on the whole object are finer and provide the mean to achieve the applications previously introduced. In particular, the comparison of molecular regions leads to functionally describe a macromolecule by specifying its binding sites and associated partners (detected either by a similarity of functional regions, or by the screening of complementary regions). It also allows evaluating the frequency of a region in a given environment/context and identifying the biological targets of a compound. The analysis of the frequency of a region and of the biological targets of compounds allows in return to inform on the possible toxic effects (if the compound interferes with biological interfaces), on the possible lack of efficacy (if the compound bind too great a number of targets), side-effects (if the compound interferes with a too great number of targets or biological interfaces) and to explain some of their molecular causes. The knowledge of these molecular causes, responsible of side or toxic effects, and/or of the lack of efficacy of a compound allows in return proposing slight modifications of the compound to modulate its side or toxic effects, as well as to modulate its efficacy for a given environment.

Segmentation of Molecules into Regions and Structural Fingerprints

The points provided by the molecular representation can be divided into two categories: the surface points (being part of the molecular envelop, that is the points directly in contact with the external environment and/or sufficiently close to interact with the external environment), and the internal points (not being part of the molecular envelop and/or being too distance of the external environment).

From this classification of points, it is also possible to differentiate three types of regions: the surface regions, having only surface points, the internal regions, having only internal points, and the intermediate regions, having both surface points and internal points.

The generation and storing of the regions and structural fingerprints can be implemented in particular following the method for characterising previously described.

In particular, we determine four databases (or tables) corresponding to the generation of regions of respective sizes 4 Å, 8 Å, 12 Å and 16 Å.

The databases corresponding to regions of small sizes (4 Å, 8 Å) are preferably used to characterise local phenomena of surfaces, such as the binding of ligands or of small peptides, or also the phosphorylation and glycosylation sites.

The database corresponding to regions of greater size (12 Å, 16 Å) more generally allows highlighting the macromolecular interactions (such as protein-protein, protein-DNA, protein-RNA, etc.).

Alternatively, a database is built by gathering all the binding sites detected in a systematic way by the structural analysis. To do so, the binding sites are identified and differentiated using the descriptions previously detailed. The binding sites can be integrated directly in a database by detailing its atomic coordinates and the remarkable properties of their atoms. Following another embodiment, the atoms and their properties are not integrated, but rather the points and the properties of these points extracted from the molecular representation (i.e. from the mesh) and corresponding to these atoms are integrated. Alternatively, it is also possible to integrate the facets (that is, three points directly linked by edges) rather than atoms or points. This database is suited for the annotation of a molecular structure from the functional regions already identified.

Following yet another embodiment, we generate all the regions of the molecule and we search those that best overlap with a binding site studied in this molecule. By overlapping, we here mean the percentage of points (or atoms) present in the binding site of study that are also part of the generated region. Therefore, rather than storing the binding site, we will store the region(s) Rₘₐₓ best overlapping the binding site.

This region is “labelled” so that we can retrieve the criteria used for its generation (size of the region, shape constraints, etc.).

In this embodiment, these are not the binding sites that are directly integrated inside the database, but rather the regions Rₘₐₓ that best overlap the known binding sites. The interest of such a method are twofold: 1) we ensure that we will be searching for regions that can be retrieved (as they have been generated systematically); 2) the labelling of the regions Rₘₐₓ allows to inform on the global shape of the region (i.e. of the binding sites: for instance, if the region is extended in a direction). It will then be possible to take into account these data during the screening of a molecule, in order to first (or uniquely) compare the stored molecular regions stored that correspond to these shape criteria.

It is also possible to generate not only a single region per binding site, but a set of regions, that correspond to the N regions best overlapping the binding site, or to the N regions corresponding to the stable conformations of this binding site. In particular, in the case of cavities binding ligands, it is possible to define a binding site that generally resembles a pocket (closed or opened) and that covers a great part of the cavity, but it is also possible to define N smaller regions that correspond to the different sides of that pocket.

Alternatively, we create a database with the structural fingerprints detected on the molecules and macromolecules. In particular, we can consider the structural fingerprints based on the curvature alone, or on the curvature and hydrophobicity, or again on the curvature and polarity, in particular: the structural fingerprints corresponding to the cleft regions that are hydrophobic; the structural fingerprints corresponding to knob regions that are cationic; the structural fingerprints corresponding to knob regions that are anionic, etc. The combination of structural fingerprints belonging to a same molecular structure often represents a unique code specific to a family of molecules, or to a sub-family of molecules. Other structural fingerprints can however be unique and specific of the molecule that contains it.

Following another embodiment, we generate the databases having only the molecules existing in a cellular/tissular type, in an organism, or even, in a cellular compartment (organelle such as the mitochondria). A screening on such a specific database will then answer more precisely to the needs of Research and Industrial World, and also allows performing comparisons of the interacting abilities of molecule in different context/environment. In particular, this can help to identify the novel therapeutic functions of known compounds: a compound in fact does not induce similar cellular responses in two different tissues. The news of the last years and researches performed by the pharmaceutical laboratories also show that several drugs known to have a therapeutic effect in a tissue can have other effects in other tissues.

Screening of Regions and Structural Fingerprints

Once databases of molecular regions are generated, it is possible to screen a given region or structural fingerprint on these databases. As the screening in fact corresponds to the pair wise comparisons of regions (or structural fingerprints), it is possible to do this computation on a network having a plurality of processors (CPU). Each CPU then corresponds to a node in the network.

Following an embodiment, one or several central nodes serve as databases (allowing for the reconstruction of molecular regions), and N slave nodes individually interrogating one at least of the databases to reconstruct the stored regions and to compare them to the query region. The N slave nodes then return (when the comparison provide a result interesting following the energy score) the results of that comparison to a database node intended to store these results.

Each screening is assigned a unique id that is shared by all the slave nodes, so that all the results sent by these nodes are labelled by this unique id. Starting from a unique query, this query is then evenly distributed among all the computational nodes, but it is possible to retrieve all the results on the intended database by using this unique id.

The comparison approaches of regions and structural fingerprints as well as the filters allowing accelerating the comparisons can be implemented.

In particular, the use of sphere controls is particularly suited to a fast comparison of any type of region (surface, internal or intermediate). The use of control discs is particularly suited to a fast comparison of surface regions and intermediate regions.

The filter corresponding to the ratio of geodesic and Euclidian radius allows selecting a subset of regions of similar size and having “folds” similar to those of the query region.

The simplification of regions from the regrouping of equivalent states of properties, and the use of graph matching algorithms are also particularly efficient filters.

Before comparing each couple of regions, it is also possible to compare the compositions of the properties states of these regions, as well as the distribution of these compositions. Too different compositions thus indicating that the regions cannot be similar and that it is unnecessary to proceed to heavier comparisons (ex: 25% of hydrophobic residues for a region, and 60% for another region).

Normalized Energy Score and Confidence Category

As seen for the general three-dimensional objects, the comparison of two regions is done by the pair wise comparison of points of these two regions. The similarities and dissimilarities between properties states of these points allow informing on the global similarity/dissimilarity of the two regions. The global score coming from the comparison of the two regions nevertheless depends on the number of points constituting these regions: the more points there are, the greater the maximal values (respectively minimal) of the global score are; inversely, the smaller the number of points is, the lower the maximal values (respectively the lowest) of the global score are.

We preferably normalized the global score of comparison in order to rapidly differentiate the relevant alignments from the less relevant ones. To do so, as every screening of region requires to define a region to be screened, it is then especially possible to compare this region with itself (respectively, with its complementary if we do a screening of the complementary of that region). This comparison of the region with itself then provides the maximal global energy score that can be achieved: in fact, following the definition of the energy score, no other region could better resemble it and therefore have a better score.

Therefore, the global score taken from each comparison of regions is normalized by this maximal value, so that the normalized energy score has values between 0 and 1 (or 0 to 100 to ease its reading). The more the normalized score is close to 0, the more the regions will be different; the more the normalized energy score will be close to 1 (respectively 100), the more the two compared regions will be close.

Starting from a normalized energy score, it then becomes possible to form confidence categories that inform on the amount of errors expected for each category. It will be then possible for instance to define 4 categories: A, B, C and D; the category A corresponding to the regions having a normalized score between 0.75 and 1 (respectively 75 and 100), B to the regions having a normalized score between 0.5 and 0.75 (respectively 50 and 75), C of 0.25 to 0.5 and D of 0 to 0.25. Most of time, the category A will only contains regions functionally identical to the screened region. The category B will contain regions with functions identical to the region A but will also contain regions with close but not necessary identical functions. The category C could contain more functionally close regions but not identical, whether the category D will contain regions more distant to the screened region.

### EXAMPLE

The comparison of a region R with itself gives a global energy score of −500 following the computation of the score we have detailed above.

The comparison of the region R with the regions L1 and L2 respectively give a global energy score of −230 and −390. The normalized energy scores of (R, L1) and of (R, L2) are then respectively 0.46 (or 46) and 0.78 (or 78).

The regions L1 and L2 are then classified into the categories C and A respectively.

Search of Molecules Having a Specific or Close Functional Region

When a region of interest A is identified by biological/chemical experiments or by existing annotations, it is possible to screen this region A to search for all the molecules having similar regions B, and with no a priori of resemblance of the global shapes (secondary and tertiary structures) of these molecules.

By homology inference and on the basis of the energy score (normalized or not) provided by the alignment of two regions A and B, it is possible for instance to infer the functional aspect of the region A on the aligned region B. Inversely, starting from a region A with an unknown function, if we find among the similar regions Bi, a region having an already characterised function (ex: bind a molecular partner), it will be possible to infer by homology this function on A.

It then becomes possible to discover a set of molecules capable of performing a same mutual molecular function (such as to bind a given molecular partner, to catalyse a given chemical reaction, being phosphorylatable—i.e., able to be phosphorylated—, etc.).

It is also possible to identify functionally close regions, which are the regions that could share a mutual function if some specific residues are mutated.

Then, remembering that the local energy score corresponds to the alignment of each couple of points formed by a point of a region with a point of another region and inform on the similarity/difference between these two aligned points, we can automatically determine the points (that is, the atoms and residues) and set of points of these two regions that best match and those that worst match, that is respectively the shared sub-regions (identical) of the two regions and the specific sub-regions (i.e. those that differ from one to the other).

### Example 1

We search to differentiate the sub molecular families and to build a phylogenetic tree on the basis of functional sites.

The nuclear receptor family is a vast family of protein transcription factors that allow regulating the expression of genes. These proteins are in particular involved in the regulation of cell cycle as well as in some cancers and leukaemia. This family can be divided especially into two sub-families, one allowing forming heterodimers (assembly of two distinct nuclear receptors), the other allowing forming homodimers (assembly of two identical nuclear receptors). For each of these two sub-families, it is possible to determine with the structures, the dimerization sites, and to screen them on a database of molecular regions.

This screening allows for instance to distinguish among all the structures of nuclear receptors, those that are capable of forming homodimers, from those that preferentially form heterodimers. Moreover, the geometrical and physicochemical differences between the binding sites of each nuclear receptor can be quantified, so that we can build an evolutionary tree of the binding sites, gathering the binding sites that are functionally the closest.

For example, forming such a tree consists in comparing all the alignments of couple of dimerization sites, which provide an energy score for each couple symbolizing a distance (geometric and physico-chemical) between these sites. With an approach such as UPGMA (stands for Unweighted Pair Group Method with Mean Arithmetic) or Neighbour Joining, which allows building phylogenetic trees, it is possible to build an evolutionary tree of these dimerization sites from the set of inter-couple distances described by these energy scores.

### Example 2

We want to retrieve a set of structures having a functional site in a given conformation.

Some functional sites are known to change their conformations under different environment factors (either change of ionic concentrations or after an interaction with a biological partner). This is especially the case of calmodulin, a protein involved in the regulation of calcium signal that is known for its conformational changes depending on the number of calcium atoms that it binds and following its partners. It is thus possible to screen the functional sites of the calmodulin in one of these environmental contexts, thus searching for a specific conformation of the functional site. We will see further in the text that it is also possible to search molecular partners specific to one of these conformations.

A more general example is the one of kinase proteins, for which man possesses more than 500 genes (about 2% of known human genes) and which the functional site exists in an active conformation and in an inactive conformation. It is possible to search among all the structures of protein kinases (determined experimentally or modelled for instance by homology modelling approaches), those that are in one or the other conformation.

### Example 3

We want to determine a new molecular partner by inferring this interaction by the mean of a region already known to bind a partner.

It is possible to screen a region R and to retrieve N similar regions; it is frequent that at least one of these N regions have at least one molecular and/or cellular known function. Then, this function can be inferred on the region R. In particular, if a region Ni of the set N of regions similar to R is known to bind a region Y, then it is possible to infer that the region R can also bind the region Y, that is, a molecule having a region R is capable of binding a given molecule having a region Y.

### Example 4

We want to retrieve molecules able to bind ligands.

ATP (Adenosine TriPhosphate) is a natural ligand used in the organism as energy source. We particularly find the ATP during numerous enzymatic catalysis. Molecular structures containing a molecule binding ATP inform us on the different binding sites of ATP.

It is then possible to screen at least one of these binding sites to determine the molecules capable of binding the ATP, and thus indicating a possible enzymatic role for the said molecule.

### Example 5

We want to determine the behaviour and the accuracy of the screening of regions for compounds of small and big size.

For instance, two independent screenings have been done respectively on the FAD and on the mannose (see FIGS. 9 and 10 respectively), the mannose smaller than the FAC then indicating the accuracy of the screening for small compounds; the FAD, bigger, indicating the accuracy of screening for bigger compounds. In both cases, the binding sites that have been screened are always found among the very first results. In the case of the PDB, which is a very redundant database (that is sometime gathering several times a same molecular structure with little variations), all the close structures binding these ligands were correctly retrieved. We also retrieve in most of cases, the different structures which were known to bind these ligands (if we screen every known binding sites for a ligand, we increase the sensitivity of the screening and necessarily ensure to retrieve all the structures known to bind these ligands).

To evaluate the accuracy of the screening, an inferior limit of the specificity is determined by counting the number of structures among the first results that are indeed known to bind respectively the mannose or the FAD. In fact, it is an inferior limit of the specificity due to the fact that if a structure does not highlight a binding to FAD (respectively to the mannose), it does not necessarily indicate that the molecule cannot bind the FAD (respectively the mannose). In order not to bias favourably the results of these screenings due to the presence of redundant structures, only the non redundant structural chains (as defined in the PDB) were retained.

On the FIGS. 9 and 10, the specificity 1 represent the number of regions binding FAD (respectively the mannose) with respect to the number of structures, whereas the specificity 2 represent the number of regions binding FAD (respectively the mannose) with respect to the number of structures with a ligand.

The results indicate that both compounds (respectively representative of the screening of small and big ligands) have a minimal specificity of about 80% for the ten first results, and of about 60% for the twenty first results.

Following another embodiment, it is also possible to annotate the structure of a molecule newly determined by dividing it into regions then by searching if those regions are found on other structures and if those similar regions have a known molecular function or behaviour (it is in particular possible to here use the database of functional regions previously described to accelerate the search). The functions and behaviours of those similar regions can then be reported to the regions of the said newly determined molecule.

Therefore, the automatic analysis of the new molecular structure generates new knowledge allowing better understanding the function(s) of said molecule by screening all of its regions. This annotation approach, also called molecular cartography is more detailed in the following description.

Non-limiting examples of functional regions that can be screened or retrieved by screening are: the binding sites (whatever their types: protein-protein, protein-peptide, protein-DNA, protein-RNA, protein-ligands, etc) as well as the phosphorylation sites, the glycosylation sites, the allosteric sites, etc.

Search of Molecular Partners

We have previously seen that the screening of a region may (by inference on the function of similar regions) allow the detection of new partners, and that it is also possible to determine the complementary of that region.

Therefore, if we wish to determine the molecular partners of a target, it is possible not to screen the regions of this target, but rather to screen the complementary regions of the regions of that target. In fact, the complementary regions are geometrically and physico-chemically determined to optimise the interaction with the initial region. As a consequence, every molecule retrieved having these complementary regions, are capable of binding the target at the initial region.

The screening approaches described in these processes (methods) are fast enough to allow the systematic screening of a macromolecule, whatever its type, on all the known molecular structures.

We can for instance screen a macromolecule in less than a day with a high degree of accuracy. By applying some filters, in particular the use of simplified representations (ex: dual shape), and/or the use of Euclidian and geodesic ratios, as well as the use of spheres of control points, it is possible to reduce this screening time for all the regions of a macromolecule to less than one hour (following the size of the said macromolecule and the number of CPU on the computational grid). All of this screening process is traceable and reproducible and is directly confronted to the experimental data provided by fields of the structural biology, such as crystallography, NMR, or cryo-microscopy, etc.

Another advantage of this in silico screening resides in the fact that the binding sites of these predicted molecular assemblies are directly identified (data that cannot be obtained by in vivo/in vitro high-throughput approaches such as two hybrid or TAP-TAG). Besides the knowledge gained with the systematic identification of these binding sites, this data also provide a way to perform simple mutagenesis experiments to verify if the mutation of a region of a predicted binding site, indeed induces a destabilisation of the molecular assembly (itself predicted and previously verified for instance by microcalorimetry, co-immunoprecipitation, anisotropy, etc.).

### Example 1

We want to determine a molecular partner of a given molecule by using complementary regions.

Let A be a protein, and R any region of that protein. It is possible to determine a unique region CR, strictly complementary to the region R. This complementary region corresponds to the region R for which the properties have been inversed with respect to a neutral state (a cleft zone is transformed into a know whereas a flat zone (neutral) remains flat; a cationic zone is transformed into an anionic zone whereas an hydrophobic zone (neutral) remains hydrophobic, etc.).

The screening of the region CR allows retrieving a set E of molecules having this region CR. Let us remember that the region CR is defined by making it the most complementary (geometrically and physico-chemically) to the region R. As a consequence, the molecules of the set E having the region CR are susceptible to interact with the region R of the protein A.

An alternative to this embodiment consists in starting from the same region R of a protein A, it is also possible to generate several complementary regions CR, each close to the unique complementary region CR. These CR regions then correspond to a plurality of regions CR on which can be applied separately and randomly some slight variations of their properties states for each of their points. These CR regions can of course also correspond to the most stable conformations generated from the region CR, or to the set of unique “complementaries” (i.e., complementary regions) generated from the stable conformations of R. The logic behind this forme of implementation resides in the fact that if the binding sites of a biological interface are indeed globally complementary, this complementary rule is nevertheless not strict and can even be inexact in some sub-zones of the interface. As a consequence, by generating several complementary regions by introducing local and slight variations on the states of properties (ex: an electrostatic charge of 0.7 normalized on the interval [−1, 1] could vary for instance of more or less 0.3), it is possible to take into account these variations prior to any comparison.

The energy score used during the comparison of two regions also have tolerance parameters on the accepted differences of properties. By playing either on the plurality of regions CR, or on the tolerances of that energy score, it is therefore possible to take into account the intrinsic variability observed in the complementarity of biological interfaces.

To determine the inverse states of properties (complementary) of a given property, it is also possible to use intermolecular contact matrices (symmetric) that inform on the frequency and likelihood (statistic) of contacts between each state. Those contact matrices are generally computed from the determination of intermolecular inter-residue contacts observed in biological interfaces. It is nevertheless possible to compute the contact matrices between any state of a given property (ex: a 3×3 matrix having 3 states: cleft, flat, knob, indicating the likelihood of contacts (cleft, cleft), (cleft, flat), (cleft, knob), etc.).

Those contact matrices between states of properties can then be used to generate a plurality of complementary regions by using at each point, the observed likelihood of possible contacts. If the contacts (cleft, knob and cleft, flat) are both plausible, it will be possible to generate two complementary at this point: one being a knob, the other a flat. To limit the number of complementary generated from a region, we will then use a likelihood threshold in order to select only a few inverse states for the given state.

### Example 2

We want to determine a molecular partner specific to a conformation of the target.

We have previously seen that the protein kinases exist in two conformations (active and inactive). As structures of these two conformations exist, it is possible to screen the complementary of these regions, and consequently to search molecular partners specific to one or the other conformation. More particularly, whatever the molecule (or macromolecule) considered, when the structures of its different conformations are experimentally determined or modelled by bioinformatics approaches, it is possible to determine specific partners to each of the molecule conformations, either by screening the complementary of the region specific to that conformation, or by inferring a partner from the comparison of identical regions. The in silico screening of regions is therefore particularly powerful to better understand the dynamical regulation of interacting networking following the activation or deactivation of one or several molecules. It however requires that a structure be determined experimentally or modelled. It can also be an excellent asset in the study of the effects of observed mutations in some genetic diseases and in the subsequent deregulations of the cellular interacting networks.

### Example 3

### Searching for the Impact of a Mutation on the Molecular Interaction Networks

More than two thousand mutations leading to genetic diseases are detailed and stored. This is in particular the case of molecular dystrophies (degenerative disease of the muscles).

Whereas some mutations are buried inside the molecular structure and alter the stability of the molecule, other surface mutations are susceptible to locally change the properties of a binding site.

The screening of the binding site (and not of its complementary) under its “common” form and under its mutated/pathogenic form allows us to detect the set (with respect to a database of molecular regions) of molecular partners specific to the “common” form and specific to the mutated/pathogenic form. By comparing these two interacting profiles, one can obtained new knowledge on the possible interferences of the molecular interaction networks induced by this genetic mutation. The identification of these interactions that cannot be done anymore due to the mutation, as well as the identification of the additional interactions induced by the mutation, is a key step for understanding of the function and of the progression of every genetic disease. In particular, if we observe the removal of an interaction, it is then possible to conceive new compounds to re-establish this interaction (and by doing so, the corresponding signalling or regulation pathway). Approaches allowing conceiving such compounds will be later discussed.

Obtaining the Structure of the Assembly from the Screening of Complementary Regions and Collision Tests

After the determination of the set of molecules having a region CR complementary to the region R of a target, that is, a set of molecules susceptible to interact with the region R of the target, it is possible to add additional tests to check if the interaction of the global shapes of the structures having these regions do not induce distant collisions.

By distant collision, we mean here collisions taking place at some distance of the studied regions, and that can prevent their interaction.

In particular, it is possible to determine the structure of the assembly of a molecule A with a molecule B from the alignment of a region CR complementary to the region R of the molecule A with a similar region CR′ of the molecule B.

Indeed, the process (method) that generates the complementary CR of the region R does not change the alignment or the spatial coordinates of the region R; only the states of properties of the region CR are changed (including the surface normal \vec{NCR}′ of the region CR′, which becomes the inverse of the surface normal \vec{NCR} of the region CR).

It follows that R and CR are structurally aligned (but oriented in opposite sens), and as CR′ is aligned with CR during the screening, then CR′ is also aligned with CR. In a first step, it is then required to apply to the molecule B, the same operators (rotation, translation) than those that were applied to its region CR′ to be aligned with the region CR of the molecule A.

In a second step, to obtain the structure of the molecular assembly of the molecules A and B, and to take into account the existing space (in particular due to the radius of atoms) between the two molecules A and B that interact, one can give the region CR′ (and the molecule B having that region) a movement of translation of a given distance following the inverse of its surface normal \vec{NCR}′ (or to give the region R a movement of translation of a given distance following the inverse of its surface normal \vec{NR}).

This distance can be fixed (approximately 6-8 Å) for the molecular assemblies.

To obtain a finer structure of the assembly, it is nevertheless possible to perform an optimisation step by iteratively varying the distance and computing several energy scores (depending for instance on the number of intermolecular contacts, and on the distance between these intermolecular contacts). It is also possible to perform an optimisation of that distance, so that the Van der Waals and Coulomb radii of the atoms of the regions R and CR′ are the closest possible without nevertheless intersecting.

Until this step, the structure of the assembly of the regions R and CR′ of the two molecules A and B are thus determined uniquely from the alignment of the regions. It is however biologically possible that the two regions are perfectly complementary (and therefore capable of interacting), but that a sterical constraint between the two molecules on regions distant to R and CR′ (the interacting regions) exists, which is depending on the constraint can destabilize or prevent the formation of this assembly.

Starting from the global structure of this assembly determined from the assembly of the regions, it can be useful to check for distant collisions between the two molecules, a commonly used method in computer graphics and in virtual realities.

Following this embodiment, it is possible to validate, penalize or invalidate an interaction detected by the screening of regions and their complementary regions, by checking if the structures of their assemblies include or not important distant collisions.

It is also possible to take into account the malleability of regions inducing these collisions.

In fact, if the regions inducing the intermolecular collisions are coils (zones known to be highly flexible, that are unstable in the space), it is possible to consider that this collision (distant) only penalizes a little the formation of the assembly. Inversely, the collision of stable zones (such as helices) often implied that the two molecules couldn't interact.

In order for this process to be efficient in a screening logic, and knowing that the collision detection algorithms takes a relative amount of time, we preferably apply this filter only on the relevant results of the screening (ex: categories A and B), and not directly during each comparison of regions.

Search of Molecular Targets of Endogen or Exogen Compounds

For any compound, as for any molecule or macromolecule, it is possible to define one or several regions, and to define for each of them one or more complementaries.

A compound is nevertheless a molecule with a relatively small size, which confers it two main modes of interactions: either it interact with the surface of a molecule, or it can interact in a cavity of the molecule (that is an internal and protected surface of the molecule), which is the case in particular with FAD (Flavin Adenin Dinucleotide) and of numerous vitamins.

Often, in the first case of interaction, only a part of the surface of the compound interacts with the target: it will then be necessary to generate distinct regions of the compound, corresponding for instance to each of its sides (according to arbitrary plans/orientations) and to screen them.

In the second case of interaction, often it is all the surface of the compound that interact in the cavity of the target: it is then necessary to consider all the envelop of the compound (which can be obtained by generating a sufficiently big region of the compound).

During the search of the molecular targets of compounds, it is thus necessary to proceed to two distinct screenings, corresponding in a first case to the screening of all the complementary regions of the distinct regions of the compound, and in a second case, to the screening of the complementary envelop of the compound. The envelope, as for a region, is defined by a set of points each characterising a set of remarkable properties. The envelope is in fact a particular case of the region, where all the points of the envelope belong to the region. As a consequence, it is possible to determine the complementary of that region by a method similar used to determine the complementary of the regions.

The screening of complementary regions of the compound as well as the screening of its complementary envelop allows to retrieve a set E of molecules having regions similar to the complementary regions and/or to that complementary envelop. As a consequence, the molecules of the set E are susceptible to be able to bind the compound, that is, the set E represents the set of molecular targets of the compound.

Let us remember that the screening is performed on a database and that this database can reflect a context described by the user: the database can for instance only contain the proteins of a particular tissue, or even an organelle. It is therefore possible to determine in particular the molecular targets of a compound for different tissues.

Typically, there are biological databases such as GenAtlas that describes the tissular expression of genes, that is, the tissular location of proteins or RNA.

Therefore, although a few molecular targets have been identified for some commercialized drugs and cosmetic compounds, there are numerous examples where the targets are not known, whereas for some others, we think that the identified targets are indeed not responsible for the described and desired action of the compound, or also that it is the synergy of action of several targets that produces the desired effect. The in silico screening provided by the invention allows to detect novel molecular targets of the compounds and as a consequence to answer two essential problems:
1) what is the true mode of action of a compound;
2) using that knowledge, how can we make it more efficient, more affine and less toxic; more generally, how modulate the efficacy, the side effects and the toxicity of the said compound.

Let us also remember that it is possible to detect the molecular targets of compounds by finding the region similar to the known binding sites of that compound.

Furthermore, the molecular targets of the pro-drugs (and as a consequence their mode of actions) cannot be detected, unless we already known the different transformations that the compound can undergo during its absorption by the organism. If the different transformation steps of the compound are known, it is then possible to proceed with the detection of the molecular targets for each of these transformed forms of the compound.

Additionally, if structures of the target-compound are available, it is also possible to identify other targets of the compound from the screening of its identified binding sites on these structures. This screening returns in fact the list of molecules having these binding sites able to bind the compound.

Search of Macromolecules and Regions that can be Targeted by Exogen Compounds (“Druggability” Concept)

In the previous description was described the possibility to detect the molecular targets of compounds. This embodiment consists in determining in a systematic way which are the macromolecules that can be targeted by exogen compounds, thus answering the concept of druggability. In fact, if in vitro, the chemical industry is often capable to determine a very specific molecule, in vivo the compound must nevertheless answer to some criteria allowing it to pass the different barriers of absorption in the organism, while not modifying its active principle (or while allowing the modification of its pro-active principle in the case of metabolised drugs).

The comparison of different commercialized compounds has established some rules such as the one of Lipinsky (1997) on the size and the nature of compounds that can have a biological effect.

The presence of such rules on the size and nature of the compound is necessarily reflected (as when using negatives) on the binding sites of molecular targets.

It is then possible that some molecules do not have these binding sites able to bind those compounds that exhibit relatively small intervals of size and nature. Such molecules that do not have the binding sites to bind exogen compounds are therefore said “non druggable”; those having the particular binding sites adapted to the limited natures and sizes of the administerable (i.e., that can be administered) compounds are said “druggable”.

The determination of those druggable and non-druggable macromolecules is therefore particularly important for the pharmaceutical and cosmetic industries, in order to limit their efforts to the targets that have the highest probability to be touched in vivo by the exogen compounds.

According to an embodiment, a list of druggable macromolecules is obtained during a three steps process:
in a first step, a set D of macromolecules known to bind exogen compounds is constituted. Such a set can be easily obtained by confronting the structural data of the PDB (where one can find the structures of assemblies of a macromolecule with a ligand), with the data of the literature detailing the nature of the said ligand.
It is also possible to use such sets of macromolecules-ligand coming from public or private sources. In several cases, the natural ligands of macromolecules can be replaced by artificial ligands, which indicates that those macromolecules as well as their binding sites of natural ligands can generally also be considered as druggable.
In a second step, the said set D of macromolecules-ligands assemblies is analysed in a systematic way: each type of molecule is identified as well as each type of interaction according to the method of the invention.
For each macromolecular-ligand assembly, it is then possible to identify the binding site of the macromolecular target. This binding site (which is a region) is also said “druggable”, in the sense that it is the site of the druggable macromolecule capable of binding an administerable compound. At the end of this study, we obtain a set Sd of druggable sites.
By screening each of these obtained druggable sites, we then retrieve all the molecules having the functional sites. By increasing the tolerance parameters of the energy score used during the comparison of regions, it is also possible to retrieve the set of molecules having sites sufficiently close to the binding sites (in the sense that the sites continue to respect the set of rules described for the administerable compounds). These molecules having sites identical or similar to the sites Sd are then considered as druggable molecules. For each of the druggable molecules, we identify the druggable site and we check by conventional mutagenesis experiments the binding/non binding of the compound to this site.

### Example

The screening of the binding sites of compounds (or of complementary regions of those compounds) such as mannose, FAD, NAD (stands for Nicotinamide Adenin Dinucleotide), NAG (stands for N-AcetylGlucosamine), ATP, eugenol, menthol, dithranol, etc, allows to determine the regions of other molecules also capable of binding either the same screened compound, or compounds close to the screened compound (data observed when the tolerance parameters of the energy score used for the comparison of regions are increased).

Search of Compounds that can Bind a Molecular Region

We have previously seen that it was possible to screen a region R in order to determine the set of similar regions existing on other molecular structures. We have also seen that sometimes one of the region of S is known to interact with a molecular partner, which allows us to infer that the region R interacts with this same molecular partner.

According to a similar embodiment, it is also possible to search among the set S of regions similar to the region R of a molecule A, if one of the regions of S is known to interact with a compound. If the tolerance parameters for the comparison of regions are low, the said compound binding a region S will also be capable of binding the region of the molecule A. According to this embodiment, we thus retrieve a set of compounds capable of binding a given region of a molecule.

Search of Compound Scaffolds that can Bind a Given Molecular Region

According to an alternative of the previous embodiment, if the tolerance parameters for the comparison of regions are higher, the screening will also detail on a set S of regions close to R, but not necessarily identical. As a consequence, the compounds capable of binding the regions of S will not necessarily be able to bind the region R of the molecule A. Nevertheless, these compounds are able to bind regions close to the region R, as a consequence, they provide a work basis for the search of compounds that can bind R. In particular, we will say that such a method allows determining the compound scaffolds capable of binding R. These scaffolds must nevertheless be modified in order to better match the properties of R, for instance by removing, adding or modifying a functional group.

Search of the Specificity (Frequency) of Regions and of Anchor Points of a Molecule or a Molecular Target

The development of an industrial compound traditionally passes by the determination of at least one molecular target, then by the determination of active and “specific” compounds of the desired target. Nevertheless, this “specificity” of the compound is evaluated at best on family of macromolecules (ex: the family of kinases, the family of nuclear receptors), but not on all the molecules constituting a cellular environment.

The efficacy of a compound depends nevertheless not only of its affinity for its target of interest, but also of its affinities with other targets (thus creating a thermodynamic equilibrium between the different unbound and bound forms of the compound with its targets). Until now, only the affinity of a compound for its target of interest could be modulated due to the incapacity to evaluate its other cellular targets. In the method described in the following, we present a method allowing to take into account the specificity of action of a compound with its other targets, so that we can increase its affinity for its target of interest, by lowering its affinity for its other molecular targets in order to both increase its efficacy and reduce its side and toxic effects. More generally, making a compound more specific of its desired target in a given environment, is (equivalent to) reducing its interferences with other biological systems.

During the previous methods, we have shown how it was possible to screen a region in order to retrieve the similar regions, as well as how to screen a compound to retrieve its molecular targets. Therefore, when we start from the structure of the compound, a first approximation of the specificity of action of that compound (and/or of its binding site) is consequently given by the number of its detected targets. More precisely, it is possible to evaluate the specificity of action of a compound by screening the complementaries of the regions and/or of the envelope of the said compound (or by directly screening one or more of its known binding sites) on a database of molecular regions specific to a tissue or to a group of tissues. Such a database then gathers all the regions of known or predicted molecular structures, which are expressed in one or several tissues. The screening of such a database allows to evaluate the specificity of action of a compound for that or those tissues, by evaluating which are its targets in the environment, and what is the frequency of its binding sites in the environment.

After the identification of a molecular target of interest (first step in the development cycle of drugs), it is also possible to determine the most specific regions of this target (respectively the less specifics) by screening each of them and by determining for each, the number of similar regions detected on other molecules and for a given tissue (or several tissues). To preferentially target the specific regions of that target by a compound, allows, very upstream (i.e., early) in the development cycle of drugs, to limit the risk of interferences of the future compound with other biological systems.

An example of embodiment thus consists, for any region R of a molecule A, of determining its specificity index, that is, to count the number N of regions that are similar, and to assign this number N to each of its points. The method is repeated in an iterative way for each region of A and for each points of these regions, the index of specificity of a point is then equal to the sum of the specificity indexes (indices) of the regions that contain it.

We thus obtain at the same time, a specificity index for each of the regions of the molecular structure, but also a specificity index in each point of the molecular structure. As we will see in a moment, this cartography of the specificity allows consequently to indicate which are the regions and the anchor points which are the most (respectively the less) specific of the molecule. This information is particularly important for the selection of a region to be targeted by a compound. In fact, very upstream in the development cycle of drug candidates, after the selection of the biological target, we preferentially choose very specific regions of that target to ensure that we develop a compound capable of binding a specific region of the target. In fact, if the chosen region is too frequent (not specific) in a given environment, the compound could bind to several cellular targets and these interferences will not only lower the specificity of action of the compound (and therefore its efficacy), but will also risk to induce side and/or toxic effects.

According to an alternative of this embodiment, the index of specific of a region can also be normalized by the expression levels of genes (by using for instance data from DNA microarray, or SAGE (Serial Analysis of Gene Expression) coding the RNA and proteins having these regions. These expression levels of genes which correspond to the amount of proteins and RNA produced in an organism and in a given tissue (that is, their frequency in the cellular environment) are also stored in different databases, in particular GenAtlas. This one details the expression level of genes for different tissues of an organism.

Indeed, the fact that a region be (in one or more copy) on a molecule is a first data to evaluate the specificity of a region, but the number of copies of that molecule (evaluated by the gene(s) expression coding this molecule) in the organism and/or in a tissue is a second data to normalize this specificity.

### Example

The protein A have a region R which was found on M regions of N molecules Bi. Let R′I be a region similar to R and on one of the Bi molecules. The first index of specificity will then simply corresponds to M, the number of similar regions retrieved in a database. The second index of specificity (normalized by the number of known structures per molecule) will correspond to N (the number of molecules having this region). If for each Bi, an expression level of the gene(s) indicates the frequency of Bi in the environment, then it is possible to re-evaluate the index of specificity of R by weighting the representativeness of one (or several) regions contained in the Bi molecules by the expression level of the gene(s) that produce it or them.

In fact, if the molecules Bi are {B1, B2, B3} and that the expression levels of the Bi molecules are respectively 1, 5, 3 and that B2 have two regions similar to R: the first index of specificity described above will be M, which is 4 here since B2 have two regions similar to R, and B1, B3 respectively have only one region similar to R. The second index of specificity described above will be N, which is 3 here. Finally, the third index of specificity, normalized by the expression level of gene(s) each coding for the molecules will be: 1×1+5×2+3×1=14. Let us note that the number “2” in the previous equation corresponds to the fact that on B2, two similar regions exist, whereas the numbers “1” correspond to the fact that on B1 and B3, only one similar regions exist.

According to another embodiment, when we are interested in a specific region of a molecule, it is possible to screen this region to retrieve the S of similar or close regions. Starting from this set S of aligned regions, it is also possible to compute the standard deviation of the remarkable properties in each point of the regions. In fact, every regions of S being aligned, at each point P₁ of a region S₁ correspond N points Pⱼ on all the other Sᵢ regions of the set S. As a consequence, it is possible to define a list L for each remarkable property, containing the states of each of the points Pⱼ aligned with the point P₁.

### Example

Let P₁, P₂ and P₃ be three aligned points of three distinct regions Rₐ, R_{b} and R_{c}. Let C₁, C₂ and C₃ be the respective local curvatures of the points P₁, P₂ and P₃. It is then possible to compute the average of these curvatures, as well as the standard deviations of these values, by conventional methods (see molecular cartography and average/variation behaviour of property).

Therefore, for each point of a given region R, it is possible to define the standard deviation of the remarkable properties observed with each point of the regions aligned with the region R, and to assign the value of this deviation to the corresponding point.

These second forms of cartography then allow to define a fine specificity on each point of the given region. It can in particular be used to determine the most specific anchor points of the given region R, the said anchor points being defined as the points of R for which the value of the standard deviation is greater than a predefined standard deviation threshold and where their state of property is not included in the interval [average−standard deviation, average+standard deviation] defined by the analysis of the states of the aligned points.

Furthermore, the knowledge of the anchor points informs on the shape and composition that a compound should have to be specific to the given molecular target.

Creation of Interaction Profiles for a Given Region or for a Given Set of Regions

To ease the visualization and interpretation of screening data, it is possible to determine interaction profiles for each region (or for all or part of the regions of a molecule). In order for this interaction profile to be informative, it is defined in a two dimensional matrix, so that it is possible to represent it by a coloured image.

Therefore, rather than determining only the partners of a molecule, we classify these partners according to their belonging to a tissue and/or a metabolic pathway.

An embodiment of that interaction profile consist of classifying in horizontal the different tissues, and in vertical, of classifying the metabolic or regulation or signalisation pathways for each tissue or inversely. Thereby, for any point (x, y) of such a profile, it is possible to detail in which tissue the interaction takes place, and which metabolic/regulation/signalisation pathway is affected. This interaction profile can in particular be used to compare the action spectrum of compounds in different tissues. It can also be used to determine the specific and non-specific partners of a target, for a given tissue (example: the molecules A and B interact in the muscular tissue, but do not interact in the neuronal tissue).

For instance, we obtain a two-dimensional matrix, where each point identifies a molecule specific to a tissue and a metabolic pathway, and each rectangular zone detail both a tissue and a metabolic pathway.

According to another embodiment of the interaction profiles, the metabolic/regulation/signalling pathways are classified in horizontal, and the molecular families are classified in vertical. Thereby, for any point (x, y) of such a profile, it is possible to detail which is the metabolic/regulation/signalling affected, and what is the molecular family affected.

Note: several databases such as Uniprot, KEGG, GO inform on the various metabolic/regulation/signalling pathways, as well as their belonging to a molecular family.

The use of these interaction profiles eases the comparison of the affected tissues and of the engaged mode of action for any molecular compound or any macromolecule. In particular, we have seen previously that it was possible to screen a same functional region under its active form of inactive form (for instance due to the binding of a third partner, or due to a genetic disease). The comparison of the interaction profiles of the active form and of the inactive form rapidly inform on the pathways that have been differentially activated, thus providing with a better understanding of the cellular consequences of these molecular interactions.

Molecular Interaction Graphs from the Screening and the Interaction Profiles

Essentially, the screening approach allows to highlight and detail the regions responsible of molecular functions, in particular of molecular interactions.

It is therefore possible to create a graph representation of these interactions. In particular, an embodiment consist of representing a molecule by a node, and each edge of the graph represent an interaction between these molecules. The edge can then be labelled to describe the interaction by detailing for each of the two nodes linked (each of the linked molecules), the interacting regions of their interface.

Alternatively, a molecule can be described by a set of gathered and interconnected nodes, so that the molecule is represented by a cluster of points (corresponding to its regions) localised in space. These performance algorithms of graph representations exist to achieve this embodiment, in particular softwares such as GraphViz. It is then possible to detail the interaction between molecules by linking the nodes representative at the same time of a molecule and of a molecular region.

According to another embodiment, it is also possible to create layers representative of a type of molecular interaction (as previously detailed: protein-protein, protein-DNA, protein-RNA, protein-ligand, etc.). Therefore it is possible to only concentrate on only one type of molecular interaction, thus easing the visualization of those data.

Such layers can also represent the cellular/tissular localization of molecules. It is then possible to ease the visualisation of interactions by considering only those taking place in a cellular and/or tissular type. In particular, it is possible to only consider the interactions for which at least one (or the two) molecule is known to be available in this cellular and/or tissular type.

It is also possible to create layers, representative of one or more metabolic/signalling/regulation pathways. It is then possible to ease the visualization of the interactions by considering only those for which at least one of the interacting molecules acts in the metabolic/signalling/regulation pathway.

The edges representing the interactions can also be coloured in order for them to correspond to categories of confidence score (described from the division in intervals of the normalized energy sore) to visually detail which are the most certain (respectively the less certain) predicted interactions.

According to an alternative of these embodiments, it is also possible to create layers, representative of categories of confidence, determined from the energy score derived from the comparison of regions. It is therefore possible to only display the molecular interactions of the category A, the most certain, and until the last category that have a relatively low confidence score.

Evaluation and Classification of a Side or Toxic Effect of a Molecule by the Analysis of the Interferences of Biological Interfaces Induced by the Said Molecule

It is here possible to evaluate a potential side or toxic effect of a molecule and to explain its molecular causes.

A side or toxic effect of a molecule A is here considered as being the interference of one or more biological interfaces.

Let us first note that the toxicity is a particular case of side effects. As a consequence, in the present description and in the annexed claims, all the information and method relative to the evaluation of a potential side effect can also be applied to a toxic effect, and inversely. In particular, any reference to a side effect must be understood as also covering the toxicity.

According to a first embodiment, we determine the complementary regions of the molecular regions of the molecule A.

These complementary regions reflect the shape as well as the physico-chemical properties that a molecular region should have to bind the said molecule. In other terms, by searching among a set of regions, the complementary regions of A, we search for the potential binding sites (and associated molecules) of the molecule A. This method is similar to the one presented for the search of molecular partners and molecular targets. According to this embodiment, we thus obtain a set S of regions susceptible to bind the molecule A.

We then search if one of the regions of S is known to bind a molecular partner M, and if yes, we detail its molecular type. If such a region R is capable to bind both the molecule A and another molecule M, there will be a thermodynamic equilibrium of reactions. This specific specify that at the level of the region R, there will be a competitiveness to bind either A or M. As a consequence, the affinity (the dissociation constant) of the biological assembly region R-M is decreased, which can induce a potential side or toxic effect.

It is in particular possible to classify the different biological interfaces, especially to differentiate the macromolecular-molecule interface type (ex: protein-ligand, DNA-ligand), from the macromolecular-macromolecular interface type (protein-protein, protein-DNA, etc.). The interference of those two great types of biological interfaces does not induce a priori, a same risk.

According to a second embodiment, close to the first one, we use the already identified binding sites of the molecule A. So that, we do not have to perform the step which consists in generating the complementary regions, thus reducing the risk of errors. As in the first embodiment, we then search if the binding site of the molecule A is similar to one or several other binding sites of biological interfaces. If it is the case, this means that the molecule A can interact with these other biological interfaces, thus inducing an interference with those biological interfaces, and thus inducing possible side and toxic effects.

As an alternative to these embodiments, we perform a screening of the complementary region (or of the binding site) of a molecule A, on a database containing only the molecular regions identified to be binding sites of biological interfaces. We thus considerably decrease the number of regions to be compared.

Generally, the potential toxic or side effect of a molecule A is important if A interferes with (i.e., disrupts, perturbes) a macromolecular biological interface (ex: protein-protein, protein-DNA). If A interferse with a biological interface containing at most one macromolecule (that is, macromolecule-molecule, or molecule-molecule), the potential toxic or side effect is more difficult to determine (such examples, of compounds in competition with ATP without inducing toxicity are known). It is in particular possible to try to establish a link between the risk of toxic and side effect with the area (or areas) of each interfered biological interface.

This method only allow to predict a “risk” of toxic or side effects induced by a molecule and to detail its molecular causes, which was not possible before. In fact, due to the limited number of molecular structures, it is not possible for the moment to affirm that a molecule does not induce a toxic or side effect. Nevertheless, this method allows to identify the biological interfaces that could be interfered by a molecule. We then can better understand the molecular causes behind this toxicity, and therefore provide solutions to reduce this toxic or side effect (see the method on the led rescue of toxic compounds that will be detailed in the following).

Furthermore, only a limited number of biological interfaces have been described on the scientific literature. It is therefore possible to include the predicted biological interfaces described for instance by the screening method according to the method of the invention, or by molecular docking experiments.

Evaluation and Classification of a Potential Toxic or Side Effect of a Molecule by Using the Interaction Profile of the Said Molecule: the Chip of Toxic and Side Effects

We have seen that we can evaluate a risk of toxic or side effect of a molecule according to the risk of interferences of biological interfaces. That is, it becomes possible to detail the molecular causes of a side effect or toxic response.

We can nevertheless evaluate the risks from the interaction profiles of the compound, in particular due to the limited knowledge on biological interfaces.

To do so, several sets of compounds known to induce different toxic or side effects (belonging to toxic classes such as allergen, sensibility, neurotoxocity. Or of side class of side effects, such as those described in the reference article “Drug Target Identification Using Side-Effect Similarity”, Monica Campillos, Michael Khun, Anne-claude Gavin, Lars Juhl Jensen, Peer Bork, published in the Science journal the 11 Jul. 2008, Vol. 321, no. 5886, pp. 263-266, DOI: 10.1126/science.1158140) are screened, so that we obtain for each of these compounds, the corresponding interaction profiles. In parallel, several sets of compounds having various properties and sizes, but known to induce no toxic response or side effects are screened. We then obtain a second set of interaction profiles corresponding to the non toxic compounds or that do not induce side effects.

According to a first embodiment, the toxicity of a compound is evaluated from its resemblance to one at least of the N interaction profiles of the toxic compounds and from the interaction profiles T of non toxic compounds. The side effect of a compound is also evaluated from its resemblance at one at least of the E interaction profiles of the compounds inducing side effects and of the NE interaction profiles of the compounds not inducing (or little) side effects.

An Euclidian distance is then computed from the sum of interactions shared by the compound and the set N (extracted from the interaction profiles), as well as from the sum of interactions shared by the compound and the set T. The compound is then described as having a risk of toxicity if the distance between him and the set N is inferior to a certain percentage of its distance to the set T (i.e. if the compound has therefore an interaction profile closer of the toxic compounds, than of those of the non-toxic compounds). In the same way, the compound is described as having side effects is the distance between him and the set E is inferior to a certain percentage of the distance to the set NE.

According to a second embodiment, for each toxic class studied from the N interaction profiles, we search the interactions shared by all or part of the set N (i.e. the interactions always/frequently induced by a compound of that toxic class). We also search the interactions shared by all or part of the set T of interactions profiles derived from the screening of non-toxic compounds (i.e. the interactions always/frequently induced by the non-toxic compounds). By difference, we then observe the interactions that are only induced by the toxic compounds. These interactions and therefore these binding sites are therefore biomarkers of one or several toxic classes.

In a same way, it is possible to identify biomarkers of toxic classes (as, as we have seen it above, a toxic compound present by definition side effects). In the following, we will only describe the steps in relation with the compounds inducing side effects: they are nevertheless applicable to the case of toxic compounds.

Alternatively, we identify the biomarkers of each class of side effect, by identifying the binding sites that always/frequently bind the compounds that induce at least one side effect of that class (and that do not bind the compounds that does not induce side effects, neither do they bind the compounds inducing side effects of other classes). This alternative is also applicable for toxic compounds.

According to these embodiments, the side effects (respectively the toxicity) is therefore evaluated from the interaction profiles of a molecule, that is, from the interactions that the molecule can make in a cellular/tissular context. The advantage with this method with respect to the previous method of side effects evaluation (and therefore of toxicity), resides in the fact that it does not have any a priori on the regions that can be interfered: here, we not only consider the known binding sites, but also all the known molecular regions. The sensitivity of the approach is therefore increased: 1) because all the binding sites of biological interfaces are not known and 2) because the side effects can also be the consequence of more complex phenomena (such as the synergy of several interactions, or such as the interference of the stability of a molecule).

Furthermore, the new European regulation REACH greatly encourages the development and the use of new alternative methods (in particular in silico) of evaluation of side effects and in particular of the toxicity, such as these two methods (evaluation of the toxicity by the analysis of the interferences of biological interfaces, and evaluation of the toxicity by the analysis of interaction profiles).

Molecular Cartography Allowing to Gather and Summarize Different Knowledge Produced by the Previous Applications from a Single Molecular Structure

During the different methods that were described above, numerous biological data was generated, in particular on the binding sites, molecular partners, druggable regions, specific regions and risks of toxicity.

Such screening methods (either in vivo, in vitro or in silico) nevertheless generate a huge amount of data that is often difficult to treat and for which, it is difficult to have an overview. We have previously seen that it was possible to generate visualizations using graphs and layers, and we have also seen that it was possible to generate interaction profiles to ease the access of those data.

A third embodiment to ease the access and visualization of the biological data produced by screening methods is to construct a molecular cartography. Such a cartography consists in assigning to each point and/or to each region of a molecular structure, a value representative of a given state. For a molecular structure, the described screening methods of regions allow for instance to detect the binding sites Li of that molecules, as well as the corresponding molecular partners Mi. For each binding site L, it is therefore possible to assign a value characterising the type of the binding site. In particular, it is possible to detail that the points constituting this binding site (and therefore, the atoms and/or residues respective to these points) serve to form assemblies with a partner of type protein, peptide, nucleic acid, etc. Following this embodiment, we then cartography on the molecular surface, the ability of each point and of each region of the molecule to participate to one or several specific interactions.

### Example

If two binding sites L₁ and L₂ are retrieved from the screening of a region R of a molecule A, then the ability to interact of the region R is defined by the union of the states of L₁ and L₂. For instance, if is known to form an assembly with some proteins and that L₂ is known to form an assembly with ligands, then the region R will be defined as having the ability to interact with a protein, and a ligand.

According to an alternative of this embodiment, we also label the regions and L₂, so that we keep the identity of the partner of the region L₁, and the partner P₂ of the region L₂. Besides the ability of the regions L₁ and L₂ to bind one (or more) molecular types, ability transposed to the region R, the identity of the partners P₁ and P₂ is also transposed to the region R. Therefore, the molecular cartography not only inform on the location of binding sites on the molecular structures (and their abilities to bind specific types of molecules), but also on the known partners (here P₁ and P₂) of these molecular binding sites. This embodiment can also be applied during the search methods of molecular partners that use the complementary of regions.

According to an alternative of these embodiments, it is also possible to cartography the specificity of regions and the specificity of anchor points of binding sites. Let us remember that the computation of specificity of regions has been described in one of the previous methods as being the number of similar regions retrieved during a screening on a specific database (reflecting a cellular/tissular/environmental context). It is therefore possible to cartography the specificity of regions and/or points of the molecular structure from the computed specificity values. The most specific points of the molecular structures then correlating with the notion of hot spot described in structural biology and in biochemistry.

Moreover, the molecular cartography can be used to summarize the observed variations on any property computed during the screening (ex: curvature, charge, density, malleability, residue conservation, surface normal orientations, local shape, etc.). It not only has a visualization role, but also provides a way to compute and analyse those variations. In fact, given a list Lᵢ of regions similar to a given region R, for each couple (R, Lᵢ), there is a matching scheme between the points of R and the points of L. It is therefore possible to analyse the behaviour and deviations of one or several properties between any couple (R, Lᵢ). In particular, it is possible to compute the average tendency of points for any couple (R, Lᵢ) in order to highlight the main tendency of one (or several) property in these points. It is also possible to compute the standard deviations on the observed variations of properties for any couple (R, Lᵢ).

### Example

We want to determine the average behaviour of a given property in a point P of a region R.

Let L₁, L₂ and L₃ be three regions similar to the region R and P₁, P₂, P₃ be points of L₁, L₂ and L₃ respectively aligned with the point P. The point P (as the points P₁, P₂ and P₃) is characterised by a set of states of properties (described by a list of real values) characterising for instance the curvature, the charge, the local density, etc.

Let us consider the property “curvature”, normalized on the interval [−1, 1] following the conventions in which the curvature is close to −1 for the cleft zones, is close to 0 for the flat zones, and close to 1 for the knob zones. If the respective states of that property for the points P₁, P₂ and P₃ are respectively 0.7, 0.9 and 0.6, the average behaviour at the point P of the region R being given by the average of the states of the aligned points P₁, P₂ and P₃, we here obtain an average of 0.73. A typical equation to compute this average is:

$${moyenne}_{{E}_{p}} = \frac{1}{N} {\sum }_{i = 0}^{N} {E}_{p} ( i )$$

Where moyenne_{E}_{_{P}} is the average of the values of the states of the properties defined by the list Eₚ; and

N is the number of elements in the list Eₚ.

We can therefore assign to each point P of the molecular cartography, the average value of the states of the curvature, i.e. 0.73.

Now, we want to determine the variations of a given property at a point P of a region R:

By taking the same previous example with the three states 0.7, 0.9 and 0.6 of the property Eₚ for the three points P₁, P₂ and P₃ aligned to the point of R, it is possible to compute the standard deviation by applying a usual equation:

$$std ( {E}_{p} ) = \frac{1}{N} {\sum }_{i = 0}^{N} {( {E}_{p} ( i ) - {moyenne}_{{E}_{p}} )}^{2}$$

Where std(Eₚ) returns the standard deviation of the list of states of the property Eₚ; and

N is the number of states defined in Eₚ; and

moyenne_{E}_{ₚ} is the average value of the elements of Eₚ.

According to this embodiment, the molecular cartography can therefore inform not only on the average behaviour of one or more properties at any point (respectively for any region) of a molecular structure, but it can also inform on its variations.

In particular, such a method has important applications in order to systematically determine and observe the change of properties in a molecular structure under different contexts (when the region is in an unbound form, that is, when it binds no partner, or when the region is in a bound form, that is, when it binds at least one partner of a given molecular type). In particular, it is then possible to observe the conformational changes (of shapes) of the molecular structure in these points (respectively regions) during the molecular assembly formation. In the same way, it is possible to observe the changes in the charge distributions, or in the local densities, or in the hydration of surface atoms and residues (identified by their 3D points of the representation of the molecular structure).

In particular, the hydration can be computed as being the interaction of a point of a molecular structure (reflecting an atom/residue of the said molecule) with at least one water molecule. Due to the lack of data on the location of these water molecules in molecular structures (both due to sometimes too-low resolution structures but also due to the lack of conventions on the necessity to resolve the location of these water molecules around the macromolecules), it is therefore particularly important to cartography the state of solvation of a point P (respectively of a region) from the average of the hydrated and non-hydrated states of the aligned points P. In fact, this average, more robust, allows to reduce the sources of error described and to retrieve the points that are generally in contact with water in a given context.

The method to classify (i.e., rank) the similar regions obtained during a screening and following a context in which a region is found is therefore particularly important (description of the unbound form or bound form of the region; and if under a bound form, consider the type of molecular interaction). Indeed, the fact to consider a set of regions in a given environmental context allows us to study this region with a dynamic view, that is, to observe the changes of behaviour (of properties) in different molecular and cellular contexts.

Note: if it is possible to classify the screened regions following the context in which they are similar, it is also possible to consider the context of molecular structures having these similar regions. We will then look for instance if the molecular structure is single or interacting with other partners, as well as to the physico-chemical conditions that allowed to obtain the said structure, in particular in the presence of ligands.

More generally, the concept of molecular cartography applied to the screening allows to gather, analyse and to simply summarise on a single molecular structure, all the biological data produced: either states of physico-chemical, geometrical or evolutionary properties, or the ability of a region to interact with one or several types of molecules, or the specificity of points or of regions of the molecular structure. It is also possible to add a cartography to warn of the too unspecific regions, which if they were to be chosen to create ligands, could induce toxicities.

LED Rescue Approach of Toxic or Inefficient Compounds Following the Interaction Profiles and the Specificities of a Compound and of its Targets

During the previous methods, we have described how it was possible to assign functions and biological behaviours to regions of a molecular structure. We have also described that it was possible to create a molecular cartography to detail the different known binding sites of the said molecule, as well as the corresponding partners.

These screening methods describe a molecular structure with a high accuracy, and can go as far as indicating the regions specific to that structure, and the regions that, when they are targeted by a compound, present a risk(s) to interfere with other molecules. These regions presenting risk of interferences are in particular the biomarkers of side effects and toxicity previously described.

Two evaluation methods of the toxicity and of the side effects have been provided, a first that check if the molecule of study does not interfere with known biological interfaces; the second that determines the interaction profiles of the said molecule and compare it to the interaction profiles of molecules inducing toxic or side effects (by differentiating the types of toxicities and side effects) as well as to the interaction profiles of non-toxic or with little side effects molecules (natural or commercialized molecules with no known toxicity).

The two methods inform on the possible interferences with other molecular regions, thus providing one or several molecular causes to this toxicity and/or to those side effects.

Given a molecule M having as target a binding site L, suppose that the screening method following the invention indicates that it can interfere with other regions Rᵢ. Starting from the alignment of L with all the Rᵢ regions, it is possible to observe the geometrical and physico-chemical differences between the points L and the aligned points of all the other regions Rᵢ.

These localised differences (which can be automatically computed by determining for instance the average and the standard deviation of one or several properties, for all the points Rᵢ aligned with a point of L) inform on the specific and non-specific anchor points of L.

The FIG. 7 represents for instance the localised differences between the region L and the regions R₁ and R₂. The points circled on the region L indeed do not have equivalents in the regions R₁ and R₂ (because they are not present in these regions or they have distinct properties), and are therefore specific of L. The dotted line describes a case of variability where the point of L exists in R₁ but not in R₂; this point is therefore not specific of L. It is important to note that the presence or absence of a point on the FIG. 7 can indicate: either the presence or the absence of an atom or residue on the molecule; or a drastic change of a state of property at this point (for instance on L, the atom is cationic, but on R₁ and R₂, the corresponding atoms are anionic).

By complementarity with these specific anchor points of the region L, it is then possible to determine the “ideal” contact points to create a specific compound. In particular, starting from the compound with toxic or side effect risks, it is possible to slightly modify its structure in order to better target the specific anchor points of L, and therefore to be less specific of the other points shared by all the regions Rᵢ. These slight modifications of the compound can be done in particular by adding, removing methyl groups or other functional groups known in organic and/or inorganic chemistry.

This led rescue approach of toxic molecule (or inducing side effects) consists therefore in determining the set of molecular targets of the toxic molecule (or inducing side effects), then to compare these target regions with the region L that we want to specifically target. From the molecular cartographies and the observation of behaviours and variations of properties for these aligned regions, it is therefore possible to determine the sub-regions that are specific to L, and those that are not. By slightly modifying the structure of the compound, either by making it more specific to the specific sub-regions of L, or by making it less specific of the sub-regions shared by all the targets, it is possible to lower or to cancel a toxicity risk.

As an alternative of this embodiment, the compound is not toxic but has a demonstrated activity, in particular in vitro that does not reflect in vivo: the compound is not efficient because it is blocked by too great a number of biological targets. By a similar method, it is possible to propose slight changes of the compound structure, so that it can be more specific to the anchor points of its target L, and less affine to its other targets Rᵢ (FIG. 7). By lowering the affinity of the compound for its other targets, we increase its in vivo efficacy by greatly favouring its interaction with the target L.

### Example 1

A molecule M having a site of interest L is targeted by a compound A by its region L_{compound}. The screening of the region L and/or of the complementary of the region L_{compound} allows to detect a molecule B having a binding site R and coming from a biological interface of type macromolecule-macromolecule. It is in particular possible to visualize the geometrical and physico-chemical alignment of the region L with the region R, so that we can easily identify the points of these regions that resemble the most, and those that differ the most (let us remember that a point of a region references one or more atoms and/or residues of the molecule), as illustrate the FIG. 7. We can imagine that the region R has a localised sub-region, with more clefts or more charges than its equivalent sub-region on L. Therefore, to make the compound more specific to the molecule M and less specific to the molecule B, it is possible to slightly change the structure of the compound, so that the sub-region of the compound that binds L have respectively less knobs and less charges. These changes of the structure of the compound are intended to make it more complementary of L, and less complementary to R (with respect to the geometrical and physico-chemical properties).

We can also imagine that the region L possesses a cleft sub-region that is not shared by the region R. As a consequence, it is possible to add to the compound an adequate group of atoms (charged or not and following the associated cleft sub-region) that can bind to this cleft sub-region. This modification which plays on the difference in a sub-region of L and R, prevent the binding of the compound on B by sterical constraint, while not destabilizing its binding on A.

### Example 2

A molecule M having a site of interest L is targeted by a compound A by its region L_{compound}. The screening of the region L and/or of the complementary of the region L_{compound} allows to detect several molecules Bᵢ having a binding site Rᵢ close to L. If it is possible as in the previous example to visualize each alignment of L with a Bᵢ, it will be advantageous here to cartography the average behaviour of properties for the regions Bᵢ, and to compare this average behaviour to the one of L. Essentially, the fact to observe the average behaviours of the Bᵢ, allows to ease the visualization of the geometrical and physico-chemical differences between all the Bi and L. Therefore, for each sub-region having differences, it is possible to treat the structure of the compound by examples similar to the example 1. In particular, one can interest himself in the sub-regions having differences between all the Bᵢ, (discretised by a region built from the average behaviours of properties) and L, and to interest himself only to the sub-regions having small standard deviations. In fact, the small standard deviations will detail that for all the Bᵢ, the average observed behaviour does not vary a lot. Therefore, when we modify the structure of the compound to make it less correspond to this average behaviour of the Bᵢ, by increasing the complementarity with L, we ensure to lower the specificity of the compound for all the Bᵢ, or at least, for many of them.

### Example 3

The two previous examples can require the presence of a user to visually check the alignments of a binding site of interest L with the binding site R of an interfered biological interface. Let us remember however that the global energy score is computed from the sum of local energy scores, themselves computes from the comparison of states of properties of two aligned points. These local energy scores inform as much on the similarity that on the difference between two regions in these points. As a consequence, the local energy score can automatically detect the points in two regions that differ the most. According to the method that allows to detect the error regions of an alignment of two regions, it is therefore possible to automatically detect the sub-regions of these two aligned regions, that differ the most. Therefore, it is also possible to automatically provide modifications of the compound to play for instance on the sub-regions that differ between the regions R and L. For instance if we automatically modify the compound so that it can bind a sub-region specific to L and that do not exist on R, then the compound will be more specific of its target of interest, and less specific of its non-wanted target(s).

### Example 4

A compound C targets a region L of biological macromolecule MB. The screening of the region L allows to retrieve a collection of similar regions Rᵢ, and as illustrated on FIG. 7, it is possible to superimpose the pairwise alignments in order to visualize the matching of points of the different but similar regions. For each point of L, it is therefore possible (1) to visualize if it exists on L, and (2) to determine if it has a state of properties (or several states of properties) that are unique to L. For instance, on the FIG. 7, we can see that four points belong exclusively to the region L. It is therefore possible to propose modifications of the compound C, so that it preferentially target these four points, which will make it more specific to bind L, and less specific of the regions R₁ and R₂. Another example would be to say that these four points have charges different between L and the Rᵢ: in L, these points represent charges for instance anionic, whereas for the aligned points in the Rᵢ, they are for instance hydrophobic or cationic. We thus increase the specificity of the compound C for L not by adding (or removing) atoms, but by changing the charges in these points so that they are more complementary to L (here, one must therefore use cationic charges).

1-24. (canceled)

25. Method for characterizing at least one molecule, comprising:
Implementing a triangulation of the surface of said molecule and/or a tetrahedrization of the internal volume of the molecule for generating a mesh of said molecule, said mesh being constituted by surface points and/or internal points of said molecule, bound in pairs by an edge;
Characterizing the points and/or facets of said mesh by determining the respective states of geometric, physico-chemical and/or evolutionary properties at these points and/or facets;
Segmenting said mesh in three-dimensional contiguous regions of the molecule, according to said characterization of points and/or facets; and
Screening said region and/or a complementary to said region in a database comprising a set of prerecorded molecular regions to obtain at least one recorded region which is similar or complementary to the screened region.

26. Method according to claim 25, wherein at least one function of the recorded region similar to said screened region is determined and inferred to said screened region, or wherein at least one interaction is determined from the search of at least one region complementary to the screened region and is inferred to said screened region.

27. Method according to claim 25, wherein the screening of said region in the database comprises a determination of an alignment allowing to maximize a global energy score, called optimal alignment, by iterations of:
Establishing a matching scheme between the points and/or facets of the compared regions by searching, for each point of said screened region, the point which is the closest in said recorded region, in terms of distance between the states of at least one of the geometric, physico-chemical and/or evolutionary properties;
Computing, for each pair of matched points, a local energy score measuring the difference between the states of one or several geometric, physico-chemical and/or evolutionary property or properties, at these points;
Computing a global energy score by summing said local energy scores; and
Producing a new alignment of the recorded region with respect to the screened region by operating a rotation of at least one of these regions.

28. Method according to claim 26, wherein the screening of said region in the database comprises:
Computing a global energy score for the alignment of said screened region with itself;
Dividing the global energy score for the alignment of said screened region with said recorded region by the global energy score for the alignment of said screened region with itself, so as to define a normalized global energy score;
Evaluating and categorizing the quality of the optimal alignment, by comparing the values of the normalized global energy score with one or several reference score(s).

29. Method according to claim 25, wherein a region of the molecule to be characterized is screened in a database comprising a set of regions presenting geometric, physico-chemical and/or evolutionary properties having states which are similar to those of the screened region and/or obtained according to a same segmentation process, said method further comprising a determination of the molecule from which was generated the region obtained.

30. Method according to claim 25, wherein a complementary of the molecular region to be characterized is screened in a database comprising a set of regions having states of geometric, physico-chemical and/or evolutionary properties similar to those of the screened region, so as to determine a region from the database having an optimal alignment with the screened region, said method further comprising a determination of the molecule from which was generated the region obtained.

31. Method according to claim 29, further comprising:
Identifying, among the regions obtained, at least one region capable of binding a compound or any other type of molecule, so as to define a scaffold of compounds or molecules capable of binding the screened region; and
Determining whether the screened region is also capable of binding this compound or molecule.

32. Method according to claim 31, wherein, when the screened region is not capable of binding the compound or molecule, the method further comprises modifying the scaffold of the compound or molecule, so as to obtain a new compound or new molecule which is capable of being bound by the molecule under study.

33. Method according to claim 25, further comprising a determination of the known molecular interactions of the molecule by one of the following methods:
Analysis of intermolecular distances,
Determination of intermolecular interactions between atoms and residues of two molecules;
Differentiation of interactions and binding sites, depending on whether the assembly corresponds to one of the following assemblies: X-protein, X-peptide, X-DNA, X-RNA, X-lipid, X-ion, X-solvent, or X-ligand, where X belongs to one of the molecular types among the proteins, peptides, DNA, RNA, lipids, ions, solvents or ligands.

34. Method according to claim 25, in which the molecule under study is a macromolecule capable of binding compounds or any other type of molecules, said method further comprising:
Identifying the binding sites and the associated partners of the macromolecule, said binding sites each defining at least one region of said macromolecule;
Screening the binding sites and/or associated regions thereby identified so as to determine the set of molecules having similar binding sites; and
Inferring the binding sites and associated partners of the macromolecule to all molecules having similar binding sites.

35. Method according to claim 25, wherein the druggability of a molecule and of a region is determined by:
Determining a set of molecules known to bind at least one exogenous or endogenous compound;
Identifying the binding sites of these molecules; and
Screening the binding sites thereby identified, so as to determine a set of molecules having similar binding sites, capable of binding exogenous or endogenous compounds.

36. Method according to claim 25, wherein a specificity index of a given region of the molecule under study is determined by:
Screening the region, or respectively the complementary to the region, on a database of molecular regions reflecting a specific environmental context; and
Assessing the specificity index of the region, by calculating the number of molecular regions similar to this region, or respectively similar to the complementary to this region.

37. Method according to claim 25, wherein a specificity index of a given region of said molecule under study is determined by calculating the number of molecules having a similar region, said number of molecules being weighted by the number of similar regions displayed by each of these molecules and/or by the frequency of said molecule in a given environment.

38. Method according to claim 36, further comprising assigning, to each point of the mesh of the molecule, a specificity index equal to the sum of the specificity indices of the regions containing this point in the molecule.

39. Method according to claim 25, wherein specificities of the molecule are determined by:
Determining a set of regions similar to each generated region of the molecule under study;
Aligning each similar region with the corresponding region of the molecule under study;
Determining the average of the states of geometric, physico-chemical and/or evolutionary properties at each point;
At each point of the aligned regions, determining the standard deviation of the states of geometric, physico-chemical and/or evolutionary properties and assign the value of each standard deviation to the corresponding point in the screened region, so as to obtain a cartography providing information on the variability of the observed states of properties; and
Deducting, from the cartographies thereby obtained, anchor points specific to each region, said anchor points being defined as points of the screened region that have states of geometric, physico-chemical and/or evolutionary properties which differ from those of the corresponding points of the aligned regions.

40. Method according to claim 25, wherein a potential side effect of a molecule under study is evaluated by:
Screening at least one binding site of the molecule under study or at least one complementary to a region of the molecule under study in a database comprising a set of molecular regions defining a determined environmental context;
Finding, in the database, the molecules with regions similar to the binding sites of the molecule under study, and/or regions complementary to the molecule under study, in order to deduce the molecules capable of binding the molecule under study;
Optionally, evaluating the assembly of the regions found with the molecule under study; and
Determining whether the regions found are known or predicted to bind other molecules and determining their molecular type to assess the potential of side effects of the molecule under study.

41. Method according to claim 40, further comprising:
Determining a set of compounds inducing at least one side effect, that is to say a set of compounds belonging to at least one determined class of side effects;
Determining a set of compounds which does not induce side effects, that is to say a set of compounds inducing no side effects;
Determining the interaction profile of each of said compounds and the interaction profile of the molecule under study;
Determining a distance between the interaction profile of the molecule under study and each of the interaction profiles of the compounds inducing side effects and of the compounds inducing no side effects;
Determining whether the distance between the molecule under study and at least one of the profiles of compounds inducing side effects is lower than or equal to a predefined threshold percentage of the one for the compounds inducing no side effects, and deducing the potential of side effects induced by the molecule under study, and
Determining the type of side effects induced by the molecule under study by referring to the class of the compound inducing the side effect having the closest interaction profile to the interaction profile of the molecule under study.

42. Method according to claim 40, further comprising:
Determining a set of compounds inducing at least one side effect, that is to say a set of compounds belonging to at least one determined class of side effects;
Determining a set of compounds which do not induce side effects, that is to say a set of compounds inducing no side effects;
Determining the interaction profile of each of said compounds and the interaction profile of the molecule under study;
Determining, for each class of side effects, interaction profiles which are common to the compounds of the class of side effects;
Optionally, for each class of side effects, eliminating, from the interaction profiles common to the compounds of the said class of side effects, the interaction profiles which are also common to other classes of side effects; and
Deducing therefrom the binding sites that are specific to a class of side effects, this collection of binding sites then serving as biomarkers for this class of side effects.

43. Method according to claim 40, further comprising:
Determining anchor points specific to a side effect, said anchor points corresponding to the points of the binding sites common to said compounds inducing side effects and to the molecule under study, and
Modifying the structure of the molecule under study in order to modify its interaction with the anchor points specific to the side effects.

44. Method according to claim 25, wherein the efficacy of the molecule under study is evaluated by:
Screening at least one binding site of the molecule under study or the complementary to at least one region of the molecule under study in a database comprising a set of molecular regions defining a determined environmental context, so as to find targets of the molecule under study;
Determining the number of targets, and
Weighting the number of targets obtained by the level of expression of the gene or genes encoding the targets that display them, the efficacy of the molecule under study being inversely proportional to the weighted number of targets of the molecule under study.

45. Method according to claim 44, further comprising:
Determining anchor points specific to a target, such anchor points corresponding to the points of binding sites which are common to the target and the molecule under study, and
Modifying the structure of the molecule under study, in order to modify its interaction with the anchor points specific to the target.

46. Method according to claim 25, wherein a cartography of the molecule under study is generated by assigning, to each point and/or to each region of the molecule, one element from the following group:
The value of the state of a given geometric, physico-chemical and/or evolutionary property;
A local energy score for a given group of geometric, physico-chemical and/or evolutionary properties;
A value characterizing a type of binding site;
A specificity index;
The druggability of the molecule;
A toxicity index;
The presence of a binding site, and an associated partner;
An average between the states of a geometric, physico-chemical and/or evolutionary property at each point or at each region for different molecular contexts;
A standard deviation between the states of a geometric, physico-chemical and/or evolutionary property at each point or at each region for different molecular contexts; and
The possibility that said point and/or to each region is an anchor point.

47. Method according to claim 25, comprising:
Generating at least one stable conformation which is random and similar to a region of the molecule under study, and
Applying the method to said conformations thereby obtained.
